(19) United States
(12) Patent Application Publication
(10) Pub. No.: US 2016/0122577 A1
(43) Pub. Date: May 5, 2016

(54) HARD COAT FILM, POLARIZING PLATE, AND TOUCH PANEL DISPLAY

(71) Applicant: FUJIFILM CORPORATION, Tokyo (JP)

(72) Inventors: Taketo OTANI, Kanagawa (JP); Masaaki SUZUKI, Kanagawa (JP); Katsuyuki TAKADA, Kanagawa (JP)

(73) Assignee: FUJIFILM CORPORATION, Tokyo (JP)

(21) Appl. No.: 14/926,485

(22) Filed: Oct. 29, 2015

(30) Foreign Application Priority Data
Oct. 31, 2014 (JP) 2014-223073

(51) Int. Cl. C09D 133/14; G02B 1/14; G02F 1/1335; G06F 3/041

(52) U.S. Cl. CPC C09D 133/14; G06F 3/0412; G02B 1/14; G02F 1/133528; G06F 2203/04103; G02F 2001/133562

(57) ABSTRACT

There is provided a hard coat film having a hard coat layer made from a hard coat layer forming composition on at least one side of a transparent support. The hard coat layer forming composition includes a resin which has a repeating unit including, in a same side chain thereof, at least one selected from a fluorine atom and a silicon atom, and a polarity conversion group capable of being hydrolyzed by the action of an alkali solution to increase the hydrophilicity.

### CROSS REFERENCE TO RELATED APPLICATION(S)

This application claims priority from Japanese Patent Application No. 2014-223073 filed on Oct. 31, 2014, the entire disclosures of which are incorporated herein by reference.

### BACKGROUND

1. Technical Field

The present invention relates to a hard coat film, a polarizing plate, and a touch panel display.

2. Background Art

Recently, a high quality has been highly demanded for a hard coat film formed by providing a hard coat layer on a substrate, and thus, when a hard coat film is used as a protective layer of a polarizer, a protective film has been developed, which can suppress deterioration of a polarizing performance of the polarizer in long-term use under a high-temperature and high-humidity environment.

For example, Japanese Patent Laid-Open Publication No. 2006-083225 (hereinafter JP-A-2006-083225) discloses that a functional film having a low moisture permeability and a high mechanical strength may be obtained by forming, on a transparent base film, a layer in which a compound having an unsaturated double bond group is cured.

Further, with respect to the hard coat film, a demand for a surface aspect has become stricter. In order to improve the surface aspect by making the coating film smooth, a method is generally used, in which a surfactant (leveling agent) such as a silicon-based compound or a fluorine-containing polymer is added to a hard coat layer forming composition. It is believed that the surfactant is unevenly distributed on the surface of the coating film due to its hydrophobicity, so that the surface tension of the coating film is reduced, thereby imparting a leveling property. To make the coating film hydrophobic is preferred from the viewpoint of the low moisture permeability.

In a case where a protective film is fabricated by curing a compound having an unsaturated double bond group as in JP-A-2006-083225, the layer surface becomes hydrophobic in many cases. Further, even in a case where a leveling agent generally used for smoothness is used as described above, a hard coat layer may be formed by making the surface of the coating film hydrophobic.

Meanwhile, for these, as a multifunction of the hard coat, there is a high demand to laminate other layers depending on its use, such as, for example, an antistatic layer, high refractive index layer, a low refractive index layer, a retardation layer, or a bonding layer, on the surface of the hard coat layer.

However, in a case where other layers are laminated on the hard coat layer, if the surface of the hard coat layer serving as a lower surface is hydrophobic, a resin composition to be laminated on the upper layer may be left out without soaking, or the interlayer adhesion may be reduced. In order to enhance lamination with the upper layer, it is important to make the surface of the hard coat layer hydrophilic (a low water contact angle).

As a method of making the surface of the hard coat layer hydrophilic when other layers are laminated, without impairing the surface aspect of the coating layer, for example, Japanese Patent Laid-Open Publication No. 2001-272503 (hereinafter JP-A-2001-272503) discloses that a contact angle with water is reduced by performing a corona discharge processing or a glow discharge processing after the hard coat layer is coated.

Further, Japanese Patent Laid-Open Publication No. 2002-265866 (hereinafter JP-A-2002-265866) discloses that an adhesion with a low refractive index layer as an upper layer is enhanced by performing a surface treatment such as an alkali treatment or a corona processing on the hard coat layer.

Further, Japanese Patent Laid-Open Publication No. 2011-212554 (hereinafter JP-A-2011-212554) discloses that a specific amount of a solvent having a boiling point and a viscosity in a specific range is used without using a surfactant.

However, when the corona processing or the glow discharge processing is used as in JP-A-2001-272503 and JP-A-2002-265866, since high energy is irradiated, film deformation, pin hole generation, or uneven water contact angle in a plane may be generated. Further, in the alkali treatment as in JP-A-2002-265866, if the alkali treatment conditions (pH, temperature, and time of the liquid) are weak, the hydrophilicity of the coating film after the treatment is reduced. On the contrary, if the conditions are excessively strong, the hardness is reduced because the hydrolysis proceeds excessively.

Further, in the method of JP-A-2011-212554, although it is hydrophilic as compared with the case where the generally hydrophobic leveling agent is unevenly distributed on the surface, the hydrophilicity is insufficient for the surface of the compound having an unsaturated double bond group which is generally used to impart hardness.

In consideration of the above-described problems, the object of the present invention, that is, the object to be solved by the present invention is to provide a hard coat film which is excellent in surface aspect, hardness, and lamination with other layers, and has various functions.

In addition, another object of the present invention is to provide a polarizing plate and a touch panel display, which are excellent in durability, using the hard coat film.

The present inventors have intensively studied in order to solve the above-described problems, and found that a polarity converting polymer having a high hydrolysable structure by an alkali treatment is used in the hard coat layer forming composition, so that the hydrophilicity of the surface may be remarkably enhanced without deteriorating the hardness by the alkali treatment as described in JP-A-2002-265866, thereby improving the adhesion when laminating with other layers. Further, the moisture permeability of the hard coat film hydrophilicized by the method was not deteriorated. It is presumed that this is because the hydrophilicized layer is only negligible thickness of the outermost layer, and most of the film remains hydrophobic.

### SUMMARY

(1) A hard coat film having a hard coat layer made from a hard coat layer forming composition on at least one side of a transparent support, the hard coat layer forming composition containing:
a) a resin which has a repeating unit including, in a same side chain thereof, at least one selected from a fluorine atom and a silicon atom, and a polarity conversion group capable of being hydrolyzed by the action of an alkali solution to increase the hydrophilicity.

(2) The hard coat film according to (1), wherein the polarity conversion group is a polarity conversion group containing a lactone ring.

(3) The hard coat film according to (1), wherein the hard coat layer forming composition further contains:
b) a compound having three or more ethylenically unsaturated double bond groups in the molecule.

(4) The hard coat film according to (1), wherein the hard coat layer forming composition further contains:
c) a compound having at least one epoxy group in the molecule.

(5) The hard coat film according to (4), wherein the compound c) is a compound having one alicyclic epoxy group and one ethylenically unsaturated double bond group in the molecule and having a molecular weight of 300 or less.

(6) The hard coat film according to (1), wherein the hard coat layer forming composition further contains:
d) inorganic fine particles having reactivity with an epoxy group or an ethylenically unsaturated double bond group.

(7) The hard coat film according to (1), wherein the hard coat layer forming composition further contains:
e) a UV absorbent.

(8) The hard coat film according to (1), wherein the transparent support is a cellulose acylate film and has a thickness of 25 μm or less.

(9) The hard coat film according to (3), wherein a content of the compound b) is 45% by mass to 75% by mass based on a total solid content of the hard coat layer forming composition.

(10) The hard coat film according to (4), wherein a content of the compound c) is 12% by mass to 35% by mass based on a total solid content of the hard coat layer forming composition.

(11) The hard coat film according to (10), wherein a content of the compound c) is 15% by mass to 30% by mass based on a total solid content of the hard coat layer forming composition.

(12) A hard coat film obtained by saponifying the hard coat film according to (1), wherein a contact angle of a surface of the hard coat layer is 75° or less.

(13) A polarizing plate comprising a polarizer and at least one sheet of the saponified hard coat film according to (12).

(14) A touch panel display comprising a liquid crystal cell, the polarizing plate according to (13) disposed at a viewing side of the liquid crystal cell, and an optically clear resin or an optically clear adhesive disposed on a surface of the polarizing plate opposite to a liquid crystal cell side.

According to an example of the present invention, there is provided a hard coat film which is excellent in surface aspect, hardness and cissing resistance of other layers when laminated.

### DETAILED DESCRIPTION OF EXEMPLARY EMBODIMENTS

Hereinafter, the present invention will be described in detail.

Meanwhile, the dash “to” means a range having the numerical values coming before and after “to” as the lower limiting value and the upper limiting value, respectively.

In the present specification, the term “(meth)acryl group” is used to mean “any one or both of an acryl group and a methacryl group.” The terms “(meth)acrylic acid”, “(meth)acrylamide”, “(meth)acryloyl group” are the same.

[Hard Coat Film]

The hard coat film of the present invention has, on at least one side of a transparent support, a hard coat layer comprising a hard coat layer forming composition containing a resin having, on one side chain, at least one selected from a fluorine atom and a silicon atom, and a repeating unit having a polarity converting group capable of being hydrolyzed by the action of an alkali solution to increase the hydrophilicity.

Hereinafter, descriptions will be made on the hard coat layer included in the hard coat film of the present invention.

<Hard Coat Layer>

((a) Resin having, on one side chain, at least one selected from a fluorine atom and a silicon atom, and a repeating unit having a polarity converting group capable of being hydrolyzed by the action of an alkali solution to increase the hydrophilicity)

The hard coat layer of the present invention is composed of a hard coat layer forming composition containing a resin represented by the above-described (a) (also referred to as a resin (a)).

Here, the polarity converting group is a group capable of being hydrolyzed by the action of an alkali solution to increase the hydrophilicity. Examples thereof may include a lactone group, a carboxylic acid ester group (—COO—), an acid anhydride group —(C(O)OC(O)—), an acid imide group (—NHCONH—), a carboxylic acid thioester group (—COS—), a carbonic acid ester group (—OC(O)O—), a sulfuric acid ester group (—OSO₂O—), and a sulfonic acid ester group (—SO₂O—).

Meanwhile, since the ester group directly bonded to the main chain of the repeating unit as in, for example, acrylate, has a poor function to increase the solubility in an alkali solution by decomposing by the action of the alkali solution, it is not included in the polarity converting group in the present invention.

Examples of the repeating unit may include a repeating unit represented by Formula (K0).

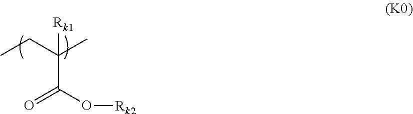

In the formula, Rₖ₁ represents a hydrogen atom, a halogen atom, a silicon atom, a hydroxyl group, alkyl group, a cycloalkyl group, aryl group, or a group containing the polarity converting group.

Rₖ₂ represents an alkyl group, a cycloalkyl group, an aryl group, or a group containing the polarity converting group.

However, at least one of Rₖ₁ and Rₖ₂ has any one of the polarity converting group, and a fluorine atom and a silicon atom.

Meanwhile, the ester group directly bonded to the repeating unit represented by Formula (K0) is not included in the polarity converting group in the present invention, as described above.

The polarity converting group is preferably a group represented by X in a partial structure represented by Formula (KA-1) or (KB-1). That is, the group containing the polarity converting group is preferably a group represented by the following Formula (KA-1) or (KB-1).

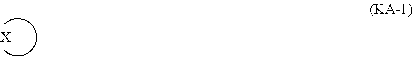

X in Formula (KA-1) or (KB-1) represents a carboxylic acid ester group: —COO—, an acid anhydride group: —C(O)OC(O)—, an acid imide group: —NHCONH—, a carboxylic acid thioester group: —COS—, a carbonic acid ester group: —OC(O)O—, a sulfuric acid ester group: —OSO₂O—, or a sulfonic acid ester group: —SO₂O—.

Y¹ and Y² may be same or different, and represent an electron withdrawing group.

Meanwhile, the repeating unit has a preferably polarity converting group by having a partial structure represented by Formula (KA-1) or (KB-1), but, in a case where the partial structure does not have a bonding hand as in the cases of the partial structure represented by Formula (KA-1) and the partial structure represented by Formula (KB-1) in which Y¹ and Y² are monovalent, a group having the partial structure is a group having a mono- or higher-valent group in which at least one hydrogen is arbitrarily removed from the partial structure. The partial structure represented by Formula (KA-1) or (KB-1) is bonded to the main chain of the resin (a) via a substituent at an arbitrary position.

The partial structure represented by Formula (KA-1) is a structure forming a ring structure together with a group as X.

X in Formula (KA-1) is preferably a carboxylic acid ester group (that is, in a case of forming a lactone ring structure as KA-1), an acid anhydride group, or a carbonic acid ester group. More preferably, it is a carboxylic acid ester.

The ring structure represented by Formula (KA-1) may have a substituent, for example, nka substituents Zₖₐ₁.

When a plurality is present, Zₖₐ₁'s each independently represent an alkyl group, a cycloalkyl group, an ether group, a hydroxyl group, an amide group, an aryl group, a lactone ring group or an electron withdrawing group.

Zₖₐ₁'s may be bonded to each other to form a ring. Examples of the ring formed when Zₖₐ₁'s are bonded to each other may include a cycloalkyl ring and a heterocyclic ring (including a cyclic ether ring and a lactone ring).

nka represents an integer of 0 to 10, preferably an integer of 0 to 8, more preferably an integer of 0 to 5, still more preferably an integer of 1 to 4, and most preferably an integer of 1 to 3.

The electron withdrawing group as Zₖₐ₁ is the same as the electron withdrawing group as Y¹ and Y² to be described later.

Meanwhile, the electron withdrawing group may be substituted with other electron withdrawing groups.

Zₖₐ₁ is preferably an alkyl group, a cycloalkyl group, an ether group, a hydroxyl group or an electron withdrawing group, and more preferably an alkyl group, a cycloalkyl group or an electron withdrawing group. Further, the ether group is preferably a group substituted with an alkyl group or a cycloalkyl group, that is, an alkyl ether group. The electron withdrawing group has the same meaning as those above.

The halogen atom as Zₖₐ₁ may be exemplified by a fluorine atom, chlorine atom, bromine atom, and an iodine atom, and is preferably a fluorine atom.

The alkyl group as Zₖₐ₁ may have a substituent, and may be straight or branched. The straight alkyl group has preferably 1 to 30 carbon atoms, and more preferably 1 to 20 carbon atoms, and examples thereof may include a methyl group, an ethyl group, a n-propyl group, a n-butyl group, a sec-butyl group, a t-butyl group, a n-pentyl group, a n-hexyl group, a n-heptyl group, a n-octyl group, a n-nonyl group, and a n-decanyl group. The branched alkyl group has preferably 3 to 30 carbon atoms, and more preferably 3 to 20 carbon atoms, and examples thereof may include an i-propyl group, an i-butyl group, a t-butyl group, an i-pentyl group, a t-pentyl group, an i-hexyl group, a t-hexyl group, an i-heptyl group, a t-heptyl group, an i-octyl group, a t-octyl group, an i-nonyl group, and a t-decanoyl group. The group having 1 to 4 carbon atoms such as a methyl group, an ethyl group, a n-propyl group, an i-propyl group, a n-butyl group, an i-butyl group, or a t-butyl group, is preferred.

The cycloalkyl group as Zₖₐ₁ may have a substituent, and may be monocyclic, polycyclic, or bridged. For example, the cycloalkyl group may have a crosslinked structure. The monocyclic form is preferably a cycloalkyl group having 3 to 8 carbon atoms, and examples thereof may include a cyclopropyl group, a cyclopentyl group, a cyclohexyl group, a cyclobutyl group, and a cyclooctyl group. The polycyclic form may be exemplified by a group having a bicyclo, tricyclo, or tetracyclo structure having 5 or more carbon atoms, preferably a cycloalkyl group having 6 to 20 carbon atoms, and examples thereof may include an adamantly group, a norbornyl group, an isoboronyl group, a camphanyl group, a di cyclopentyl group, an a-pinel group, a tricyclodecanyl group, a tetracyclododecyl group, an androstanyl group, and the following structure. Meanwhile, some of the carbon atoms in the cycloalkyl group may be substituted with a heteroatom such as an oxygen atom.

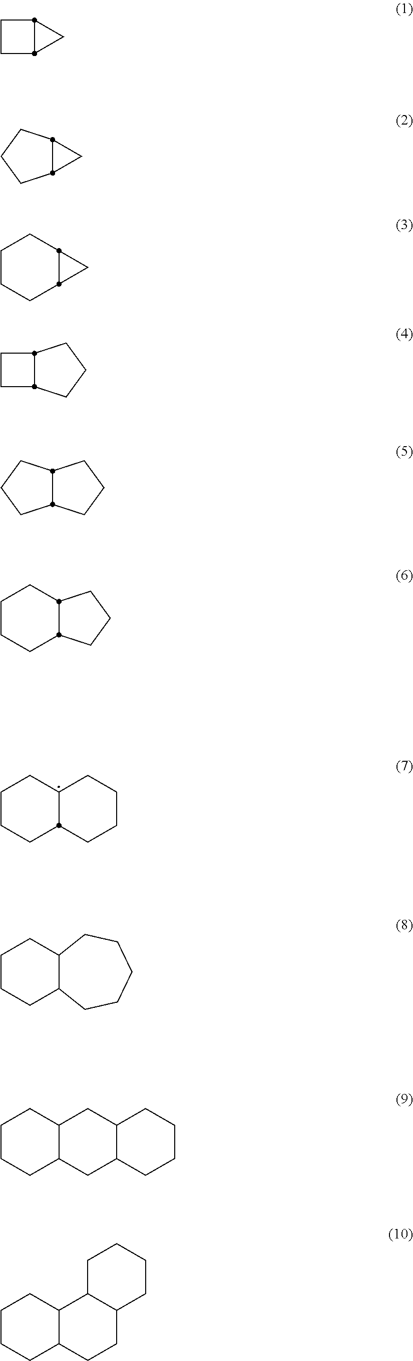

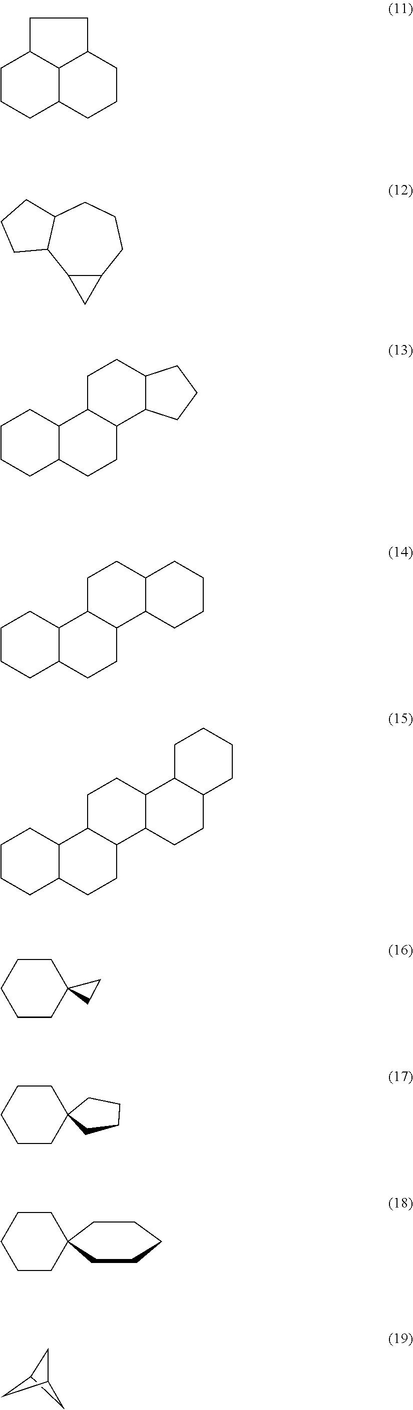

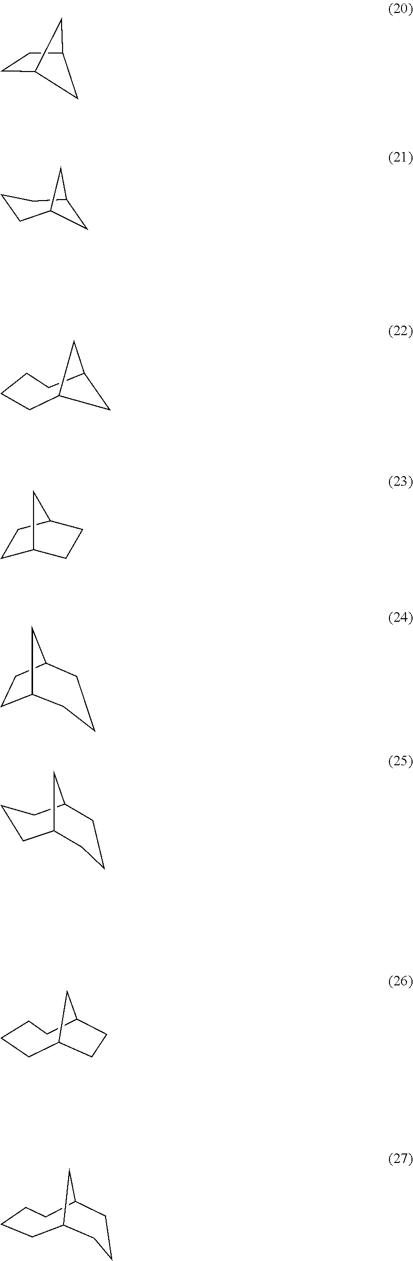

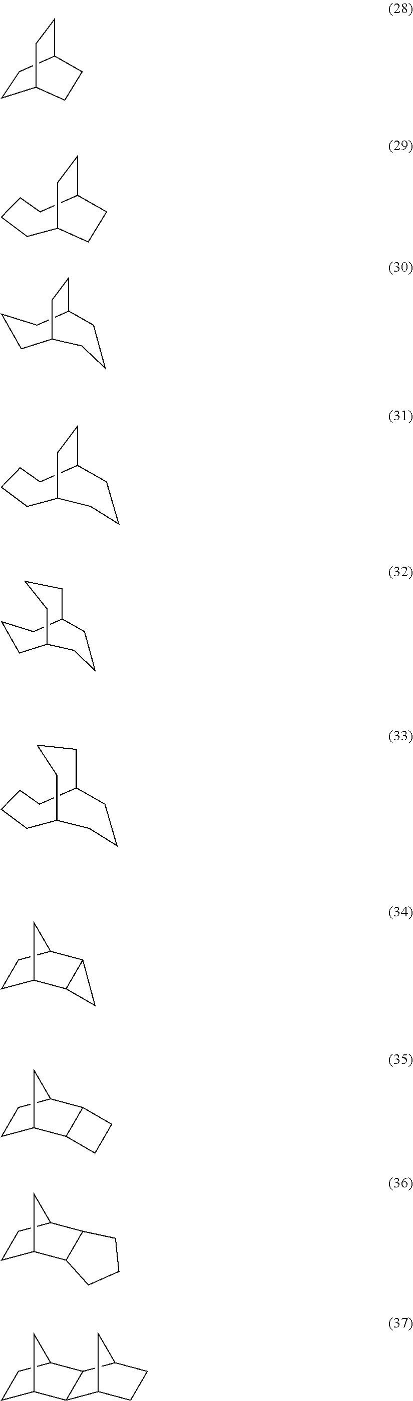

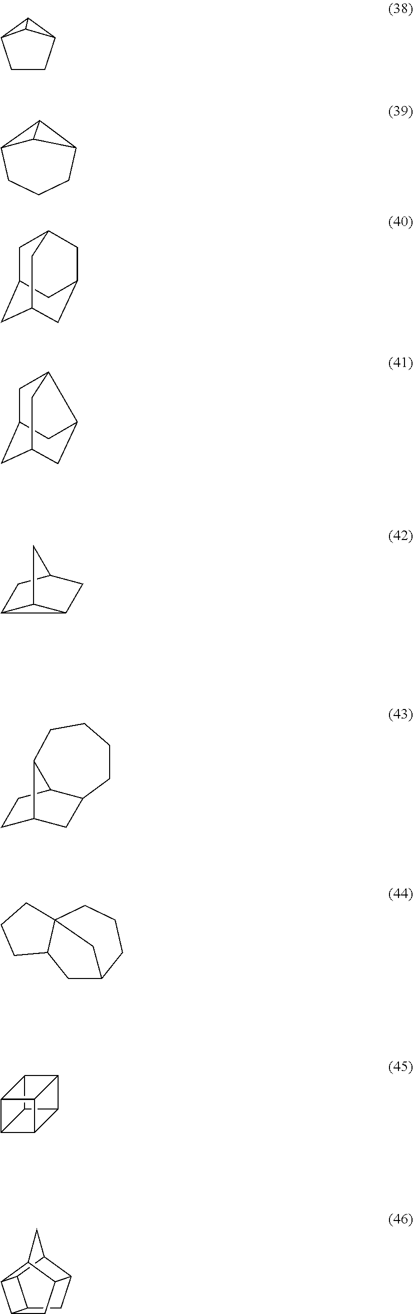

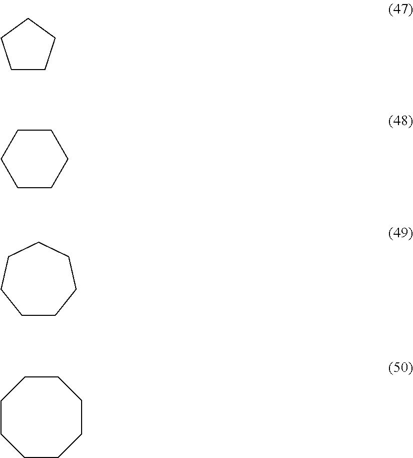 [SMILES: C1CCCC1 ; C1CCCCC1 ; C1CCCCCC1 ; C1CCCCCCC1]

Preferred example of the alicyclic moiety may include an adamantyl group, noradamantyl group, a decalin group, a tricyclodecanyl group, a tetra cyclododecanyl group, a norbornyl group, a cedrol group, a cyclohexyl group, a cycloheptyl group, a cyclooctyl group, a cyclodecanyl group, and a cyclododecanyl group. More preferred are an adamantyl group, a decalin group, a norbornyl group, a cedrol group, a cyclohexyl group, a cycloheptyl group, a cyclooctyl group, a cyclodecanyl group, a cyclododecanyl group, and a tricyclodecanyl group.

Examples of a substituent of the alicyclic structure may include an alkyl group, a halogen atom, a hydroxyl group, an alkoxy group, a carboxyl group, and an alkoxycarbonyl group. Examples of the alkyl group may include preferably a lower alkyl group such as a methyl group, an ethyl group, a propyl group, an isopropyl group, and a butyl group, and more preferably a methyl group, an ethyl group, a propyl group, and an isopropyl group. Examples of the alkoxy group may include a group having 1 to 4 carbon atoms, preferably a methoxy group, an ethoxy group, a propoxy group, and a butoxy group. Examples of a substituent, which may be possessed by the alkyl group and the alkoxy group, may include a hydroxyl group, a halogen atom, and an alkoxy group (preferably having 1 to 4 carbon atoms).

Further, more examples of the substituent which may be possessed by the above groups, may include a hydroxyl group, a halogen atom (including fluorine, chlorine, bromine, and iodine), a nitro group, a cyano group, the above-described alkyl group, an alkoxy group such as a methoxy group, an ethoxy group, a hydroxyethoxy group, a propoxy group, a hydroxypropoxy group, a n-butoxy group, an isobutoxy group, a sec-butoxy group, and a t-butoxy group, an alkoxycarbonyl group such as a methoxycarbonyl group and an ethoxycarbonyl group, an aralkyl group such as a benzyl group, a phenethyl group, and a cumyl group, an aralkyloxy group, an acyl group such as a formyl group, an acetyl group, a butyryl group, a benzoyl group, a cyanamyl group, and a valeryl group, an acyloxy group such as a butyryloxy group, the above-descdribed alkenyl group, an alkenyloxy group such as a vinyloxy group, a propenyloxy group, an allyloxy group, and a butenyloxy group, the above-described aryl group, an aryloxy group such as a phenoxy group, aryloxycarbonyl group such as a benzoyloxy group, a fluorine atom-containing group (to be described later), and a silicon atom-containing group (to be described later).

It is preferred that X in Formula (KA-1) is a carboxylic acid ester group, and the partial structure represented by Formula (KA-1) is a lactone ring, and preferably a 5- to 7-membered lactone ring.

Further, as in Formulas (KA-1-1) to (KA-1-17) below, it is preferred that other ring structures are condensed to the 5- to 7-lactone ring as the partial structure represented by Formula (KA-1) to form a bicyclo structure or a spiro structure.

For neighboring ring structure to which the ring structure represented by Formula (KA-1) may be bound, those represented by Formula (KA-1-1) to (KA-1-17) below, or those analogous thereto may be exemplified.

As a structure containing a lactone ring structure represented by Formula (KA-1), any structures among Formula (KA-1-1) to (KA-1-17) are more preferred. Meanwhile, the lactone structure may be bonded directly to the main chain. Preferable structures are (KA-1-1), (KA-1-4), (KA-1-5), (KA-1-6), (KA-1-13), (KA-1-14), (KA-1-17).

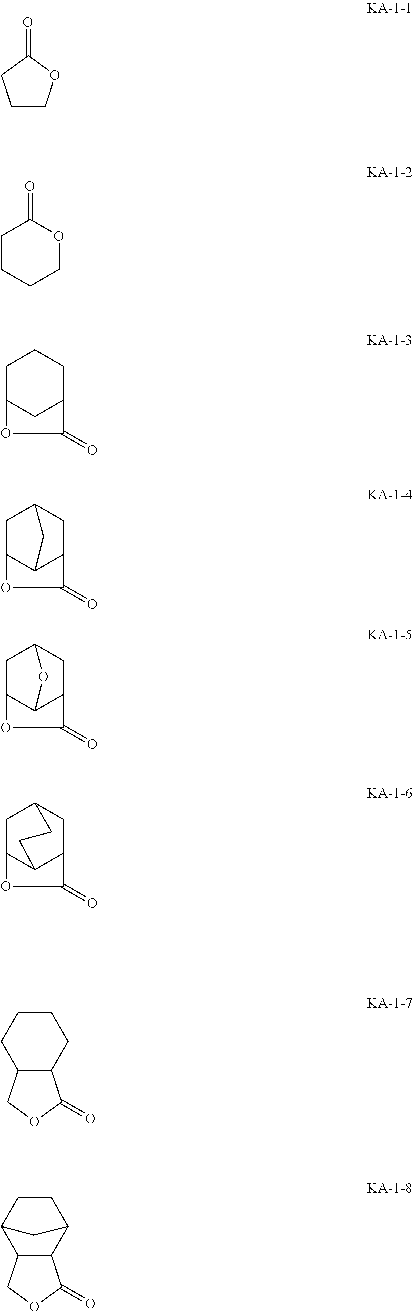

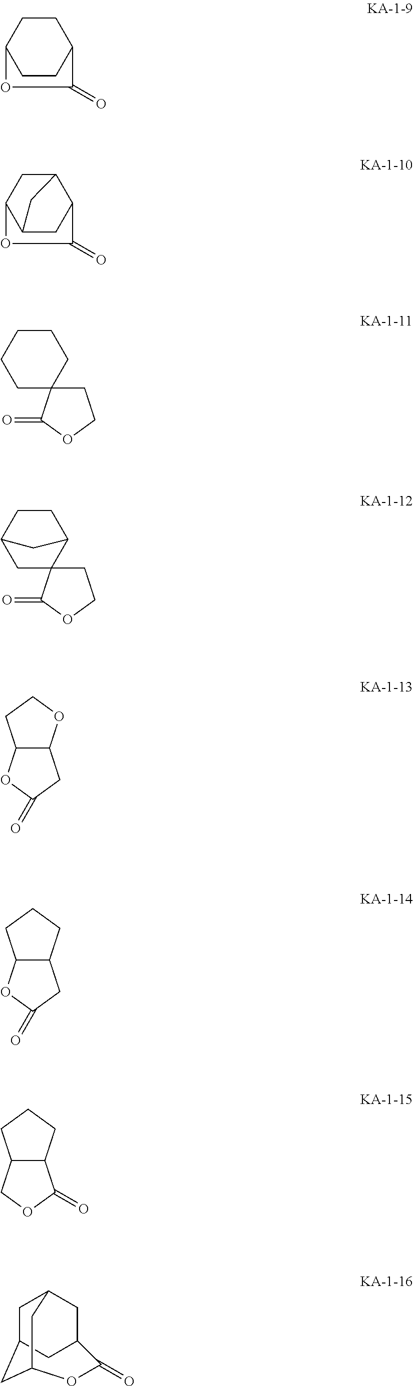

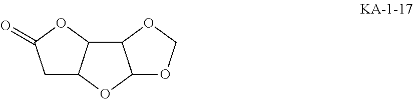 [SMILES: O=C1CC2OC3OCOC3C2O1]

The structure containing the lactone ring structure may not have a further substituent as long as the structure has any one of a fluorine atom and a silicon atom on the same side chain. A preferred substituent may be exemplified by the substituent which may be possessed by the ring structure represented by Formula (KA-1).

Some optically active substances may be present in the lactone structure, but any optically active substance may be used. Further, one optically active substance may be used alone, or a plurality of optically active substances may be used in mixture. When one optically active substance is mainly used, its optical purity (ee) is preferably 90 or more, more preferably 95 or more, and most preferably 98 or more.

Preferred Examples of X in Formula (KB-1) may include a carboxylic acid ester (—COO—).

Y¹ and Y² in Formula (KB-1) each independently represent an electron withdrawing group.

The electron withdrawing group is a partial structure represented by the following Formula (EW). * in Formula (EW) represents a bonding had directly to (KA-1), or a bonding hand directly bonded to X in (KB-1).

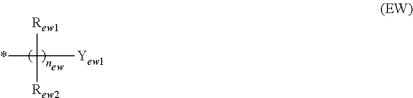

In Formula (EW),

n_{ew} is a repeating number of a linking group represented by —C(R_{ew1})(R_{ew2})—, and represents an integer of 0 or 1. When n_{ew} is 0, it represents a single bond, which means Y_{ew1} is directly bonded.

Y_{ew1} may be exemplified by a halogen atom, a silicon atom, a cyano group, a nitryl group, nitro group, a halo(cyclo)alkyl group or a haloaryl group represented by —C(R_{f1})(R_{f2})—R_{f3}, an oxy group, a carbonyl group, a sulfonyl group, a sulfinyl group, or a combination thereof, and the electron withdrawing group may be, for example, the following structure. Meanwhile, the “halo(cyclo)alkyl group” means an at least partially halogenated alkyl group or cycloalkyl group. R_{ew3} and R_{ew4} each independently represent any structure. The partial structure represented by Formula (EW) has an electron withdrawing property, and may be connected to, for example, the main chain of the resin, but is preferably an alkyl group, a cycloalkyl group, or a fluorinated alkyl group.

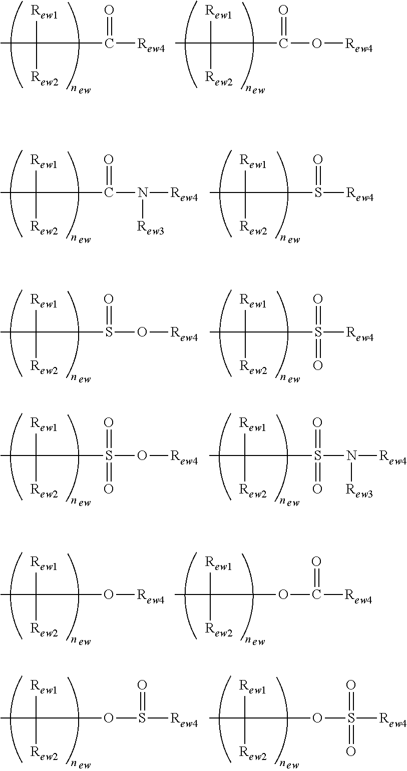

When Y_{ew1} is a di- or higher-valent group, the remaining bonding hands form a bonding with an arbitrary atom or a substituent. At least one of Y_{ew1}, R_{ew1}, and R_{ew2} may be linked to the main chain of the resin a via more substituents.

Y_{ew1} is preferably a halogen atom, or a halo(cyclo)alkyl group or a haloaryl group represented by —C(R_{f1})(R_{f2})—R_{f3}.

R_{ew1} and R_{ew2} each independently represent an arbitrary substituent, for example, a hydrogen atom, an alkyl group, a cycloalkyl group, or an aryl group.

At least two of R_{ew1}, R_{ew2}, and Y_{ew1} may be linked to each other to form a ring.

Here, R_{f1} represents a halogen atom, a perhaloalkyl group, a perhalocycloalkyl group, or a perhaloaryl group, more preferably a fluorine atom, a perfluoroalkyl group, or a perfluorocycloalkyl group, and still more preferably a fluorine atom or a trifluoromethyl group.

R_{f2} and R_{f3} each independently represent a hydrogen atom, a halogen atom, or an organic group, and R_{f2} and R_{f3} may be linked to each other to form a ring. The organic group represents, for example, an alkyl group, a cycloalkyl group, or an alkoxy group. R_{f2} represents the same group as R_{f1}, or more preferably, is linked with R_{f3} to form a ring.

R_{f1} to R_{f3} may be linked to form a ring, and the formed ring may be exemplified by a (halo)cycloalkyl ring and a (halo)aryl ring.

The (halo)alkyl group in R_{f1} to R_{f3} may be exemplified by the alkyl group in Zₖₐ₁ as described above and a halogenated structure thereof.

The (per)halocycloalkyl group and the (per)haloaryl group in R_{f1} to R_{f3}, or in the ring formed by linking R_{f2} and R_{f3} may be exemplified by a structure in which the cycloalkyl group in Zₖₐ₁ as described above is halogenated, and more preferably a fluoroalkyl group represented by —C(n)F₍₂ₙ₋₂₎H and a perfluoroaryl group represented by —C₍ₙ₎F₍ₙ₋₁₎. Here, the carbon number n is not particularly limited, but preferably 5 to 13, and more preferably 6.

The ring formed by linking at least two of R_{ew1}, R_{ew2}, and Y_{ew1} may be preferably exemplified by a cycloalkyl group or a heterocyclic ring, and the heterocyclic ring is preferably a lactone ring group. The lactone ring may be exemplified by the structures represented by Formulas (KA-1-1) to (KA-1-17) above.

Meanwhile, the repeating unit may have a plurality of partial structures represented by Formula (KA-1), a plurality of partial structures represented by Formula (KB-1), or both of the partial structures represented by Formula (KA-1) and Formula (KB-1).

Meanwhile, a part or all of the partial structure of Formula (KA-1) may also serve as the electron withdrawing group as Y¹ or Y² in Formula (KB-1). For example, when X in Formula (KA-1) is a carboxylic acid ester group, the carboxylic acid ester group may also functions as the electron withdrawing group as Y¹ or Y² in Formula (KB-1).

In the present invention, a hard coat layer composed of a composition containing the resin (a) is included as a leveling agent. Therefore, in a state where the hard coat layer is formed on a support, fluorine or silicon is unevenly distributed on the layer surface, and thus, an excellent surface aspect is exhibited, thereby suppressing wind unevenness at the time of coating and drying. Further, the surface of the hard coat layer may be hydrophilized by hardening the hard coat layer and then performing saponification on the film so that the polarity converting group decomposes by the action of an alkali solution, thereby achieving the polarity conversion. Thus, lamination property of other layers on the hard coat may be enhanced.

Accordingly, the position of the polarity converting group is preferably closer to the main chain than a fluorine atom or a silicon atom in one side chain.

When the hard coat film of the present invention is subjected to saponification by an alkali solution, since the polarity converting group in the resin (a) is hydrolyzed to increase its hydrophilicity, the contact angle with water on the surface of the hard coat layer is reduced so that the surface becomes hydrophilic. Specifically, when the saponification (preferably saponification with 1.5 N NaOH solution at 45° C. for 120 seconds) is performed, the contact angle between the hard coat layer and water is preferably 75° or less, more preferably 60° or less, and most preferably 50° or less. The lower limit is preferably 10° or more.

Meanwhile, the hard coat film before the saponification and the hard coat film after the saponification are included in the scope of the present invention.

The resin (a) of the present invention is preferably a resin (C1) containing a repeating unit having at least two polarity converting groups as well as at least one of a fluorine atom and a silicon atom.

When the repeating unit has at least two polarity converting groups, it is preferred to have a group having a partial structure having two polarity converting groups represented by Formula (KY-1) below. Meanwhile, when the structure represented by Formula (KY-1) does not have a bonding hand, the case is a group having a mono- or higher-valent group in which at least one hydrogen atom is arbitrarily removed from the structure.

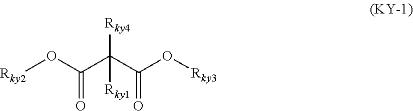

In Formula (KY-1),

R_{ky1} and R_{ky4} each independently represent a hydrogen atom, a halogen atom, an alkyl group, a cycloalkyl group, a carbonyl group, a carbonyloxy group, an oxycarbonyl group, an ether group, a hydroxyl group, a cyano group, an amide group or an aryl group. Alternatively, R_{ky1} and R_{ky4} may be bonded to the same atom to form a double bond. For example, R_{ky1} and R_{ky4} may be bonded to the same oxygen atom to form a part (═O) of the carbonyl group.

R_{ky2} and R_{ky3} each independently represent an electron withdrawing group, or R_{ky1} and R_{ky2} are linked to form a lactone ring and at the same time, R_{ky3} is an electron withdrawing group. The formed lactone ring is preferably a structure of (KA-1-1) to (KA-1-17) above. The electron withdrawing group may be exemplified by the same as Y₁, Y₂ in Formula (KB-1) above, and preferably a halogen atom, or a halo(cyclo)alkyl group or a haloaryl group represented by —C(R_{f1})(R_{f2})—R_{f3}. Preferably, R_{ky3} is a halogen atom, or a halo(cyclo)alkyl group or a haloaryl group represented by —C(R_{f1})(R_{f2})—R_{f3}, and R_{ky2} is linked with R_{ky1} to form a lactone ring, or a halogen atom-free electron withdrawing group.

R_{ky1}, R_{ky2}, and R_{ky4} may be linked to each other to form a monocyclic or polycyclic structure. Specifically, R_{ky1} and R_{ky4} may be exemplified by groups such as Zₖₐ₁ in Formula

(KA-1).

The lactone ring formed by linking R_{ky1} and R_{ky2} is preferably the structures of Formulas (KA-1-1) to (KA-1-17) above. The electron withdrawing group may be exemplified by those such as Y₁, Y₂ in Formula (KB-1) above.

The structure represented by Formula (KY-1) is more preferably a structure represented by Formula (KY-2) below. Meanwhile, the structure represented by Formula (KY-2) is a group having a mono- or higher-valent group in which at least one hydrogen atom is arbitrarily removed from the structure.

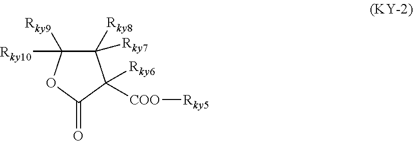

Formula (KY-2),

R_{ky6} to R_{ky10} each independently represent a hydrogen atom, a halogen atom, an alkyl group, a cycloalkyl group, a carbonyl group, a carbonyloxy group, an oxycarbonyl group, an ether group, a hydroxyl group, a cyano group, an amide group or an aryl group.

Two or more of R_{ky6} to R_{ky10} may be linked to each other to form a monocyclic or polycyclic structure.

R_{ky5} represents an electron withdrawing group. The electron withdrawing group may be exemplified by the same as Y₁, Y₂ described above, and preferably a halogen atom, or a halo(cyclo)alkyl group or a haloaryl group represented by —C(R_{f1})(R_{f2})—R_{F3}.

Specifically, R_{ky5} to R_{ky10} may be exemplified by the same as Zₖₐ₁ in Formula (KA-1).

The structure represented by Formula (KY-2) is more preferably a partial structure represented by Formula (KY-3) below.

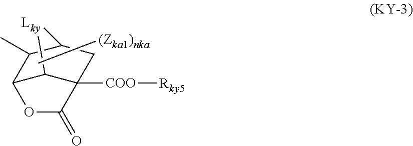

Formula (KY-3),

Zₖₐ₁ and nka have the same meaning as those in Formula (KA-1) above. R_{ky5} has the same meaning as that in Formula (KY-2) above.

L_{ky} represents an alkylene group, an oxygen atom, or a sulfur atom. Examples of the alkylene group of L_{ky} may include a methylene group and an ethylene group. L_{ky} is preferably an oxygen atom or a methylene group, and more preferably a methylene group.

The repeating unit is not limited as long as it is a repeating unit obtained by polymerization such as addition polymerization and condensation polymerization, but is preferably a repeating unit obtained by addition polymerization of a carbon-carbon double bond. Examples thereof may include an acrylate-based repeating unit (also including a system having substituents at α-position and β-position), a styrene-based repeating unit (also including a system having substituents at α-position and β-position), a vinyl ether-based repeating unit, a norbornene-based repeating unit, and a repeating unit of a maleic acid derivative (such as a maleic anhydride or a derivative thereof, or a maleimide). Preferred are an acrylate-based repeating unit, a styrene-based repeating unit, a vinyl ether-based repeating unit, and a norbornene-based repeating unit, more preferred are an acrylate-based repeating unit, a vinyl ether-based repeating unit, and a norbornene-based repeating unit, and most preferred is an acrylate-based repeating unit.

As a more specific structure, the repeating unit is preferably a repeating unit having a partial structure described below.

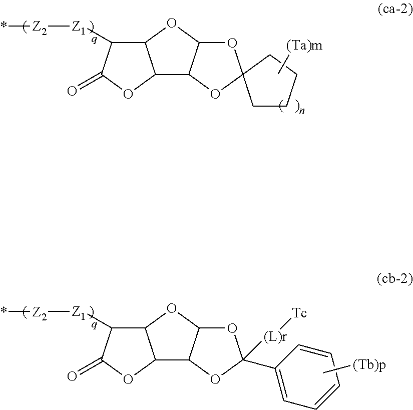

In Formulas (ca-2) and (cb-2),

Z₁'s each independently represent a single bond, an ether bond, an ester bond, an amide bond, a urethane bond, or a urea bond.

Z₂'s each independently represent a chained or cyclic alkylene group.

Ta and Tb each independently represent an alkyl group, a cycloalkyl group, an alkoxy group, a nitryl group, a hydroxyl group, an amide group, an aryl group, an electron withdrawing group (having the same meaning as the electron withdrawing group as Y¹ and Y² in Formula (KB-1)). When a plurality of Ta's is present, Ta's may be bonded to each other to form a ring.

Tc represents a hydrogen atom, an alkyl group, a cycloalkyl group, a nitryl group, a hydroxyl group, an amide group, an aryl group, or an electron withdrawing group (having the same meaning as the electron withdrawing group as Y¹ and Y² in Formula (KB-1)). L's each independently represent a carbonyl group, a carbonyloxy group, or an ether group.

* represents a bonding hand to the main chain of the resin.

m represents an integer of 1 to 28.

n represents an integer of 0 to 11.

p represents an integer of 0 to 5.

q represents an integer of 0 to 5.

r represents an integer of 0 to 5.

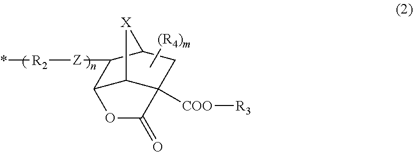

In Formula (2),

R₂ represents a chained or cyclic alkylene group, and when a plurality is present, R₂'s may be same or different.

R₃ represents a straight, branched or cyclic hydrocarbon group in which a part or all the hydrogen atoms on the constituent carbon are substituted by fluorine atoms.

R₄ represents a halogen atom, a cyano group, a hydroxyl group, an amide group, an alkyl group, a cycloalkyl group, an alkoxy group, a phenyl group, an acyl group, an alkoxycarbonyl group, or a group represented by R—C(═O)— or R—C(═O)O— (R represents an alkyl group or a cycloalkyl group). When a plurality is present, R₄'s may be same or different, or two or more R₄'s may be bonded to form a ring.

X represents an alkylene group, an oxygen atom, or a sulfur atom.

Z represents a single bond, an ether bond, an ester bond, an amide bond, a urethane bond or a urea bond, and when a plurality is present, Z's may be same or different.

* represents a bonding hand to the main chain of the resin.

n represents a repeating number, and represents an integer of 0 to 5.

m represents the number of substituents, and represents an integer of 0 to 7.

The structure of —R₂—Z— is preferably a structure represented by —(CH₂)₁—COO— (I represents an integer of 1 to 5).

Specific examples of the repeating unit having a polarity converting group will be described, but not limited thereto.

Ra represents a hydrogen atom, a fluorine atom, a methyl group, or a trifluoromethyl group.

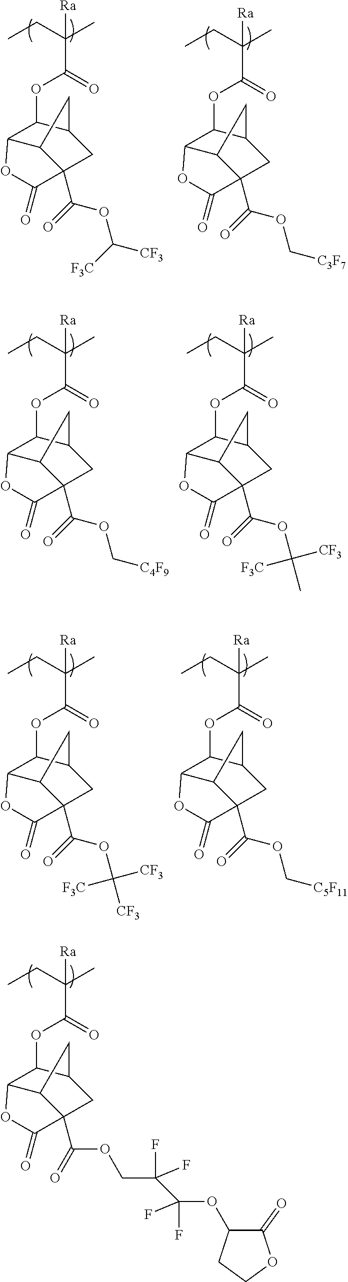

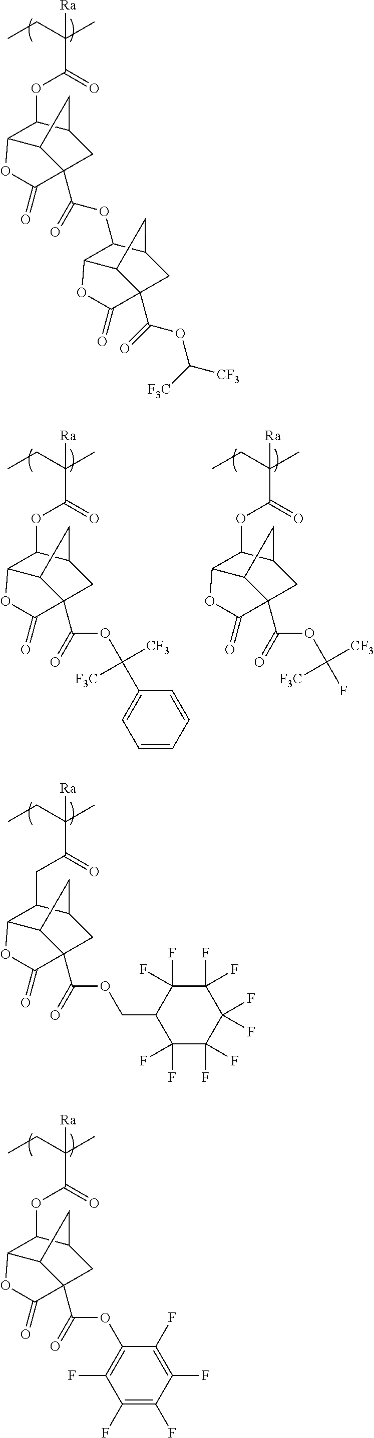

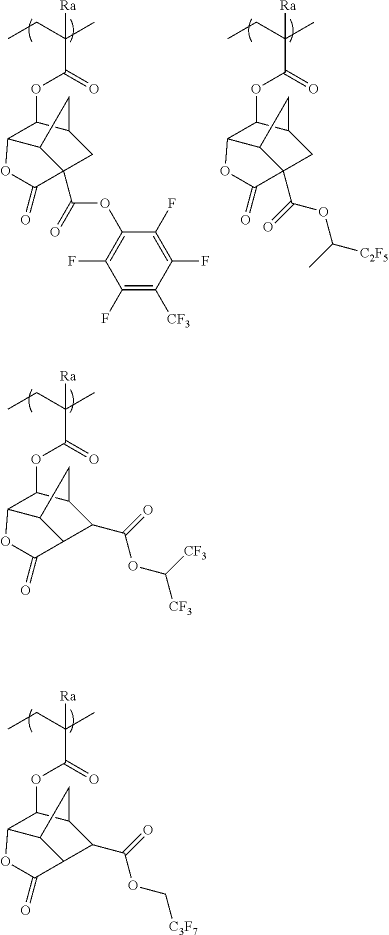

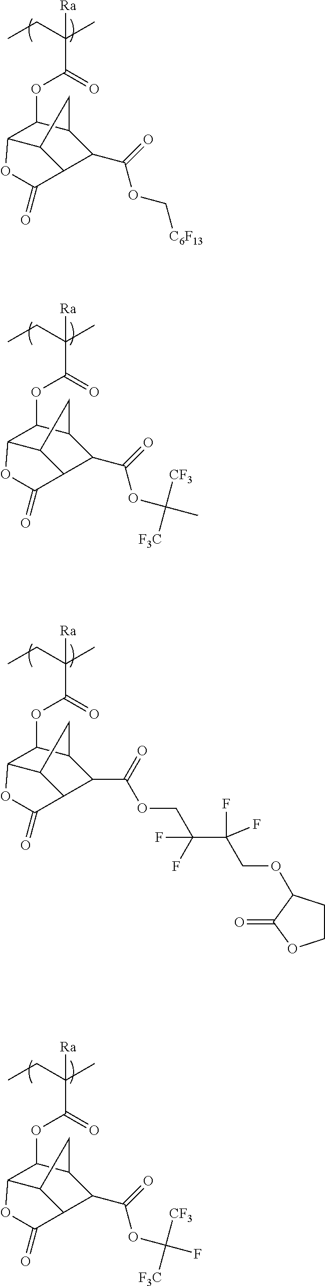

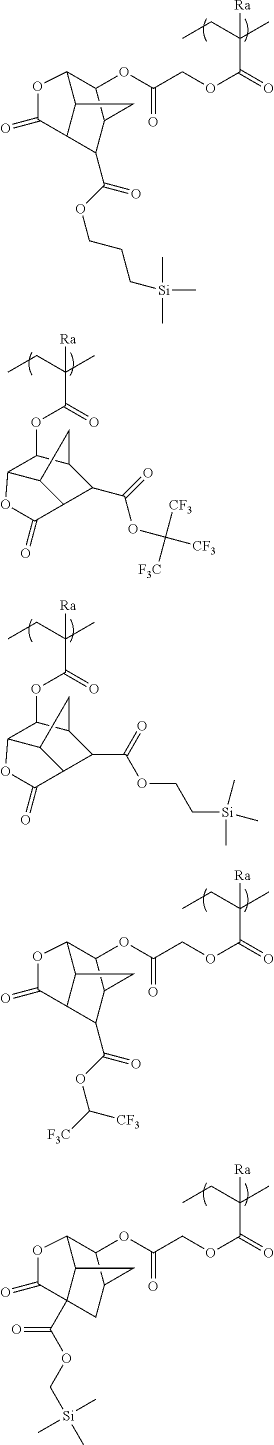

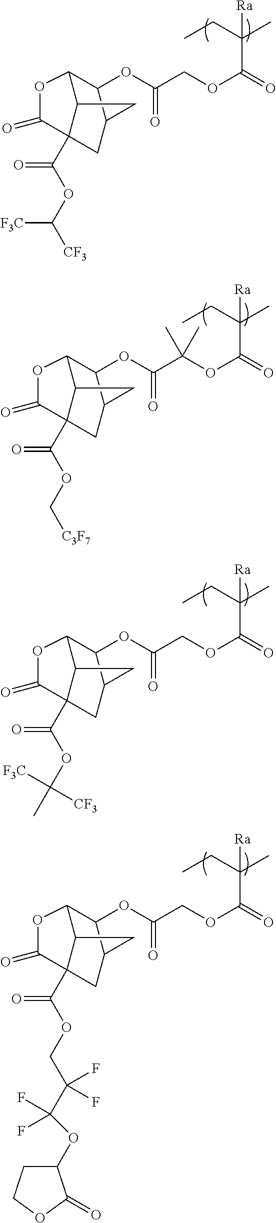

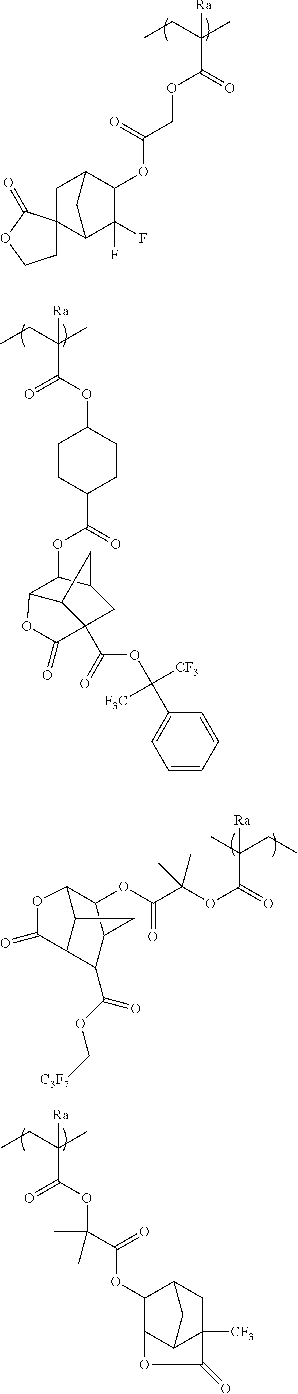

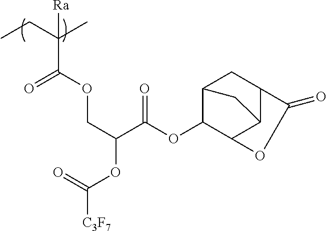

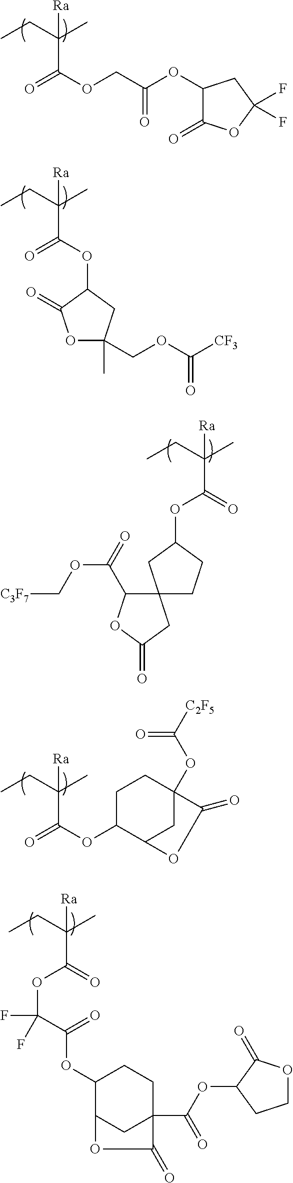

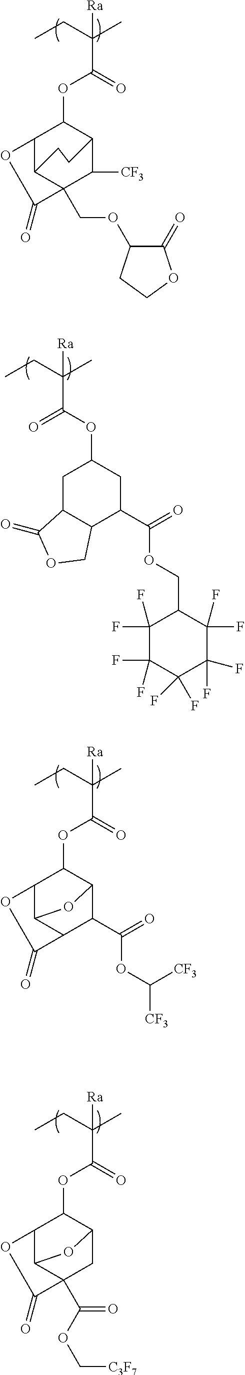

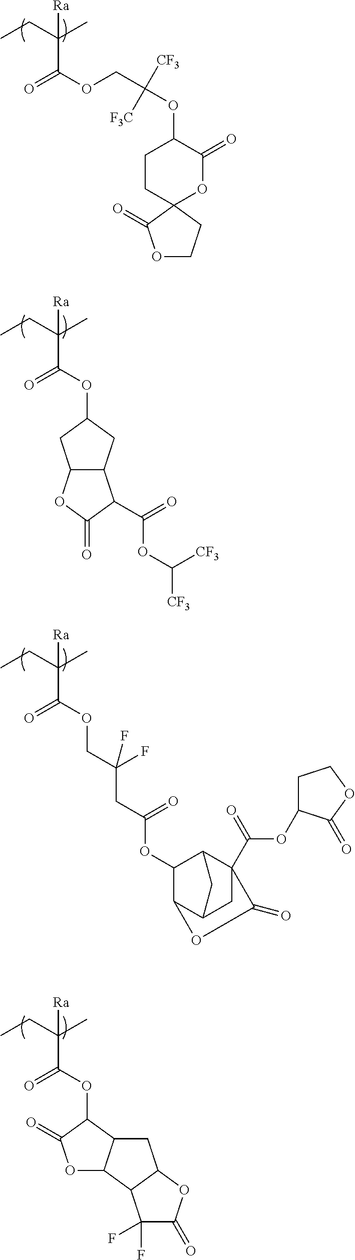

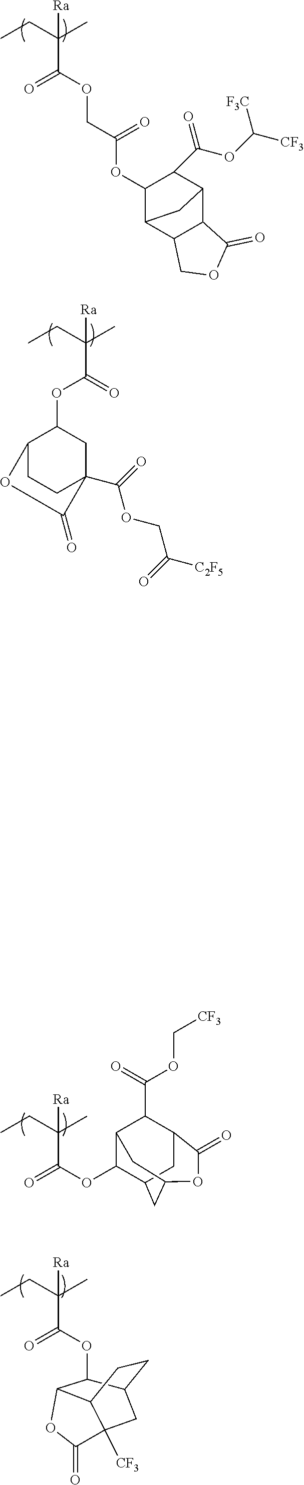

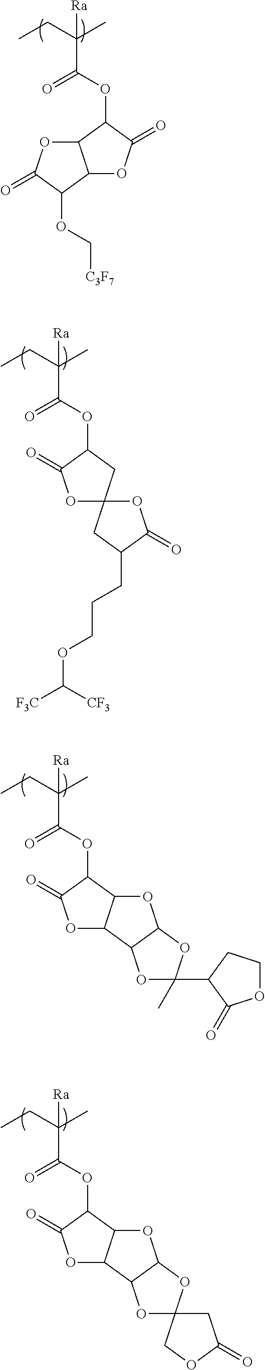

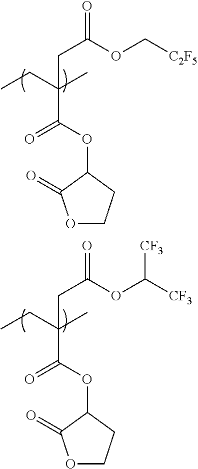

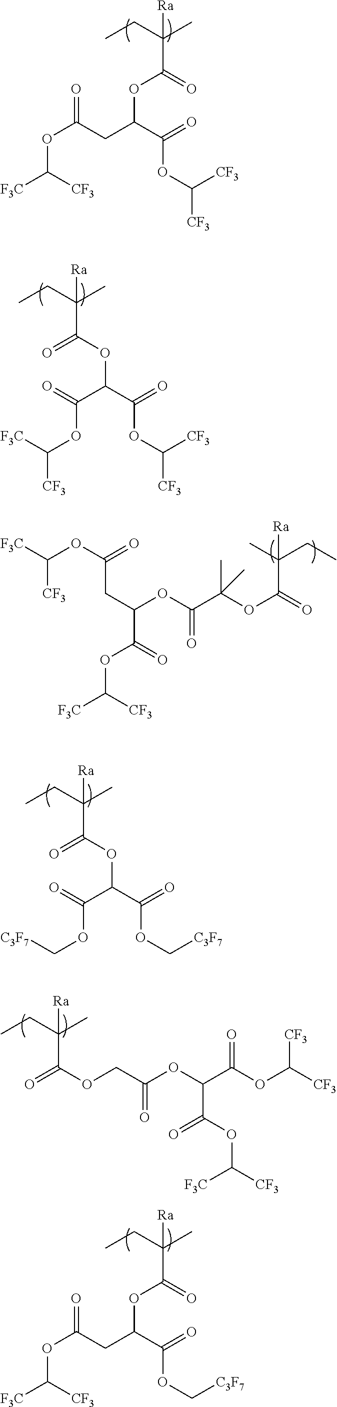

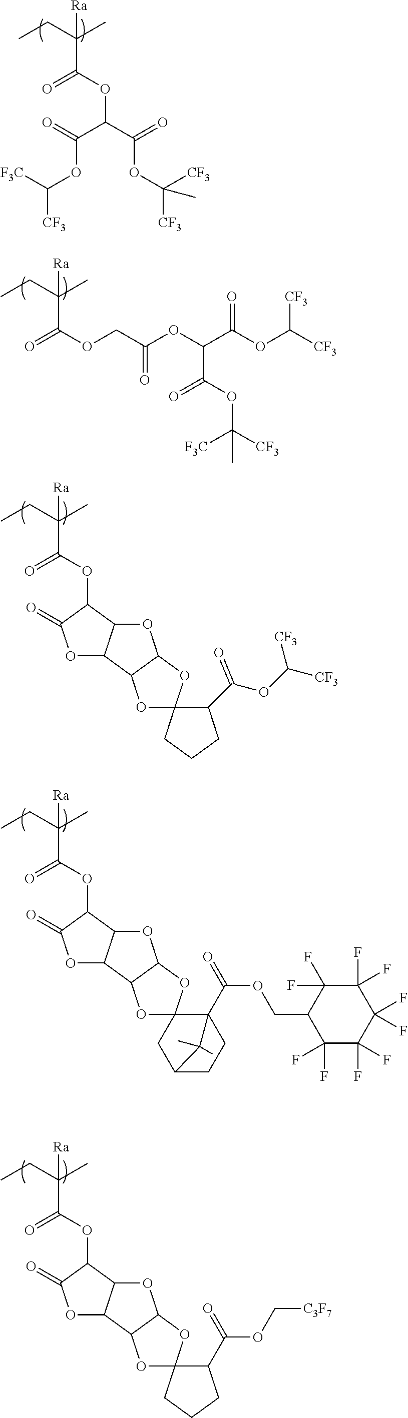

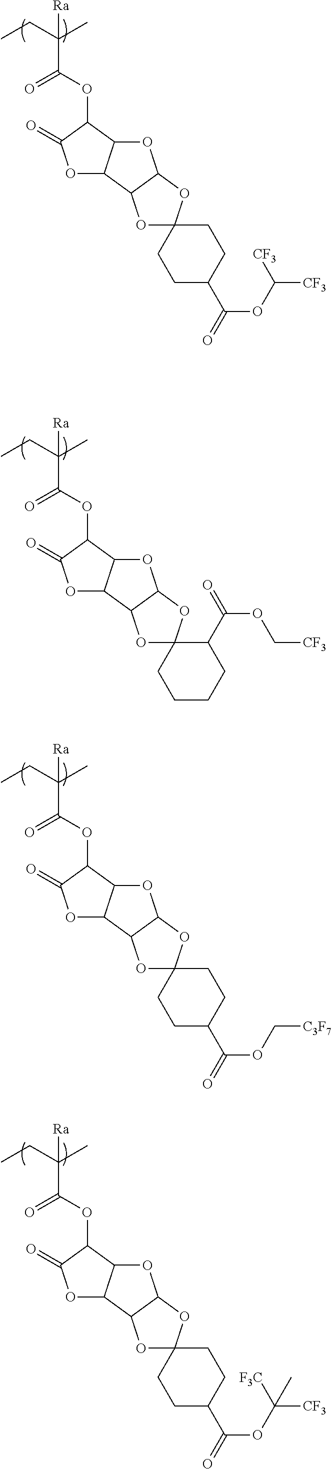

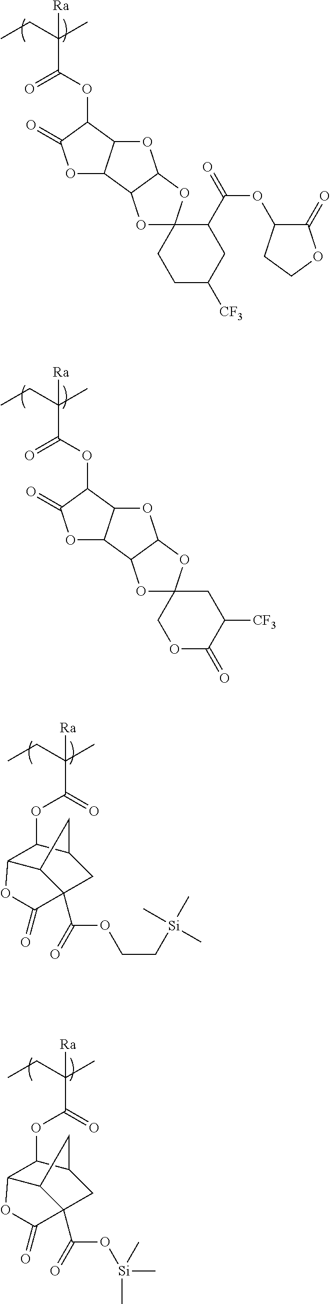

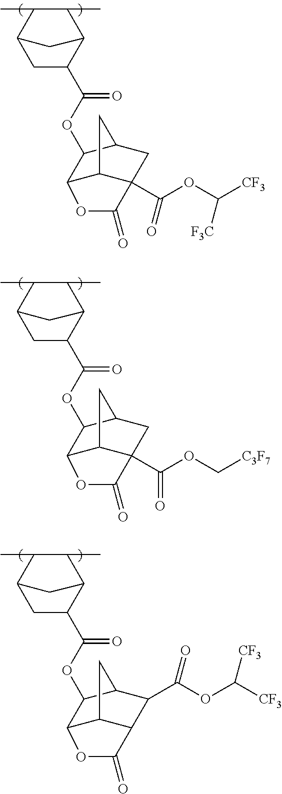

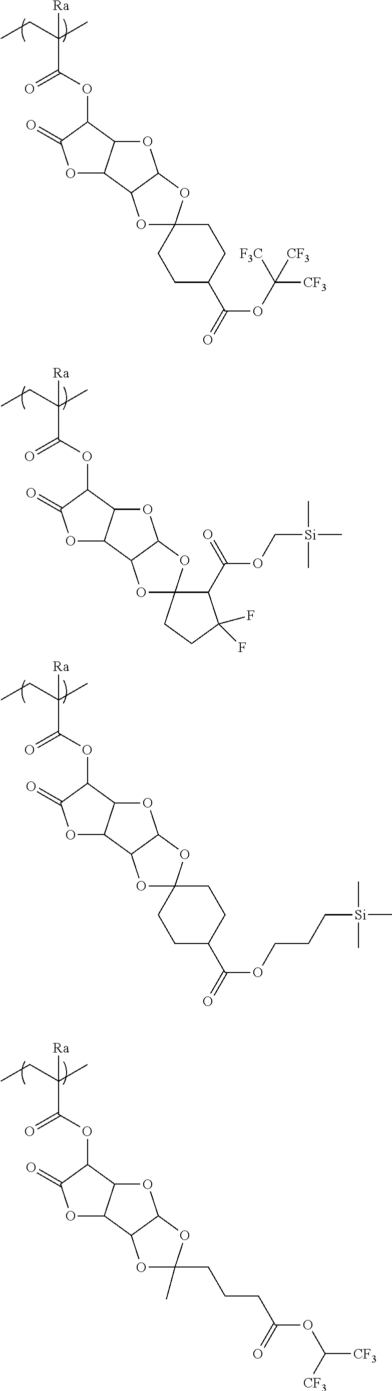

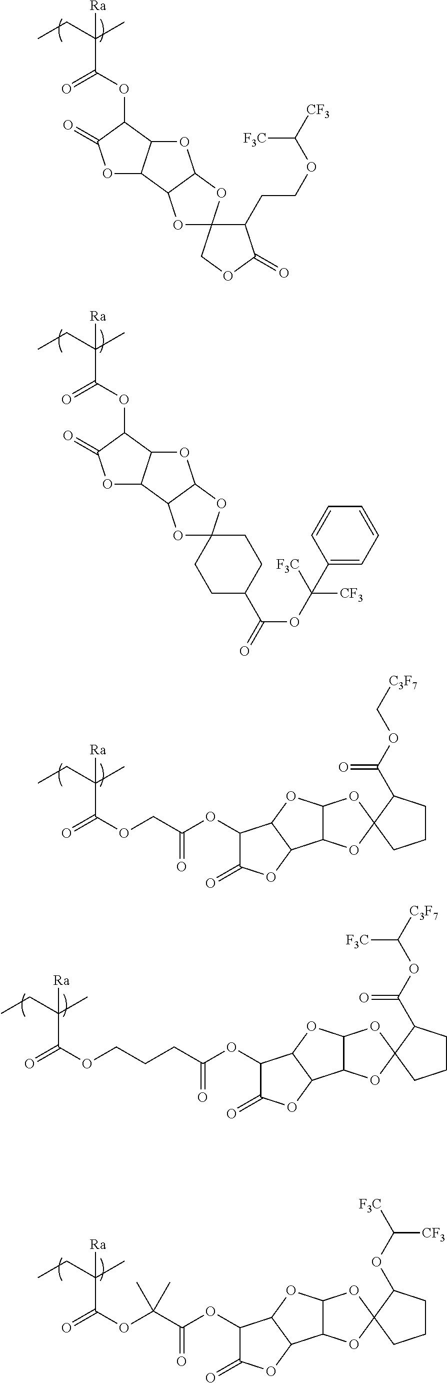

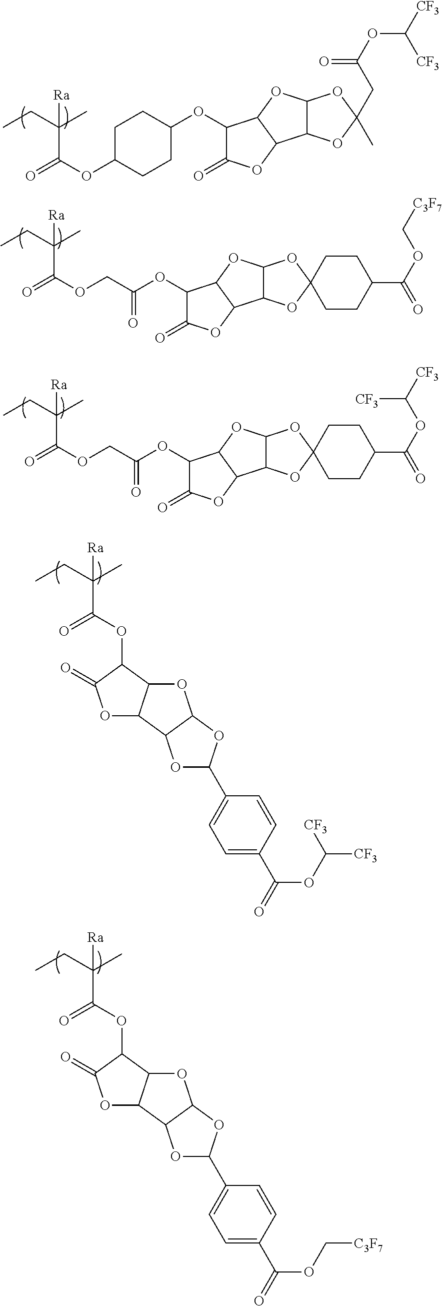

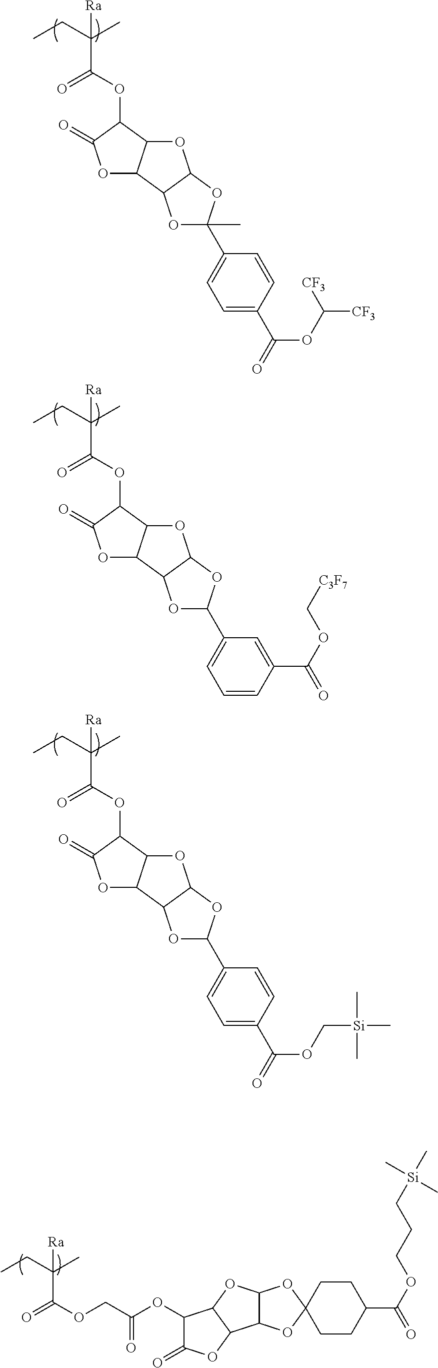

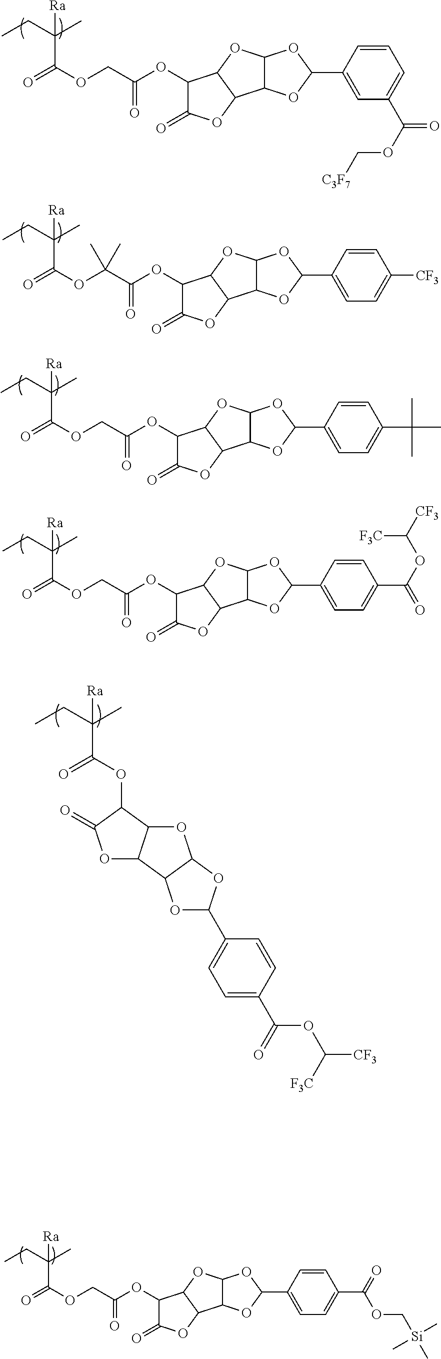

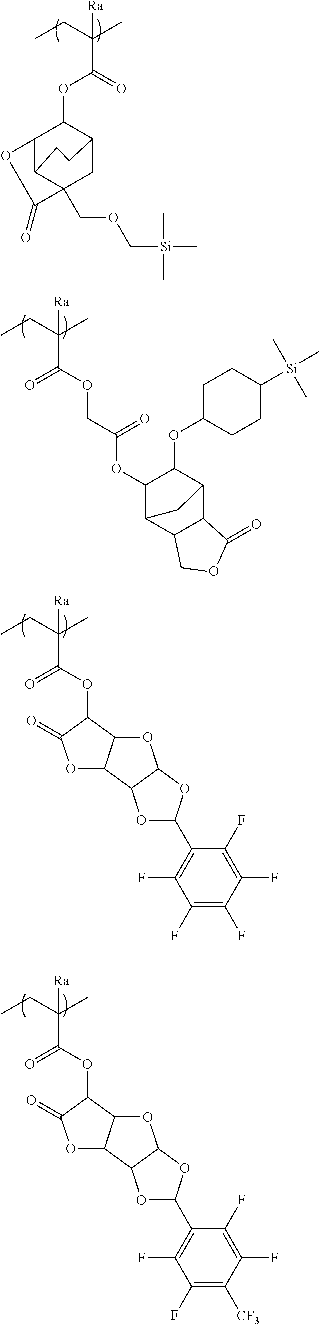

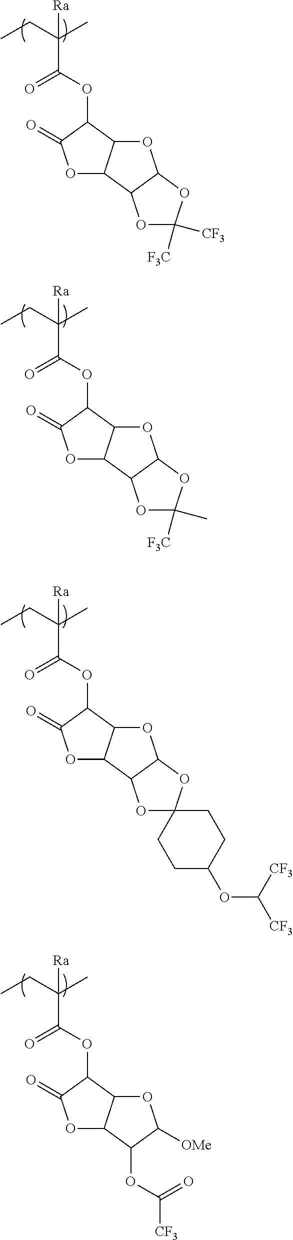

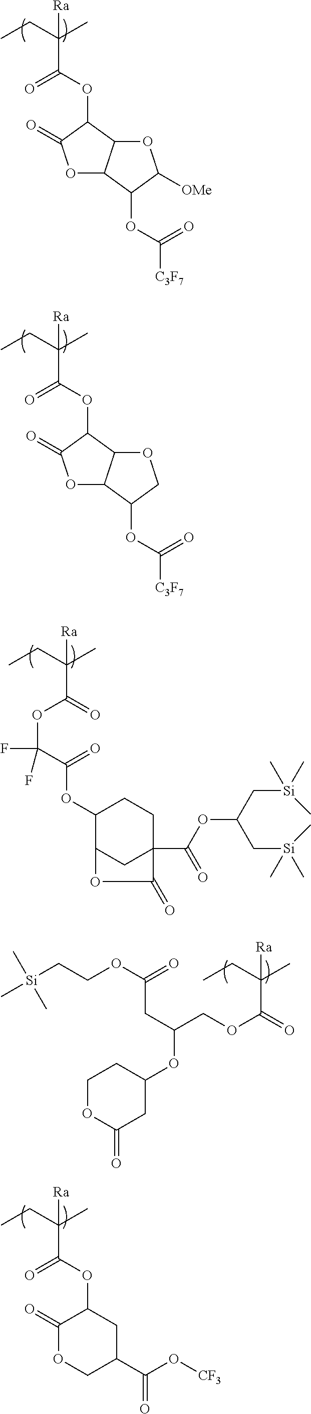

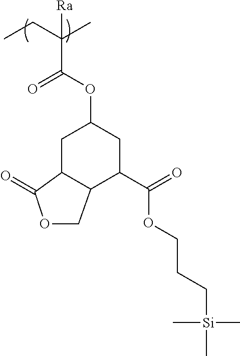

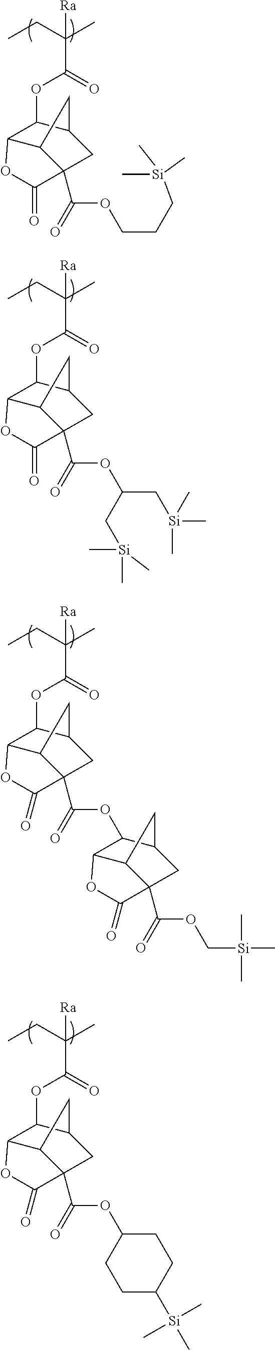

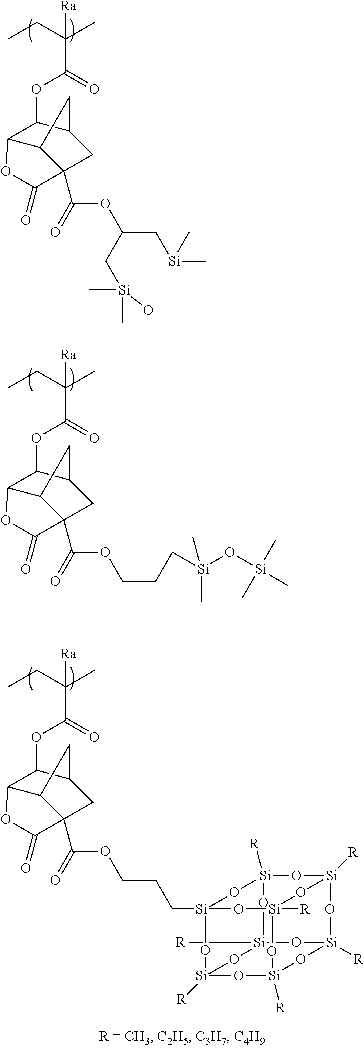

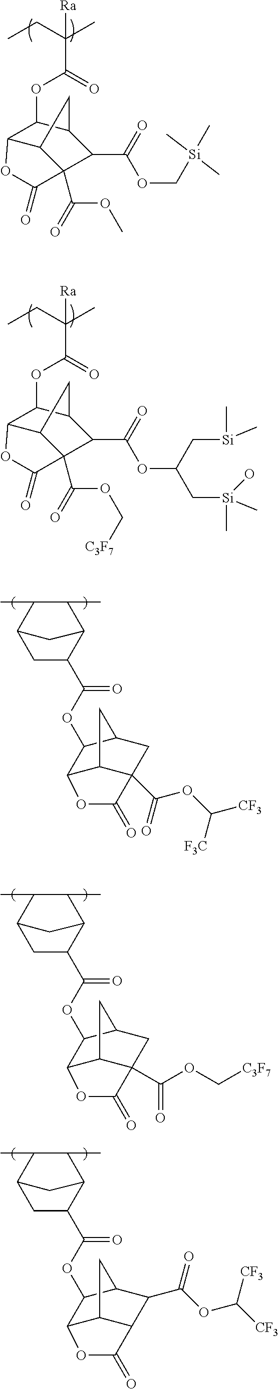

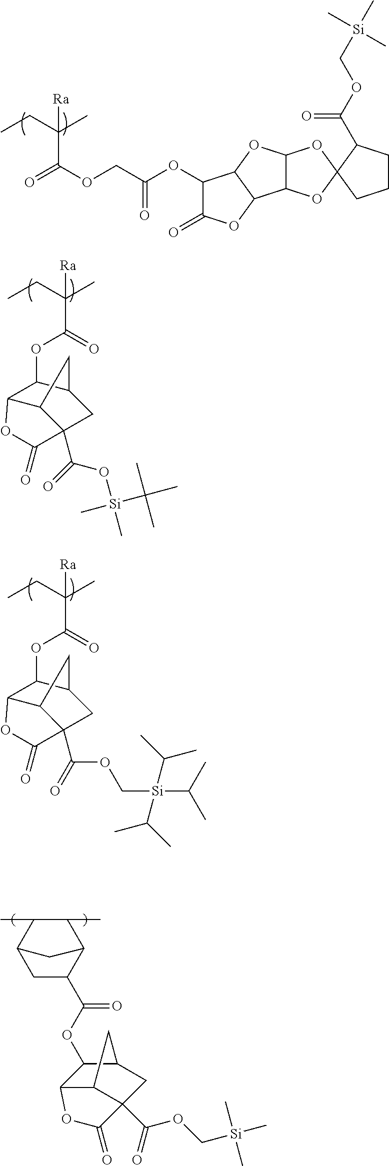

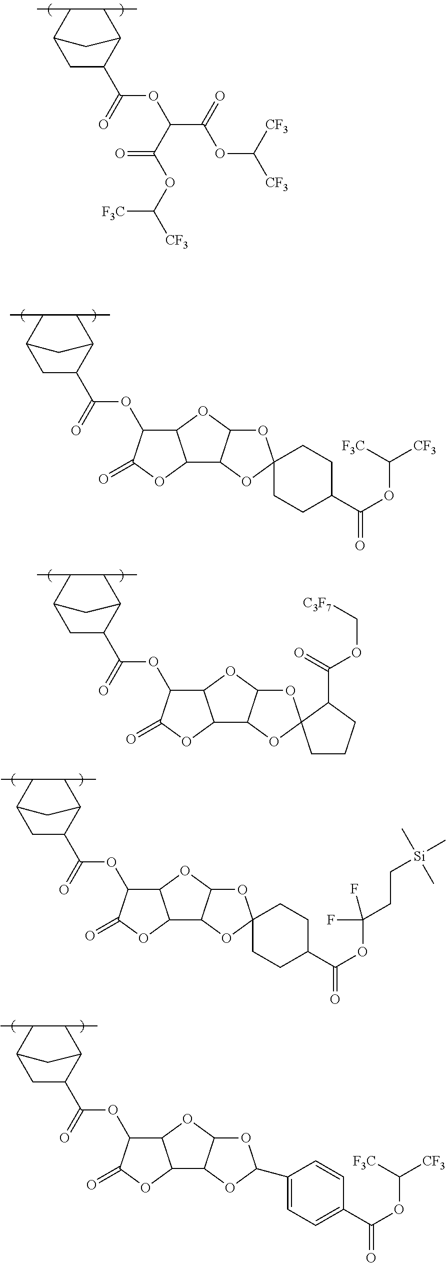

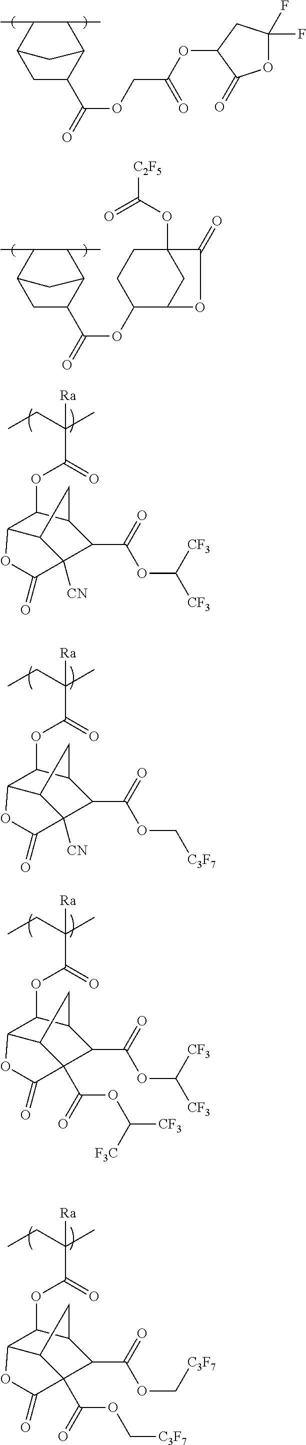

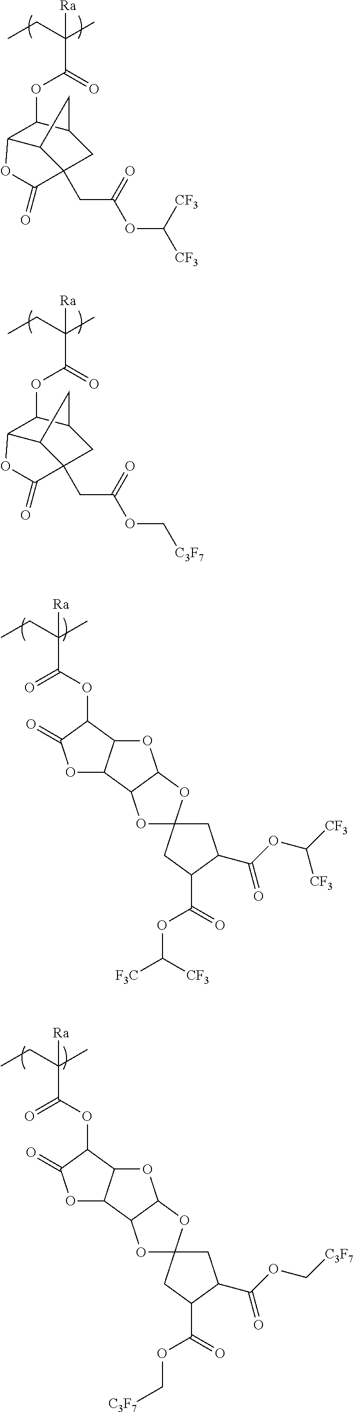

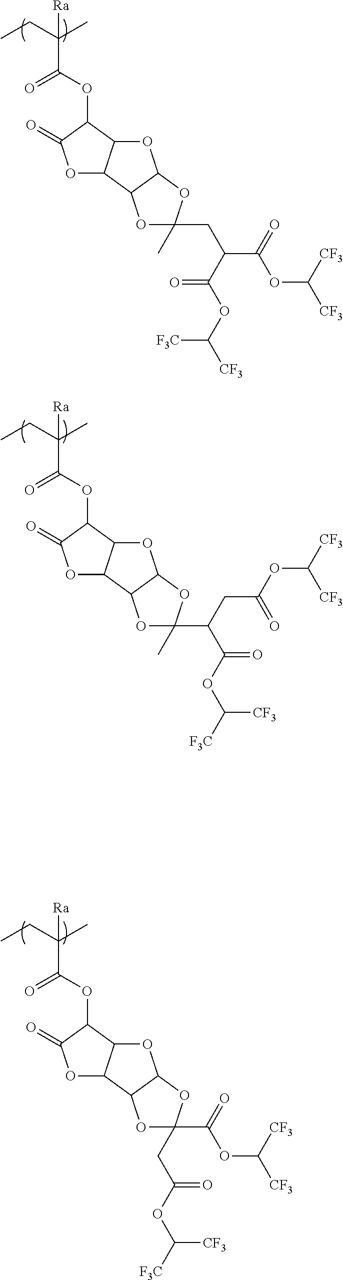

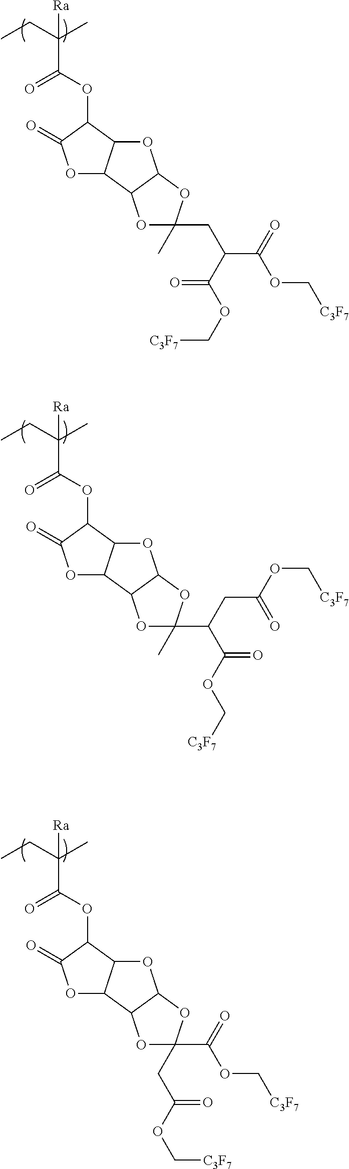

Further, the resin (a) contains at least one atom selected from a fluorine atom and a silicon atom, on the same side chain as the polarity converting group.

The partial structure having a fluorine atom is preferably a structure having an alkyl group having a fluorine atom, a cycloalkyl group having a fluorine atom, or an aryl group having a fluorine atom.

The alkyl group having a fluorine atom (preferably having 1 to 10 carbon atoms, and more preferably 1 to 4 carbon atoms) is a straight or branched alkyl group in which at least one hydrogen atom is substituted by a fluorine atom, and may have a further substituent.

The cycloalkyl group having a fluorine atom is a monocyclic or polycyclic cycloalkyl group in which at least one hydrogen atom is substituted by a fluorine atom, and may have a further substituent.

The aryl group having a fluorine atom may be exemplified by an aryl group such as a phenyl group or a naphthyl group in which at least one hydrogen atom is substituted by a fluorine atom, and may have a further substituent.

Preferred examples of the alkyl group having a fluorine atom, the cycloalkyl group having a fluorine atom, or the aryl group having a fluorine atom may include groups represented by Formulas (F2) to (F4) below, but the present invention is not limited thereto.

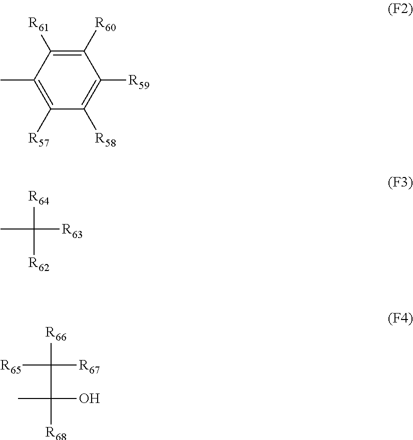

In Formulas (F2) to (F4),

R₅₇ to R₆₈ each independently represent a hydrogen atom, a fluorine atom, or an alkyl group (straight or branched). However, at least one of R₅₇ to R₆₁, at least one of R₆₂ to R₆₄, and at least one of R₆₅ to R₆₈ represents an alkyl group (preferably having 1 to 4 carbon atoms) in which at least one hydrogen atom is substituted by a fluorine atom.

It is preferred that all of R₅₇ to R₆₁ and R₆₅ to R₆₇ are a fluorine atom. R₆₂, R₆₃, and R₆₈ are preferably a fluoroalkyl group (preferably having 1 to 4 carbon atoms), and more preferably a perfluoroalkyl group having 1 to 4 carbon atoms. R₆₂ and R₆₃ may be linked to each other to form a ring.

Specific examples of the group represented by Formula (F2) may include a p-fluorophenyl group, a pentafluorophenyl group, and a 3,5-di(trifluoromethyl)phenyl group.

Specific examples of the group represented by Formula (F3) may include a trifluoromethyl group, a pentafluoropropyl group, a pentafluoroethyl group, a heptafluorobutyl group, a hexafluoroisopropyl group, a heptafluoroisopropyl group, a hexafluoro(2-methyl)isopropyl group, a nonafluorobutyl group, an octafluoroisobutyl group, a nonafluorohexyl group, a nonafluoro-t-butyl group, a perfluoroisopentyl group, a perfluorooctyl group, a perfluoro(trimethyl)hexyl group, a 2,2,3,3-tetrafluorocyclobutyl group, and a perfluorocyclohexyl group. Preferred are a hexafluoroisopropyl group, a heptafluoroisopropyl group, a hexafluoro(2-methyl)isopropyl group, an octafluoroisobutyl group, a nonafluoro-t-butyl group, and a perfluoroisopentyl group, and more preferred are a hexafluoroisopropyl group and a heptafluoroisopropyl group.

Specific examples of the group represented by Formula (F4) may include —C(CF₃)₂OH, —C(C₂F₅)₂OH, —C(CF₃)(CH₃)OH, and —CH(CF₃)OH, and preferred is —C(CF₃)₂OH.

The fluorine-containing partial structure may be bonded directly, or may be bonded through one selected from the group consisting of an alkylene group, a phenylene group, an ether group, a thioether group, a carbonyl group, an ester group, an amide group, a urethane group, and a ureylene group, or a combination of two or more thereof.

The partial structure (group) having a silicon atom is preferably a resin having an alkylsilyl structure (preferably a trialkylsilyl group), or a cyclic siloxane structure.

Specific examples of the alkylsilyl structure or the cyclic siloxane structure may include groups represented by Formulas (CS-1) to (CS-3) below.

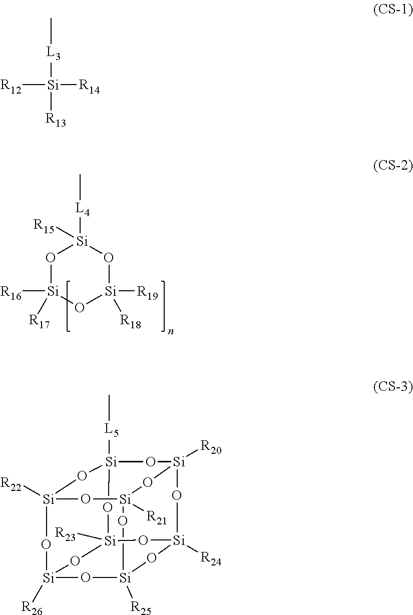

In Formulas (CS-1) to (CS-3),

R₁₂ to R₂₆ each independently represent a straight or branched alkyl group (preferably having 1 to 20 carbon atoms) or a cycloalkyl group (preferably having 3 to 20 carbon atoms).

L₃ to L₅ represent a single bond or a divalent linking group. Examples of the divalent linking group may include one selected from the group consisting of an alkylene group, a phenylene group, an ether group, a thioether group, a carbonyl group, an ester group, an amide group, a urethane group, and a ureylene group, or a combination of two or more thereof.

n represents an integer of 1 to 5.

In the resin (a), a content of the repeating unit represented by Formula (K0) is preferably 10 mol % to 100 mol %, more preferably 20 mol % to 100 mol %, still more preferably 30 mol % to 100 mol %, and most preferably 40 mol % to 100 mol % based on the entire repeating units in the resin (a).

Further, the resin (a) may have at least one group selected from the following groups (x) and (z).

(x) an alkali-soluble group, and

(z) a group capable of decomposing by an action of an acid.

Examples of the alkali-soluble group (x) may include a phenolic hydroxyl group, a carboxylate group, a fluorinated alcohol group, a sulfonate group, a sulfonamide group, a sulfonylimide group, a (alkylsulfonyl)(alkylcarbonyl)methylene group, a (alkylsulfonyl)(alkylcarbonyl)imide group, a bis(alkylcarbonyl)methylene group, a bis(alkylcarbonyl)imide group, a bis(alkylsulfonyl)methylene group, a bis(alkylsulfonyl)imide group, a tris(alkylcarbonyl)methylene group, and a tris(alkylsulfonyl)methylene group.

Preferred examples of the alkali-soluble group may include a fluorinated alcohol group (preferably, hexafluoroisopropanol), a sulfonimide group, a bis(carbonyl)methylene group.

The repeating unit having the alkali-soluble group (x) may be exemplified by a repeating unit in which an alkali-soluble group is bonded directly to the main chain of the resin such as a repeating unit by an acrylic acid or methacrylic acid, or a repeating unit in which an alkali-soluble group is bonded to the main chain of the resin via a linking group, furthermore, may be introduced to a terminal of a polymer chain by using a polymerization initiator or chain transfer agent having an alkali-soluble group, which is preferable in any case.

The content of the repeating unit having the alkali-soluble group (x) is preferably 1 mol % to 50 mol %, more preferably 3 mol % to 35 mol %, and still more preferably 5 mol % to 30 mol % based on the entire repeating units in the resin (a).

Specific examples of the repeating unit having the alkali-soluble group (x) are listed below, but the present invention is not limited thereto. In the specific examples, Rx represents H, CH₃, CH₂OH or CF₃.

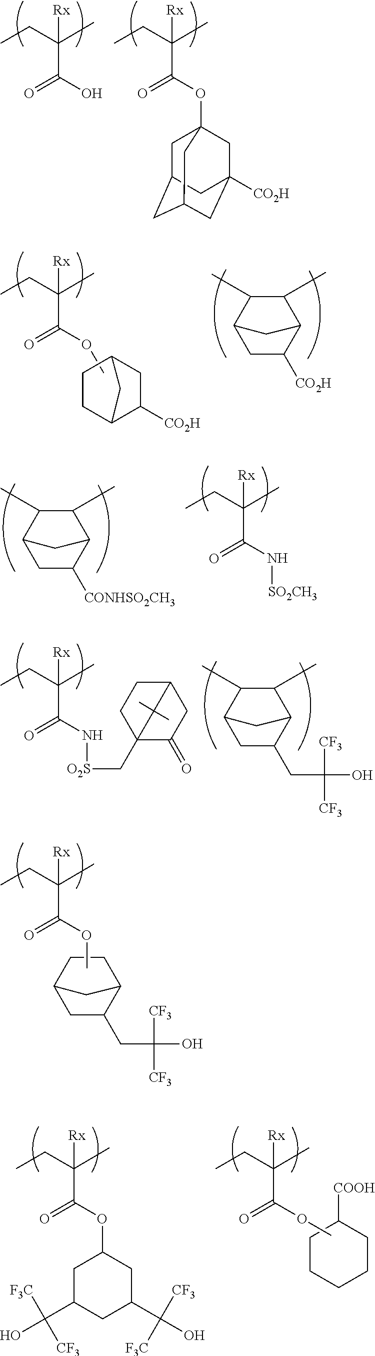

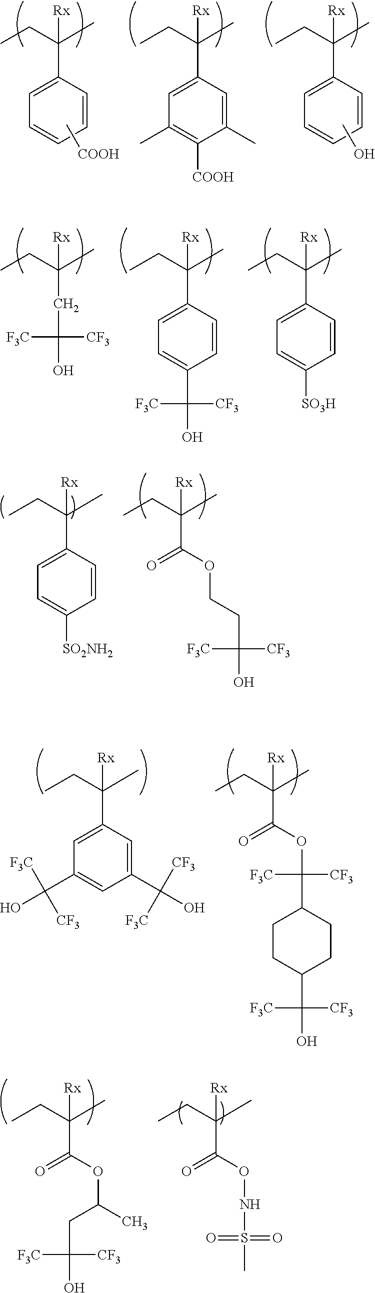

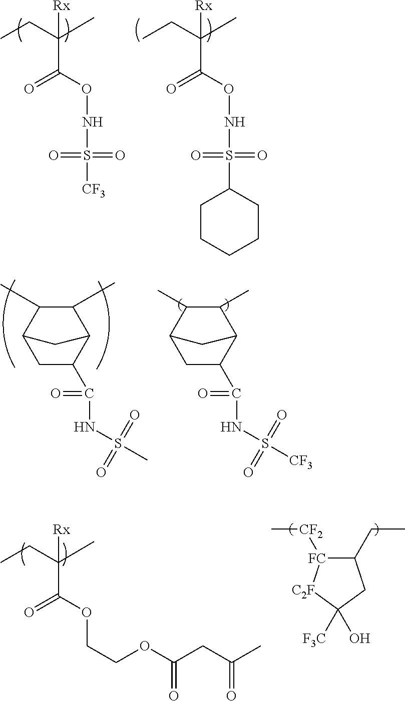

In the resin (a), the repeating unit having the group capable of decomposing by the action of an acid may be exemplified by a repeating unit having an acid-decomposable group. The acid-decomposable group is preferably a cumyl ester group, an enol ester group, an acetal ester group, or a tertiary alkyl ester group. More preferred is a tertiary alkyl ester group.

The repeating unit having the acid-decomposable group is preferably a repeating unit represented by Formula (CAI) below.

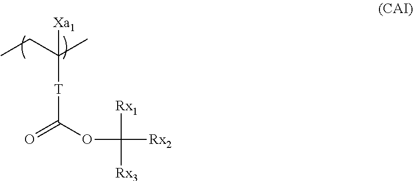

In Formula (CAI),

Xa₁ represents a hydrogen atom, a methyl group, or a group represented by —CH₂—R₉. R₉ represents a hydroxyl group or a monovalent organic group, and examples thereof may include an alkyl group or acyl group having 5 or less carbon atoms, preferably an alkyl group having 3 or less carbon atoms, and more preferably a methyl group. Xa₁ represents preferably a hydrogen atom, a methyl group, a trifluoromethyl group, or a hydroxymethyl group.

T represents a single bond or a divalent linking group.

Rₓ₁ to Rₓ₃ each independently represent an alkyl group (straight or branched) or a cycloalkyl group (monocyclic or polycyclic).

At least two of Rx₁ to Rx₃ may be bonded to form a cycloalkyl group (monocyclic or polycyclic).

Examples of the divalent linking group of T may include an alkylene group, a —COO-Rt- group, and a —O-Rt- group. In the formula, Rt represents an alkylene group or a cycloalkylene group.

T is preferably a single bond or a —COO-Rt- group. Rt is preferably an alkylene group having 1 to 5 carbon atoms, and more preferably a —CH₂— group or a —(CH₂)₃—group.

The alkyl group as Rx₁ to Rx₃ is preferably a group having 1 to 4 carbon atoms such as a methyl group, an ethyl group, a n-propyl group, an isopropyl group, a n-butyl group, an isobutyl group, and a t-butyl group.

The cycloalkyl group of Rx₁ to Rx₃ is preferably a monocyclic cycloalkyl group such as a cyclopentyl group and a cyclohexyl group, or a polycyclic cycloalkyl group such as a norbornyl group, a tetercyclodecanyl group, a tetracyclododecanyl group, and an adamantyl group. The cycloalkyl group formed by bonding at least two of Rx₁ to Rx₃ is preferably a monocyclic cycloalkyl group such as a cyclopentyl group and a cyclohexyl group, or a polycyclic cycloalkyl group such as a norbornyl group, a tetracyclodecanyl group, a tetracyclododecanyl group, and an adamantyl group.

Preferred is an aspect in which Rx₁ is a methyl group or an ethyl group, and Rx₂ and Rx₃ are bonded to form the above-described cycloalkyl group.

Each of the groups may have a substituent, and examples of the substituent may include an alkyl group (having 1 to 4 carbon atoms), a halogen atom, a hydroxyl group, an alkoxy group (having 1 to 4 carbon atoms), a carboxyl group, an alkoxycarbonyl group (having 2 to 6 carbon atoms), and preferably a group having 8 or less carbon atoms.

In the resin (a), the content of the repeating unit having the group capable of decomposing by the action of an acid is preferably 1 mol % to 80 mol %, more preferably 10 mol % to 80 mol %, and still more preferably 20 mol % to 60 mol % based on the entire repeating units in the resin (a). LWR may be enhanced by having the group capable of decomposing by the action of an acid (z).

The resin (a) may further have other repeating units. Preferred aspects of other repeating units are listed below.

(cy1) A repeating unit which has a fluorine atom and/or a silicon atom, is stable to an acid, and is sparingly soluble or insoluble in an alkali solution.

(cy2) A repeating unit which does not have a fluorine atom or a silicon atom, is stable to an acid, and is sparingly soluble or insoluble in an alkali solution.

(cy3) A repeating unit which has a fluorine atom and/or a silicon atom and also has a polar group other than (x) and (z) described above.

(cy4) A repeating unit which does not have a fluorine atom or a silicon atom but has a polar group other than (x) and (z) described above.

In the repeating units of (cy1) and (cy2), the term “sparingly soluble or insoluble in an alkali solution” means that (cy1) and (cy2) do not contain a group capable of generating an alkali-soluble group by an action of an acid or an alkali solution (for example, an acid-decomposable group or a polarity converting group).

The repeating units (cy1) and (cy2) preferably have an aliphatic hydrocarbon structure.

Hereinafter, preferred aspects of the repeating units (cy1) to (cy4) are described.

The repeating units (cy1) and (cy2) are preferably a repeating unit represented by Formula (CIII) below.

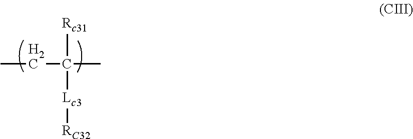

In Formula (CIII),

R_{c31} represents a hydrogen atom, an alkyl group which may be substituted with a fluorine atom, a cyano group, or a —CH₂—O—Rac₂ group. In the formula, Rac₂ represents a hydrogen atom, an alkyl group, or an acyl group. R_{c31} is preferably a hydrogen atom, a methyl group, a hydroxymethyl group, or a trifluoromethyl group, and particularly preferably a hydrogen atom or a methyl group.

R_{c32} represents a group having an alkyl group, a cycloalkyl group, an alkenyl group, or a cycloalkenyl group. These groups may be substituted with a fluorine atom or a silicon atom.

L_{c3} represents a single bond or a divalent linking group.

In Formula (CIII), the alkyl group of R_{c32} is preferably a straight or branched alkyl group having 3 to 20 carbon atoms.

The cycloalkyl group is preferably a cycloalkyl group having 3 to 20 carbon atoms.

The alkenyl group is preferably an alkenyl group having 3 to 20 carbon atoms.

The cycloalkenyl group is preferably a cycloalkenyl group having 3 to 20 carbon atoms.

R_{c32} is preferably an unsubstituted alkyl group or an alkyl group substituted with a fluorine atom.

The divalent linking group of L_{c3} is preferably an ester group, an alkylene group (preferably having 1 to 5 carbon atoms), an oxy group, a phenylene group, or an ester bond (a group represented by —COO—).

The repeating unit (cy1) or (cy2) is preferably a repeating unit represented by Formula

(C4) or (C5) below.

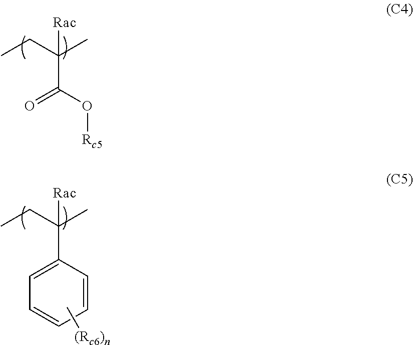

In Formula (C4), R_{c5} has at least one cyclic structure, and represents a hydrocarbon group which has neither a hydroxyl group nor a cyano group.

Rac represents a hydrogen atom, an alkyl group which may be substituted with a fluorine atom, a cyano group, or a —CH₂—O—Rac₂ group. In the formulas, Rac₂ represents a hydrogen atom, an alkyl group, or an acyl group. Rac is preferably a hydrogen atom, a methyl group, a hydroxymethyl group, or a trifluoromethyl group, and particularly preferably a hydrogen atom or a methyl group.

The cyclic structure possessed by R_{c5} includes a monocyclic hydrocarbon group and a polycyclic hydrocarbon group. Examples of the monocyclic hydrocarbon group may include a cycloalkyl group having 3 to 12 carbon atoms and a cycloalkenyl group having 3 to 12 carbon atoms. A preferred monocyclic hydrocarbon group is a monocyclic hydrocarbon group having 3 to 7 carbon atoms.

The polycyclic hydrocarbon group includes a ring-aggregated hydrocarbon group and a crosslinked hydrocarbon group. Examples of the crosslinked hydrocarbon ring may include a bicyclic hydrocarbon ring, a tricyclic hydrocarbon ring, and a tetracyclic hydrocarbon ring. Further, the crosslinked hydrocarbon ring also includes a condensed hydrocarbon ring (for example, a condensed ring in which a plurality of 5- to 8-membered cycloalkane rings are condensed). Preferred examples of the crosslinked hydrocarbon ring may include a norbornyl group and an adamantyl group.

The alicyclic hydrocarbon group may have a substituent, and preferred examples of the substituent may include a halogen atom, alkyl group, a hydroxyl group protected by a protecting group, and an amino group protected by a protecting group. Preferred examples of the halogen atom may include a bromine, chlorine, and fluorine atom, and preferred examples of the alkyl group may include a methyl, ethyl, butyl, and t-butyl group. The alkyl group may further have a substituent, and examples of the further substituent may include a halogen atom, an alkyl group, a hydroxyl group protected by a protecting group, and an amino group protected by a protecting group.

Examples of the protecting group may include an alkyl group, a cycloalkyl group, an aralkyl group, a substituted methyl group, a substituted ethyl group, an alkoxycarbonyl group, and an aralkyloxycarbonyl group. Preferred examples of the alkyl group may include an alkyl group having 1 to 4 carbon atoms, preferred examples of the substituted methyl group may include a methoxymethyl, methoxythiomethyl, benzyoxymethyl, t-butoxymethyl, and 2-methoxyethoxymethyl group, preferred examples of the substituted ethyl group may include 1-ethoxyethyl and 1-methyl-1-methoxyethyl, preferred examples of the acyl group may include a aliphatic acy group having 1 to 6 carbon atoms such as a formyl, acetyl, propionyl, butyryl, isobutyryl, valeryl, pyvaloyl group, and examples of the alkoxycarbonyl group may include an alkoxycarbonyl group having 1 to 4 carbon atoms.

In Formula (C5), R_{c6} represents an alkyl group, a cycloalkyl group, an alkenyl group, a cycloalkenyl group, an alkoxycarbonyl group, or an alkylcarbonyloxy group. These groups may be substituted with a fluorine atom or a silicon atom.

The alkyl group of R_{c6} is preferably a straight or branched alkyl group having 1 to 20 carbon atoms.

The cycloalkyl group is preferably a cycloalkyl group having 3 to 20 carbon atoms.

The alkenyl group is preferably an alkenyl group having 3 to 20 carbon atoms.

The cycloalkenyl group is preferably a cycloalkenyl group having 3 to 20 carbon atoms.

The alkoxycarbonyl group is preferably an alkoxycarbonyl group having 2 to 20 carbon atoms.

The alkylcarbonyloxy group is preferably an alkylcarbonyloxy group having 2 to 20 carbon atoms.

n represents an integer of 0 to 5. When n is 2 or more, a plurality of R_{c6}'s may be same or different.

R_{c6} is preferably an unsubstituted alkyl group or an alkyl group substituted with a fluorine atom, and particularly preferably a trifluoromethyl group or a t-butyl group.

As (cy1) or (cy2), a repeating unit represented by Formula (CII-AB) below is also preferred.

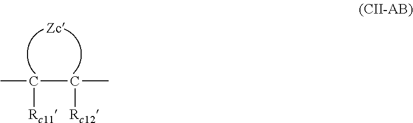

In Formula (CII-AB),

R_{c11}′ and R_{c12}′ each independently represent a hydrogen atom, a cyano group, a halogen atom, or an alkyl group.

Zc′ contains two bonded carbon atoms (C—C), and represents an atomic group for forming an alicyclic structure.

Further, Formula (CII-AB) above is more preferably Formula (CII-AB1) or Formula (CII-AB2) below.

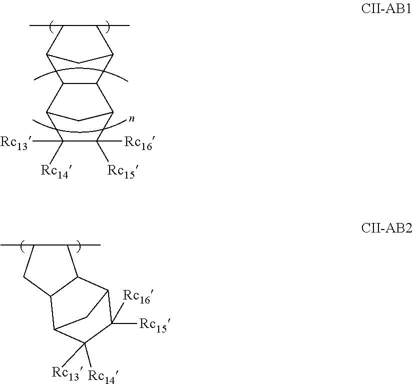

In Formula (CII-AB1) and Formula (CII-AB2),

R_{c13}′ to R_{c16}′ each independently represent a hydrogen atom, a halogen atom, an alkyl group, or a cycloalkyl group.

Further, at least two of R_{c13}′ to R_{c16}′ may be bonded to form a ring.

n represents 0 or 1.

Specific examples of (cy1) and (cy2) will be listed below, but the present invention is not limited thereto. In the formulas, Ra represents H, CH₃, CH₂OH, CF₃, or CN.

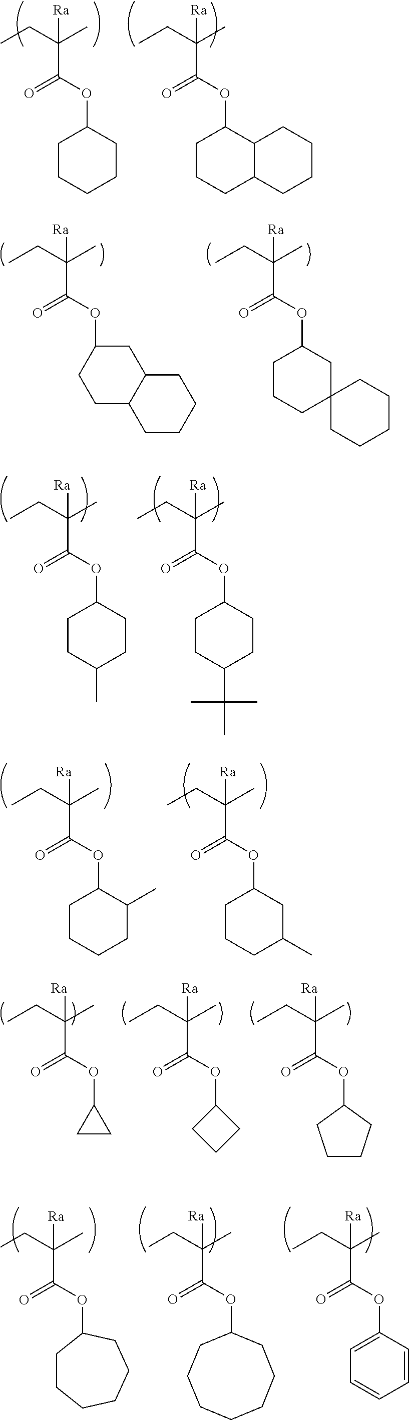

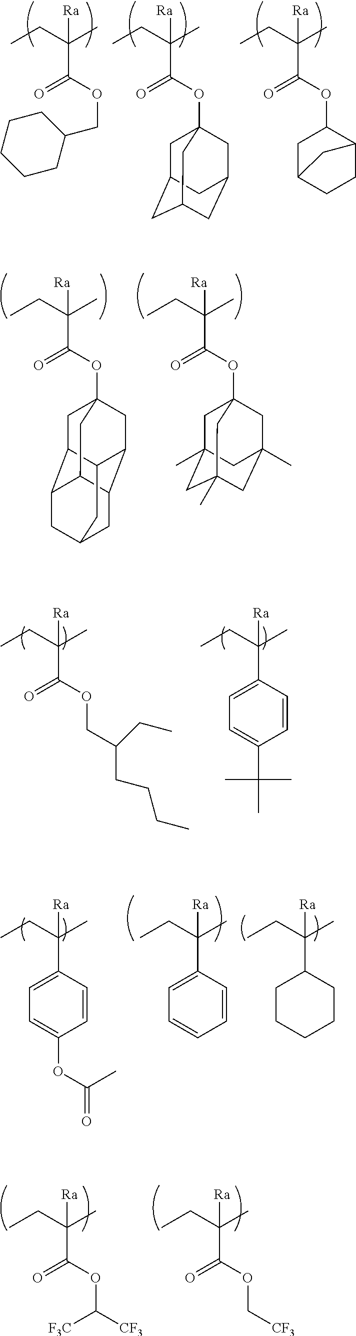

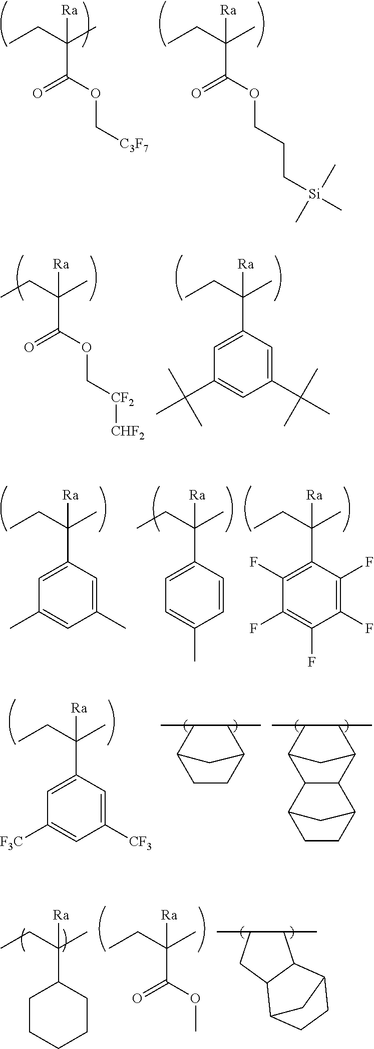

As (cy3) or (cy4), a repeating group having a hydroxyl group or a cyano group as a polar group is preferred. Accordingly, developer compatibility is enhanced. The repeating unit having a hydroxyl group or a cyano group is preferably a repeating unit having an alicyclic hydrocarbon structure substituted with a hydroxyl group or a cyano group. In the alicyclic hydrocarbon structure substituted with a hydroxyl group or a cyano group, the alicyclic hydrocarbon structure is preferably an adamantyl group, a diamatyl group, or a norbornyl group. Preferred examples of the alicyclic hydrocarbon structure substituted with a hydroxyl group or a cyano group may include a monohydroxyadamantyl group, a dihydroxyadamantyl group, a monohydroxydiamatyl group, a dihydroxyadamantyl group, and a norbornyl group substituted with a cyano group.

Examples of the repeating unit having the atomic groups described above may include repeating units represented by Formulas (CAIIa) to (CAIId) below.

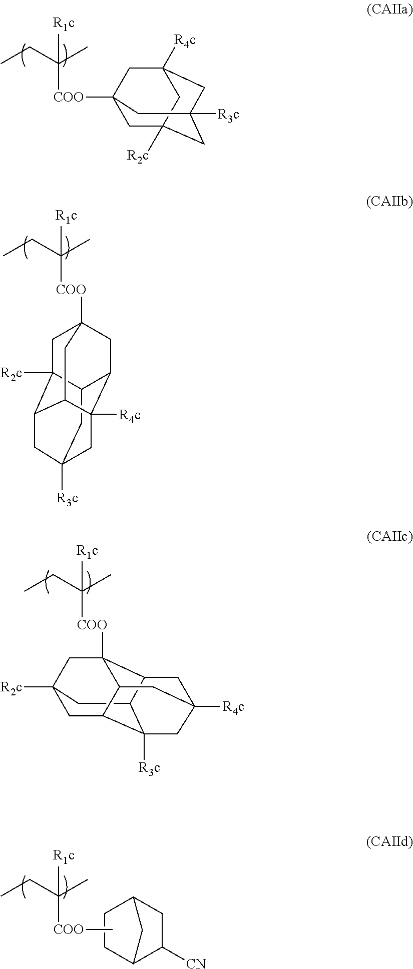

In Formulas (CAIIa) to (CAIId),

R_{1c} represents a hydrogen atom, a methyl group, a trifluoromethyl group, or a hydroxymethyl group.

R_{2c} to R_{4c} each independently represent a hydrogen atom, a hydroxyl group, or a cyano group. However, at least one of R_{2c} to R_{4c} represents a hydroxyl group or a cyano group. Preferably, one or two of R_{2c} to R_{4c} are hydroxyl groups, and the others are hydrogen atoms. In Formula (CAIIa), more preferably, two of R_{2c} to R_{4c} are hydroxyl groups, and the others are hydrogen atoms.

Specific examples of the repeating units represented by (cy3), (cy4) are listed below, but the present invention is not limited thereto.

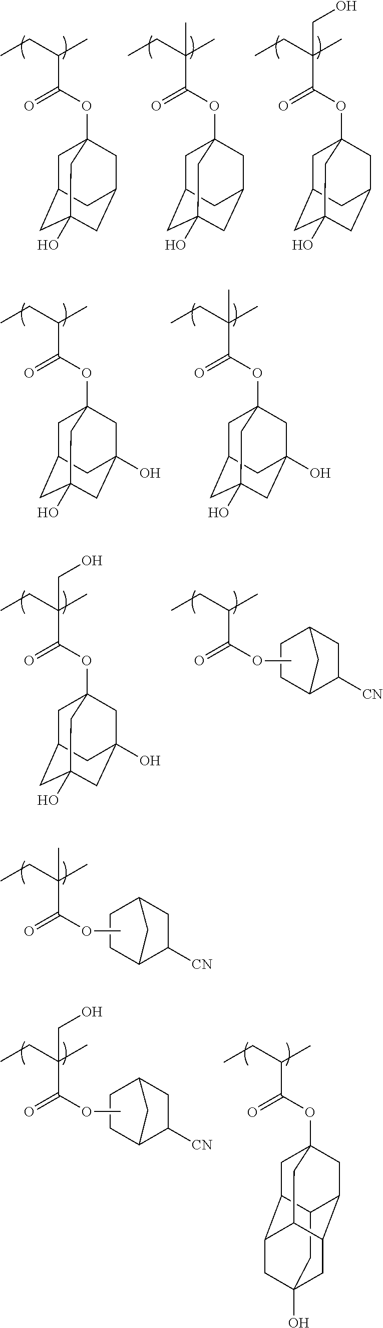

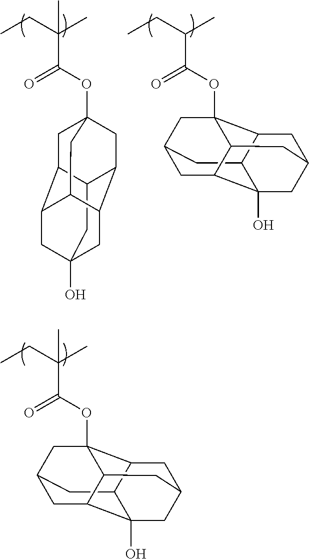

The content of the repeating units represented by (cy1) to (cy4) is preferably 5 mol % to 40 mol %, more preferably 5 mol % to 30 mol %, and still more preferably 10 mol % to 25 mol % based on the entire repeating units in the resin (a).

The resin (a) may have a plurality of repeating units represented by (cy1) to (cy4).

When the resin (a) has a fluorine atom, the content of the fluorine atom is preferably 5% by mass to 80% by mass, and more preferably 10% by mass to 80% by mass based on the molecular weight of the resin (a). Further, the repeating unit containing a fluorine atom is preferably 10% by mass to 100% by mass, and more preferably 30% by mass to 100% by mas based on the entire repeating units in the resin (a).

When the resin (a) has a silicon atom, the content of the silicon atom is preferably 2% by mass to 50% by mass, and more preferably 2% by mass to 30% by mass based on the molecular weight of the resin (a). Further, the repeating unit containing a silicon atom is preferably 10% by mass to 90% by mass, and more preferably 20% by mass to 80% by mass based on the entire repeating units in the resin (a).

The weight average molecular weight of the resin (a) in terms of standard polystyrene is preferably 1,000 to 100,000, more preferably 1,000 to 50,000, and still more preferably 2,000 to 15,000.

The content of the resin (a) in the total solid content of the hard coat layer forming composition may be appropriately adjusted, but is preferably 0.0001% by mass to 1% by mass, more preferably 0.0005% by mass to 0.1% by mass, and still more preferably 0.001% by mass to 0.05% by mass based on the total solid content of the hard coat layer forming composition.

The resin (a) may be synthesized or purified by a general method, there is less impurities such as metal as a matter of course, and a residual monomer or oligomer component is preferably 0% by mass to 10% by mass, more preferably 0% by mass to 5% by mass, and still more preferably 0% by mass to 1% by mass. Accordingly, a resist may be obtained without a temporal change such as foreign substances in the liquid or sensitivity. Further, from the viewpoint of a resolution, a resist shape, a sidewall of a resist pattern, or roughness, the molecular weight distribution (Mw/Mn, also referred to as a polydispersity) is preferably in a range of 1 to 3, more preferably 1 to 2, still more preferably 1 to 1.8, and most preferably 1 to 1.5.

The resin (a) may be commercially available, or may be synthesized by a general method (for example, radical polymerization).

Specific examples of the resin (a) will be described. Further, in the following tables, the molar ratio of the repeating units (sequentially corresponding to each repeating unit from the left), the weight average molecular weight (Mw), and the polydispersity (Mw/Mn) of each resin are described.

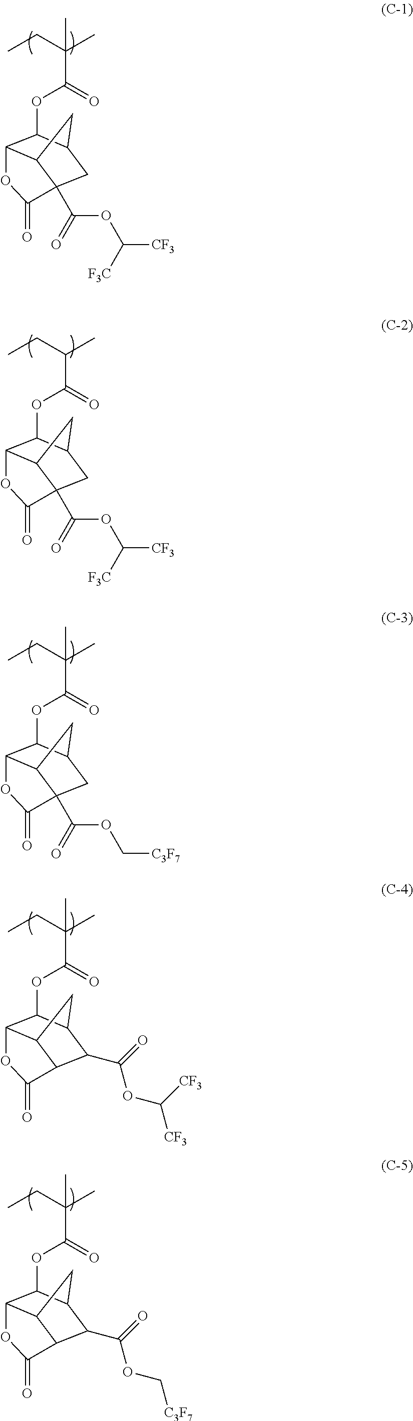

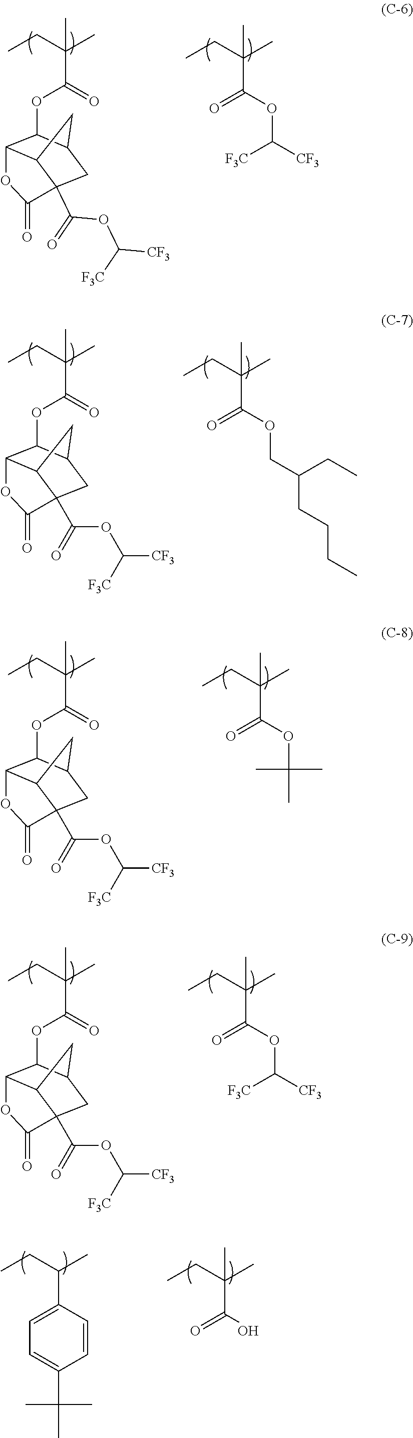

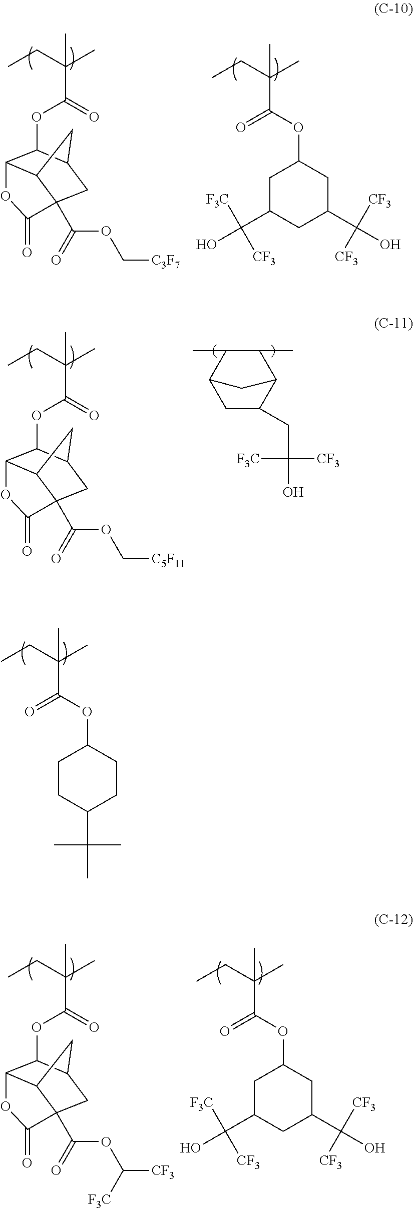

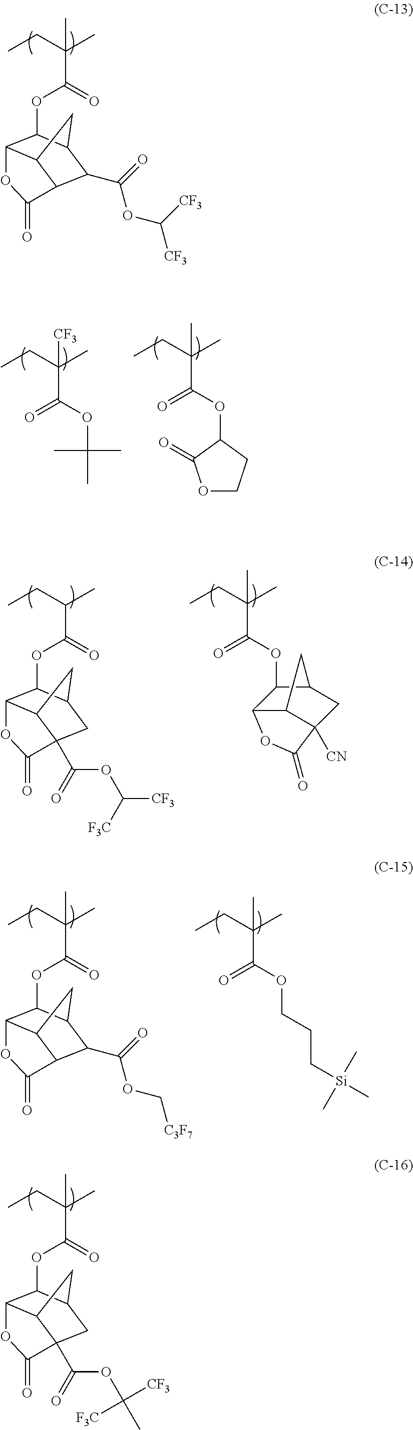

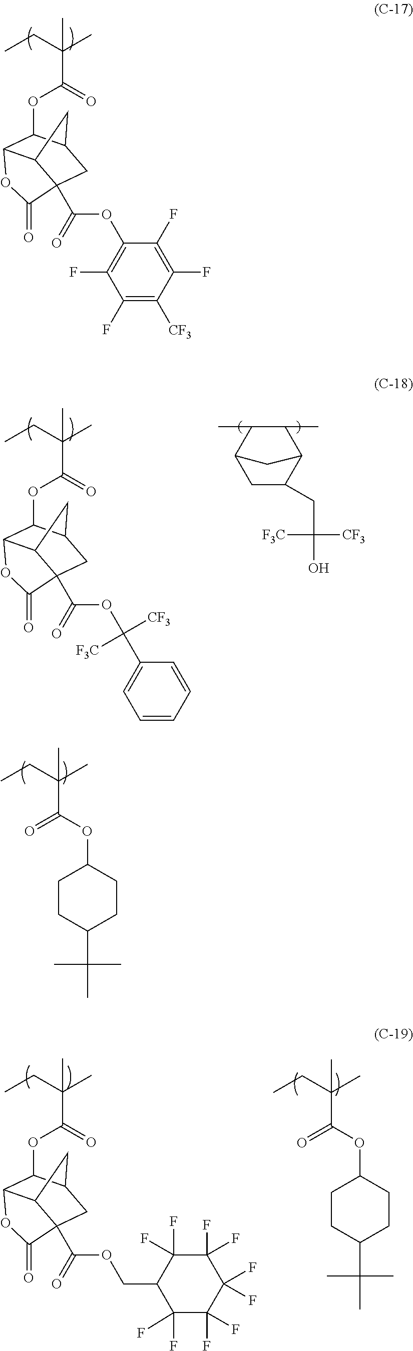

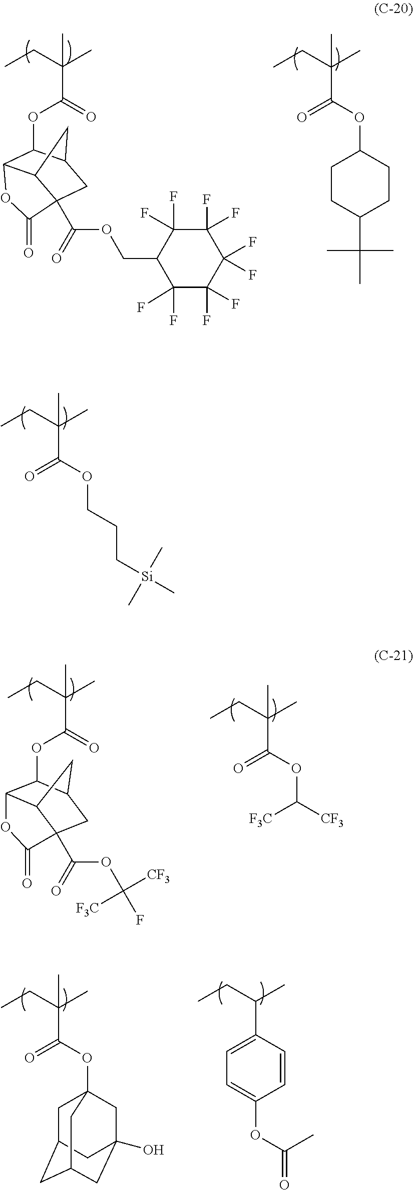

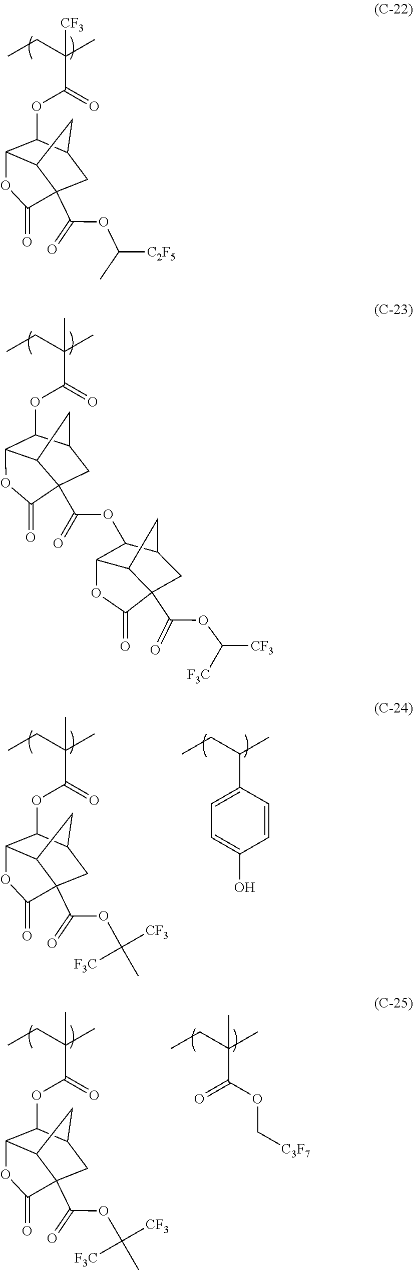

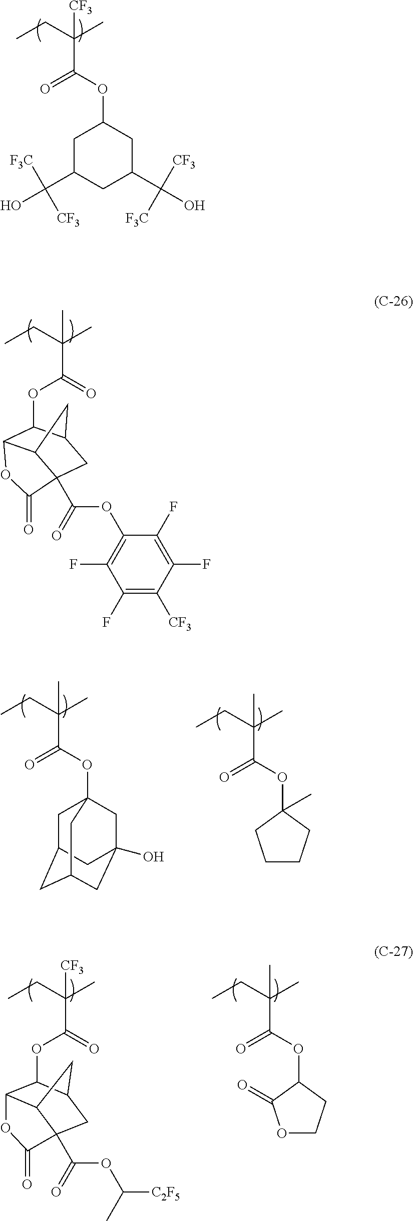

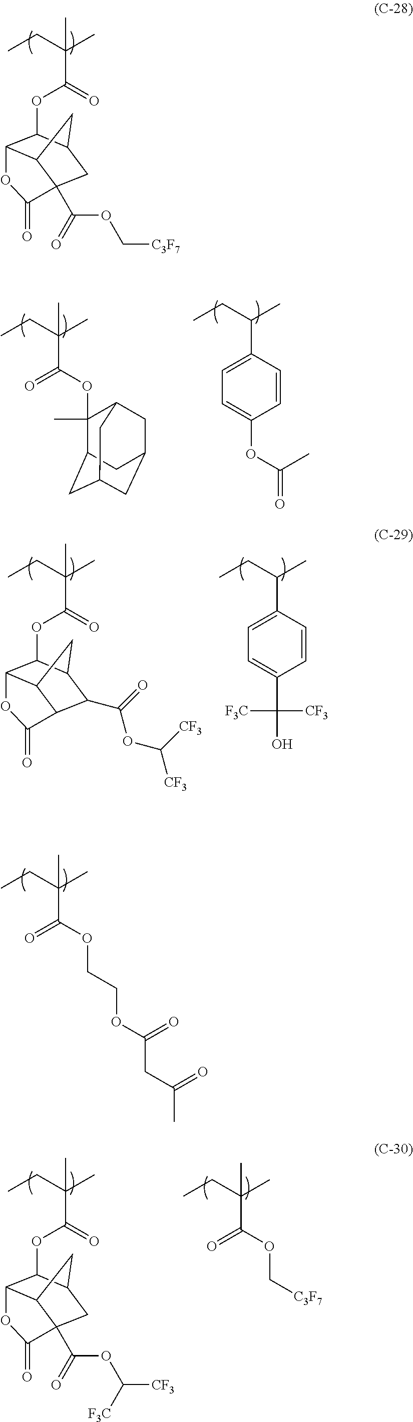

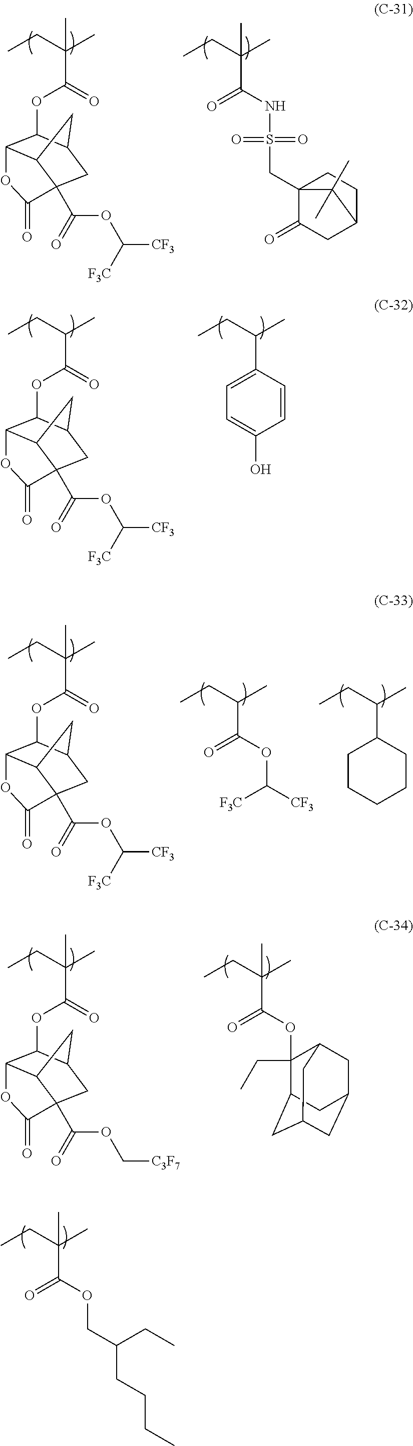

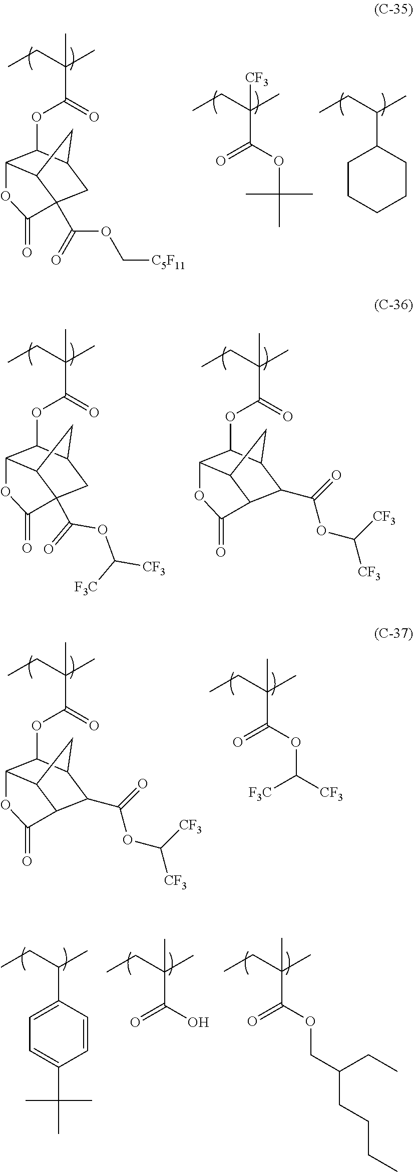

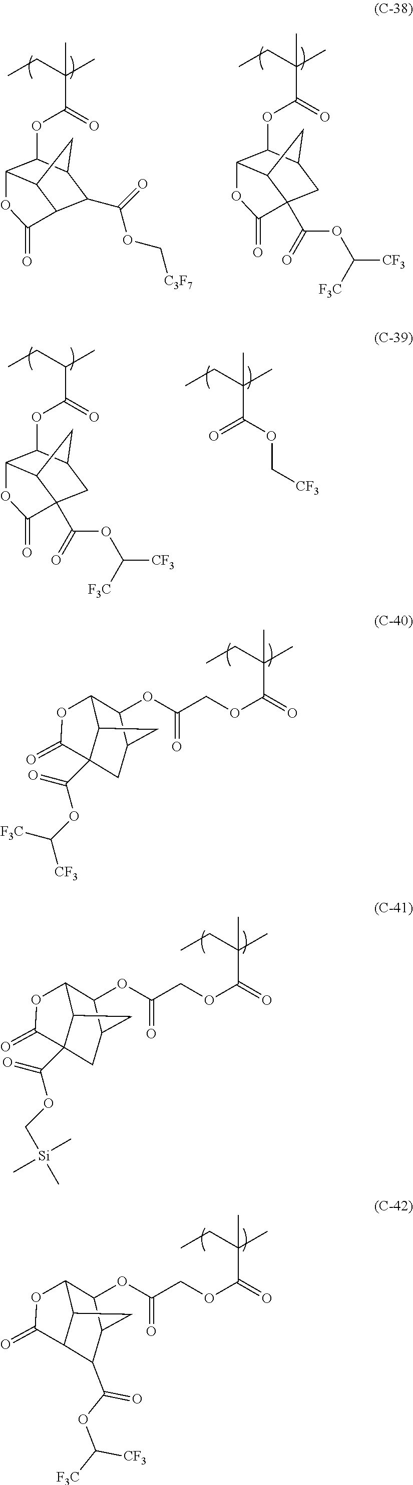

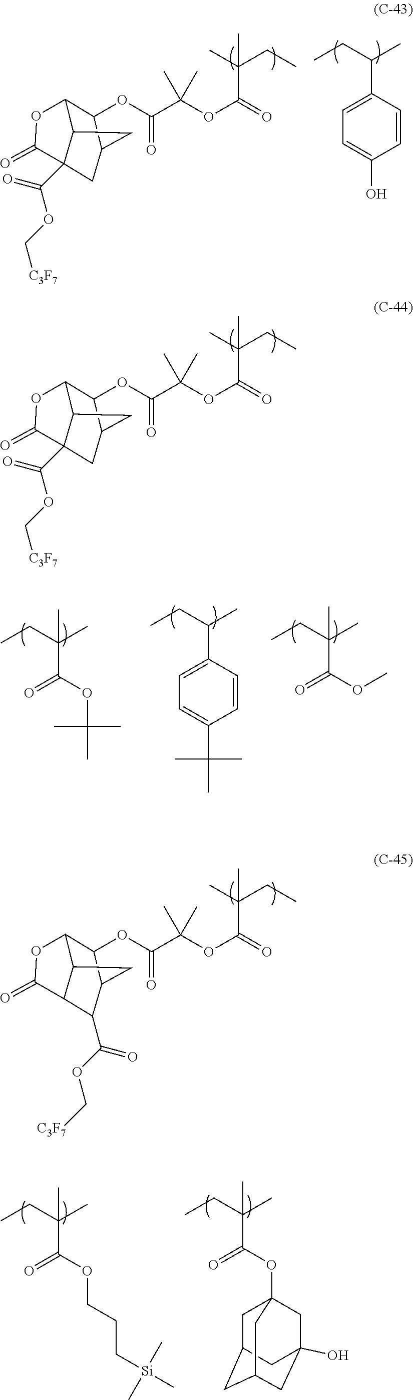

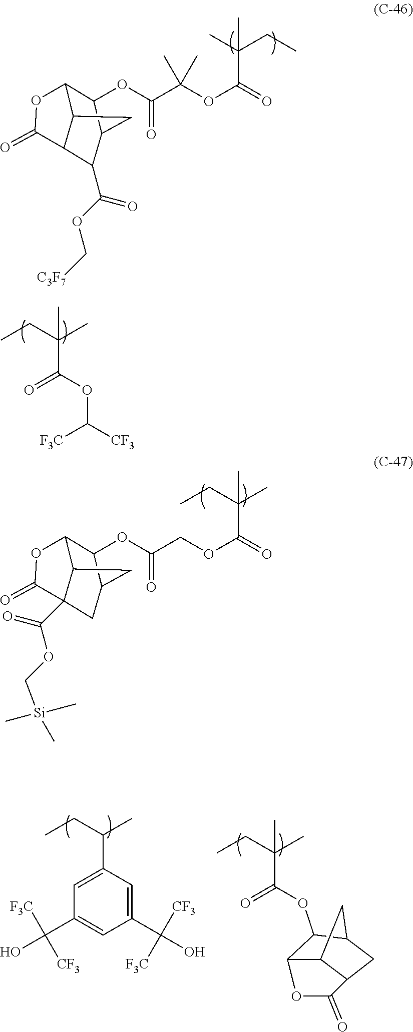

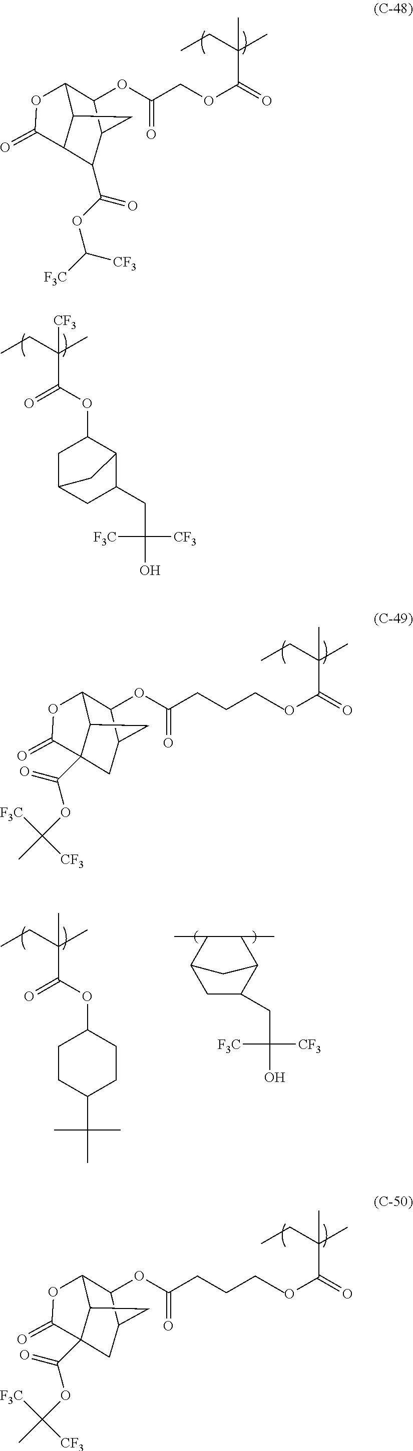

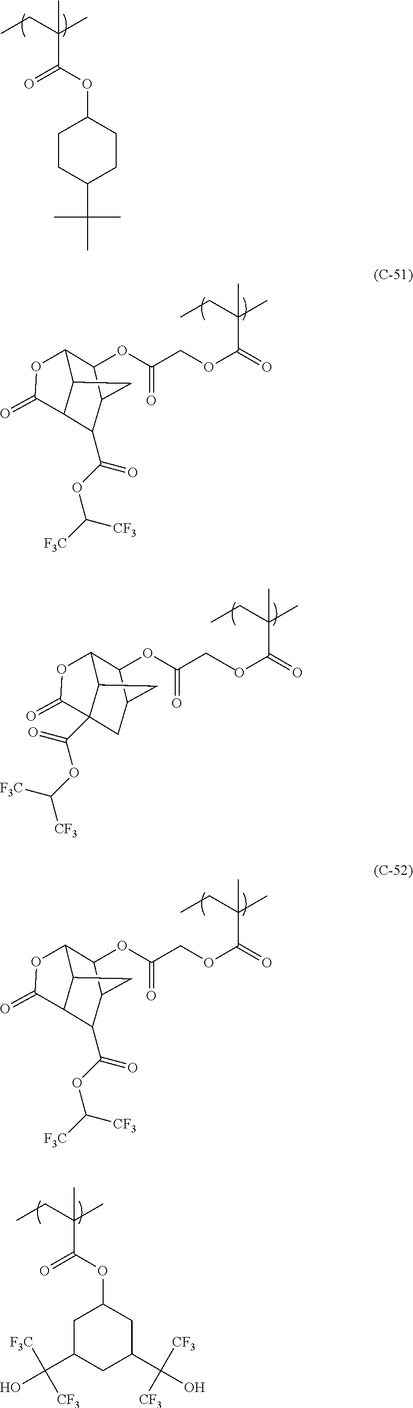

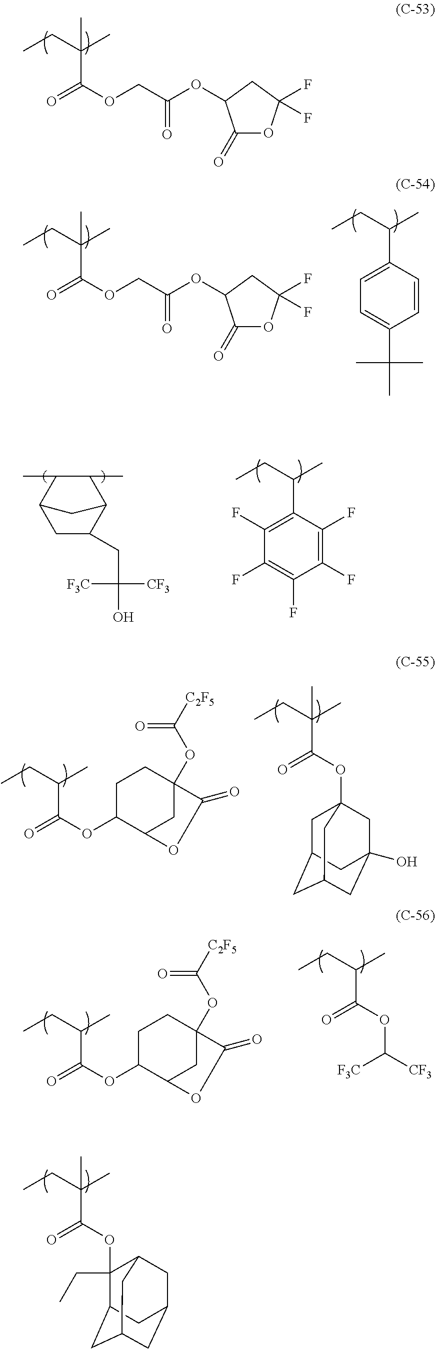

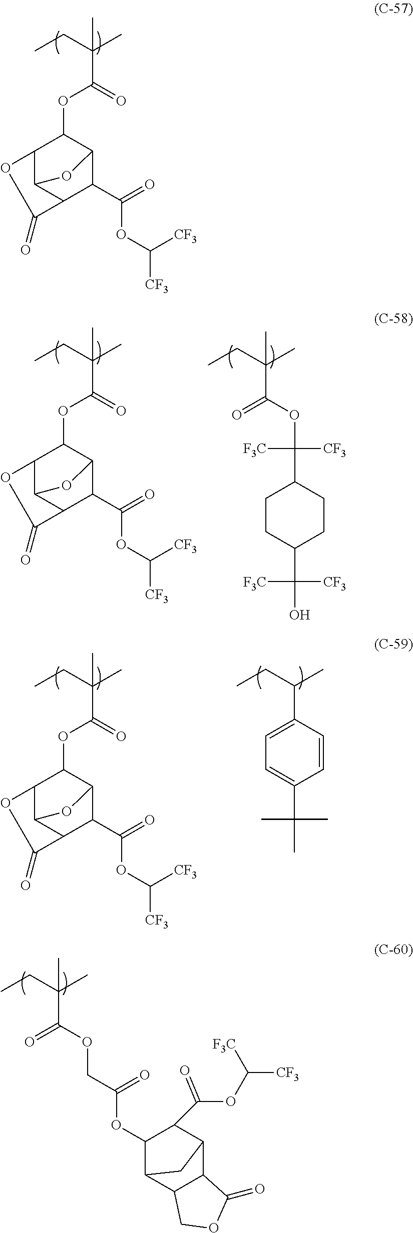

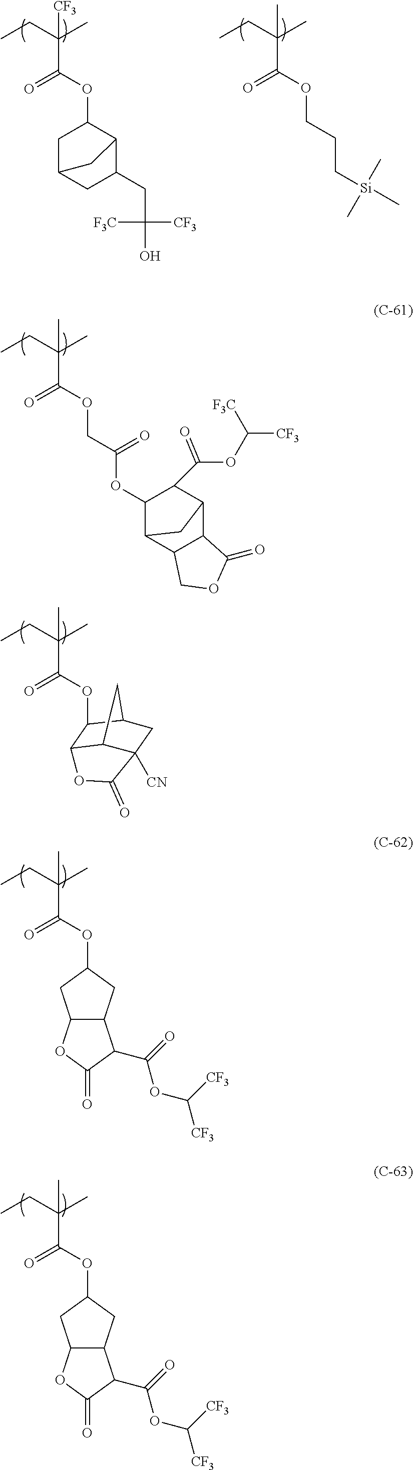

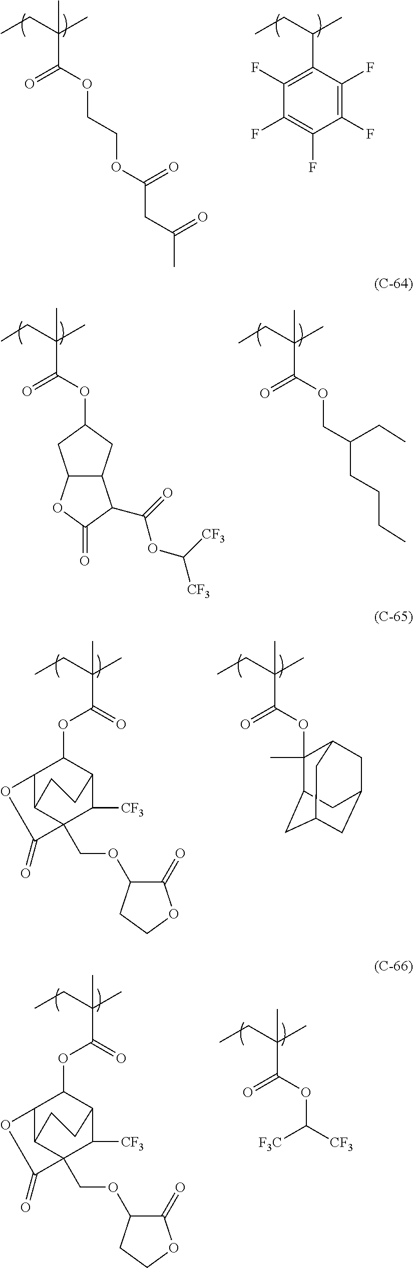

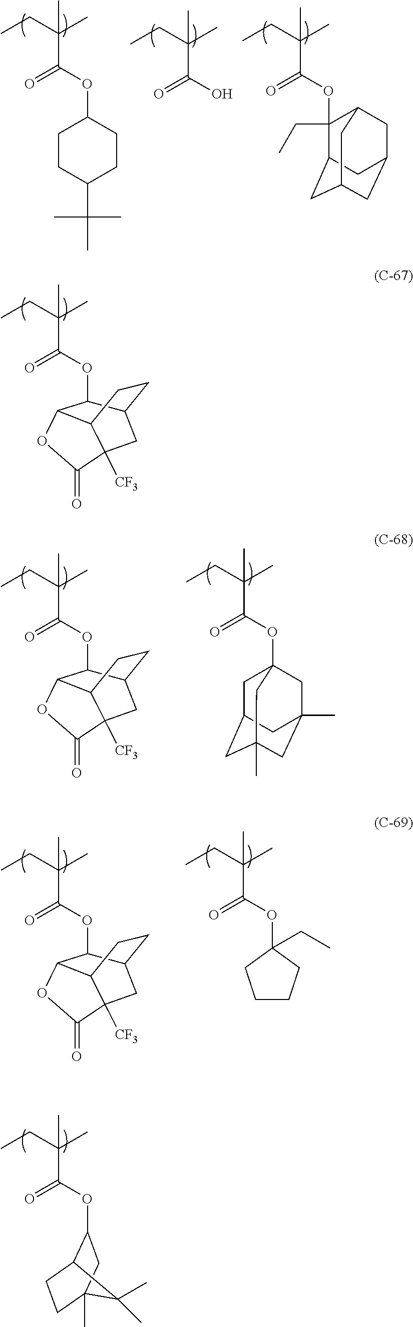

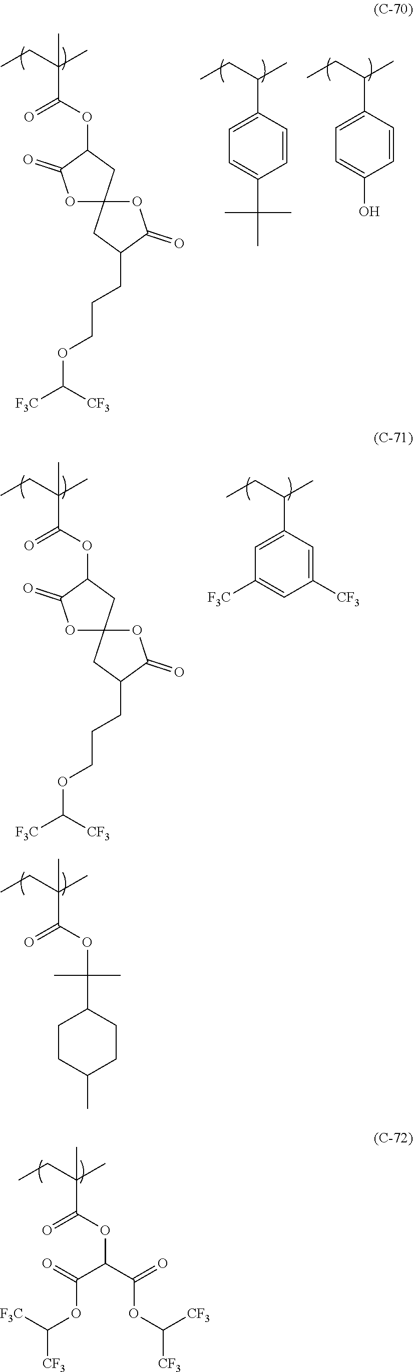

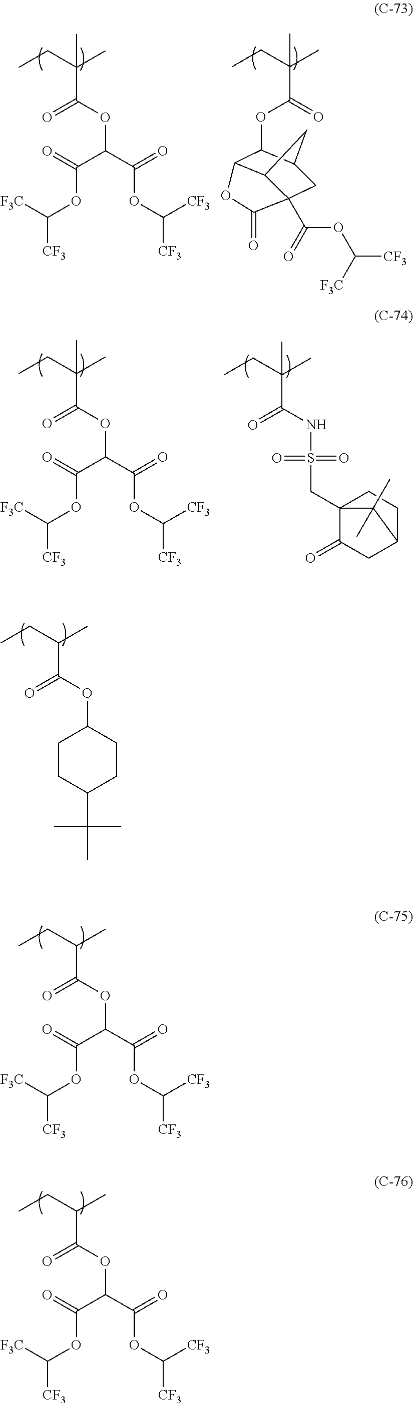

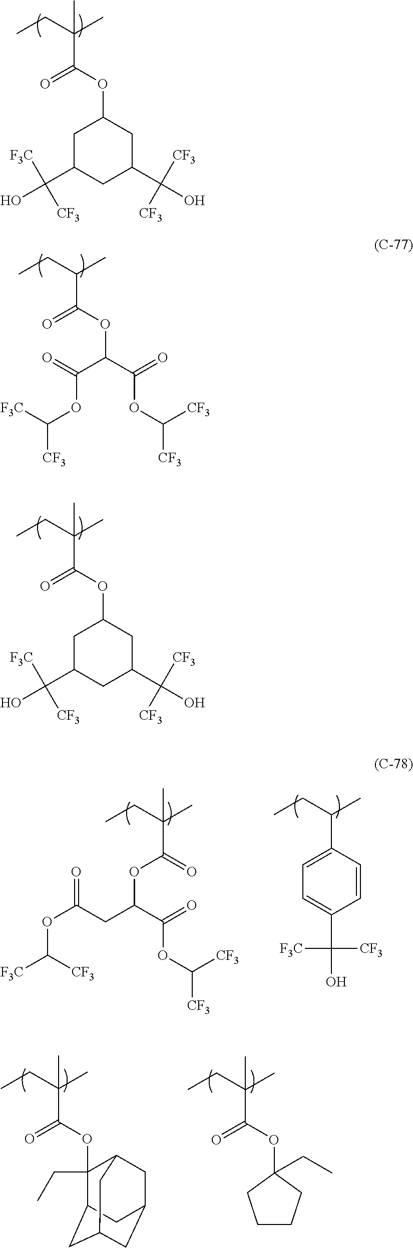

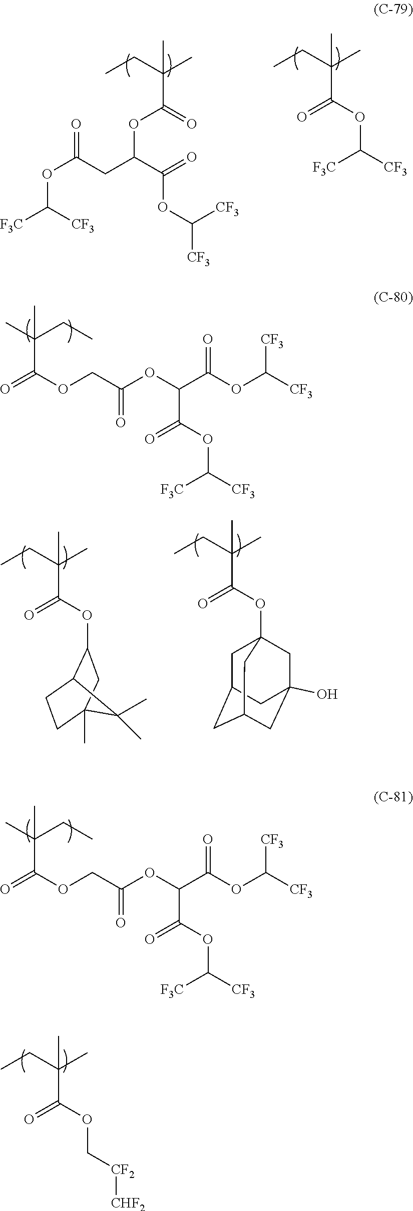

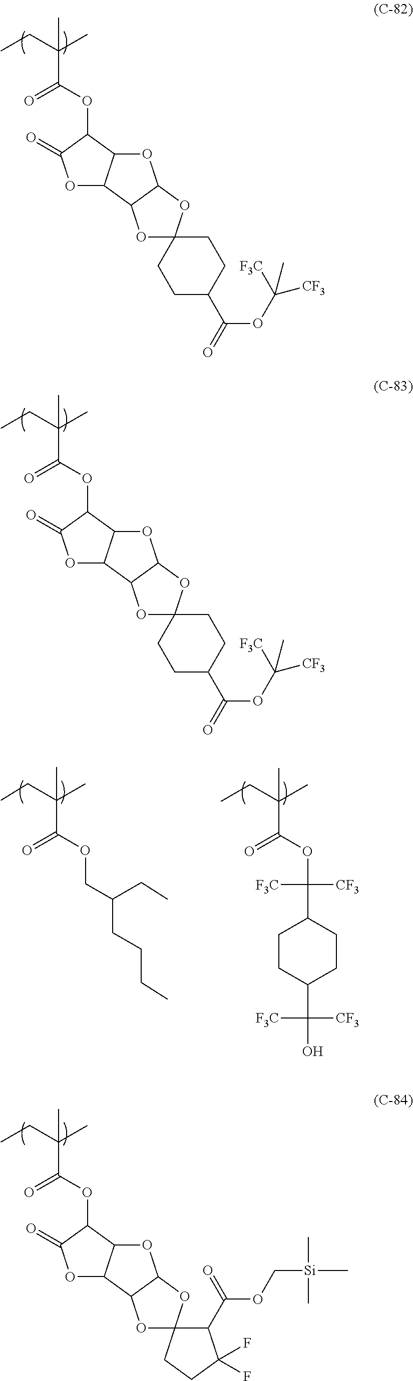

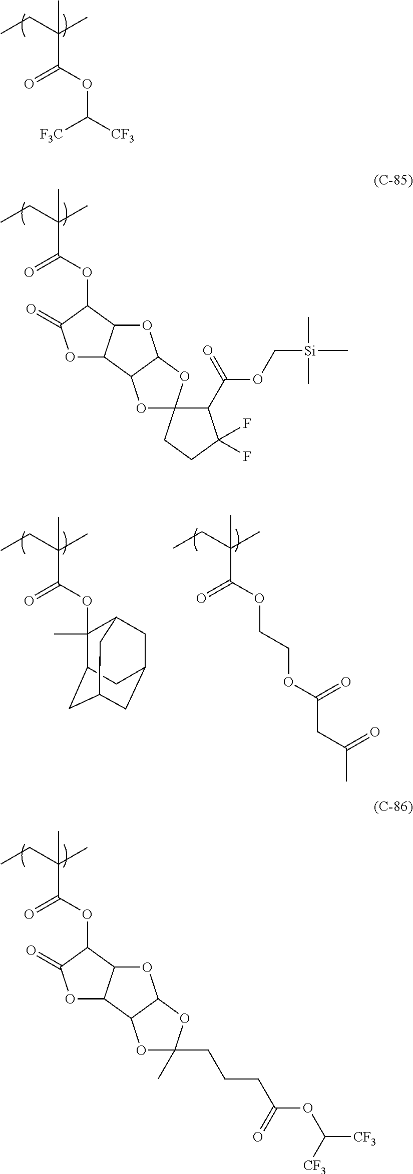

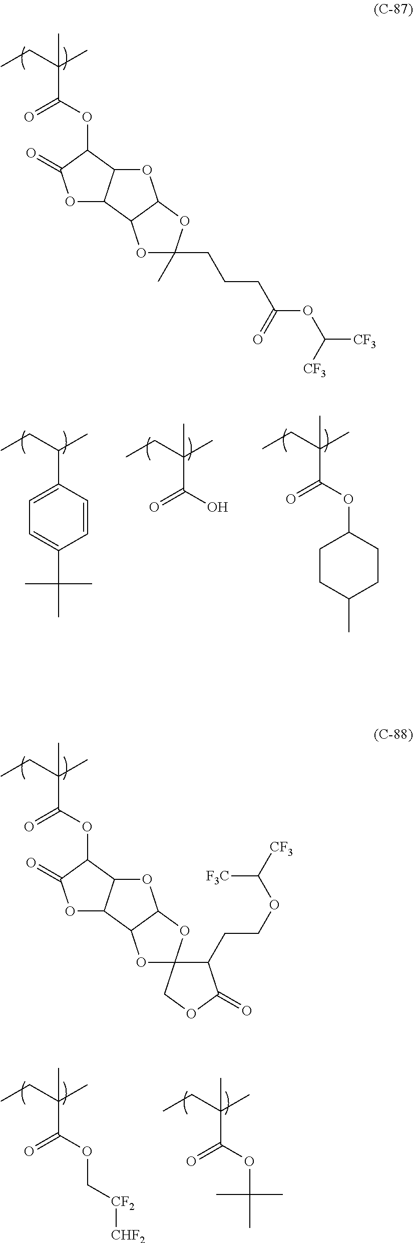

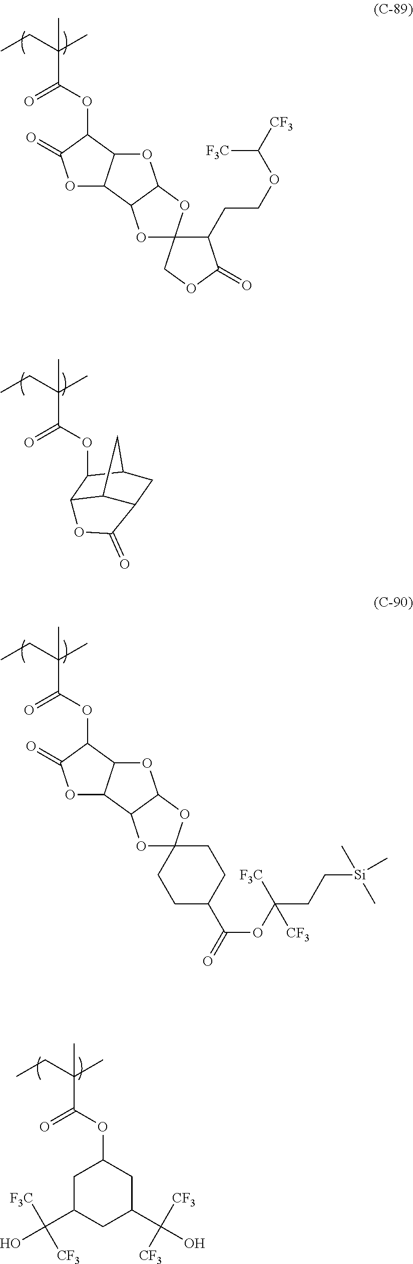

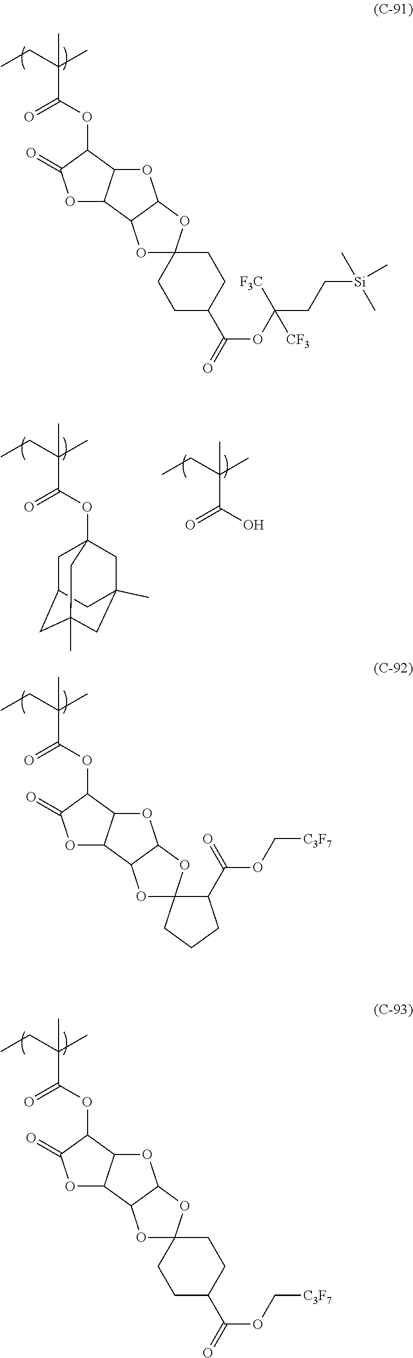

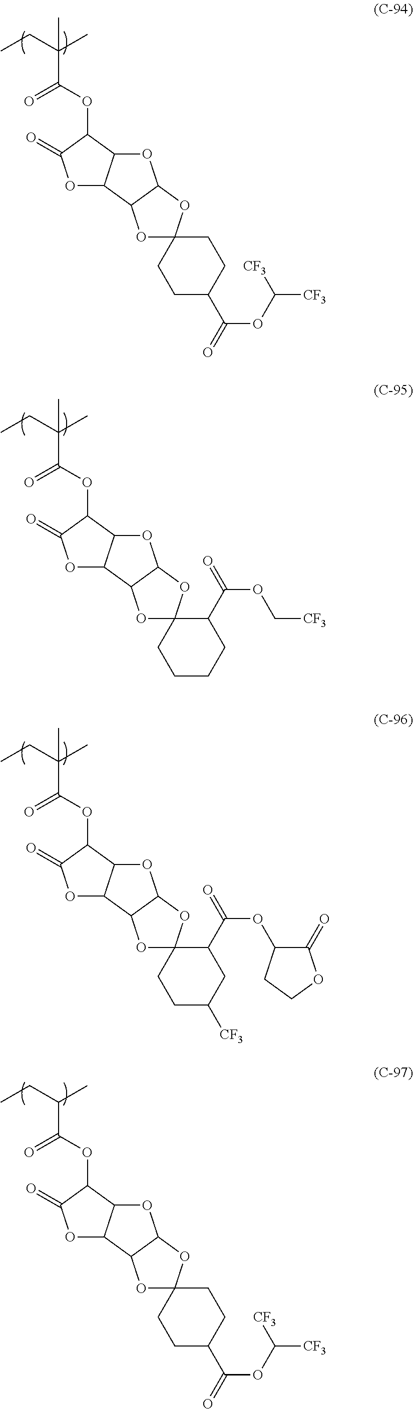

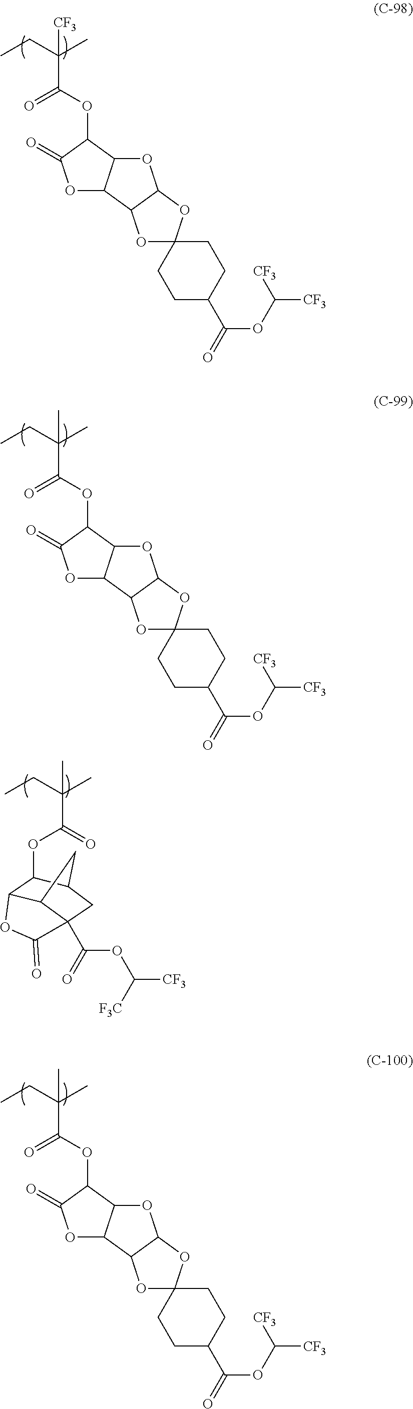

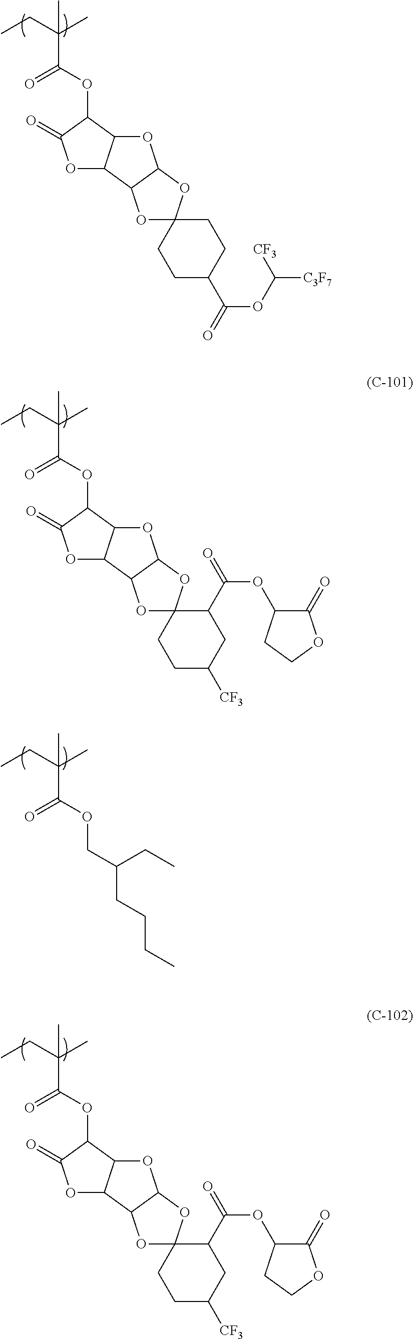

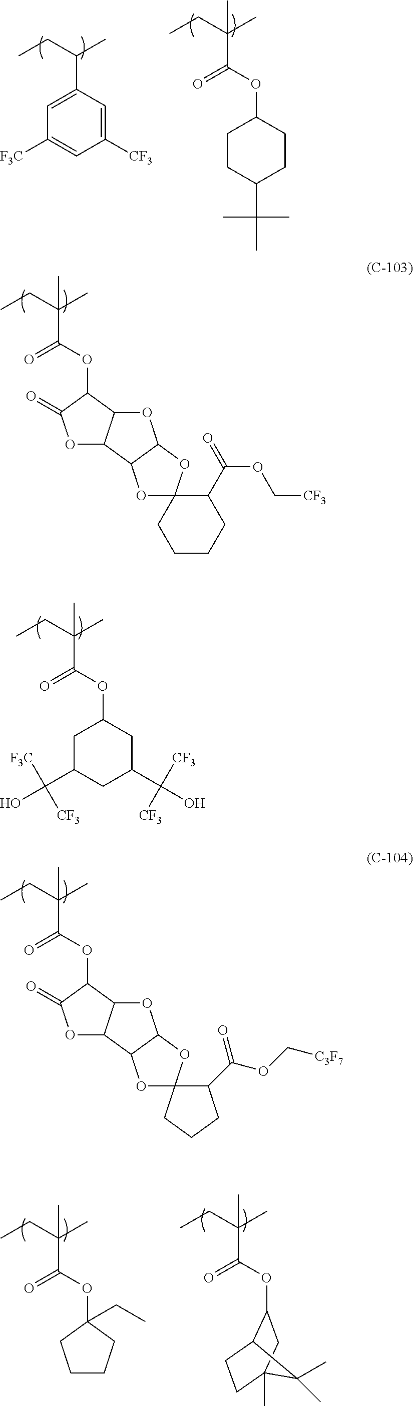

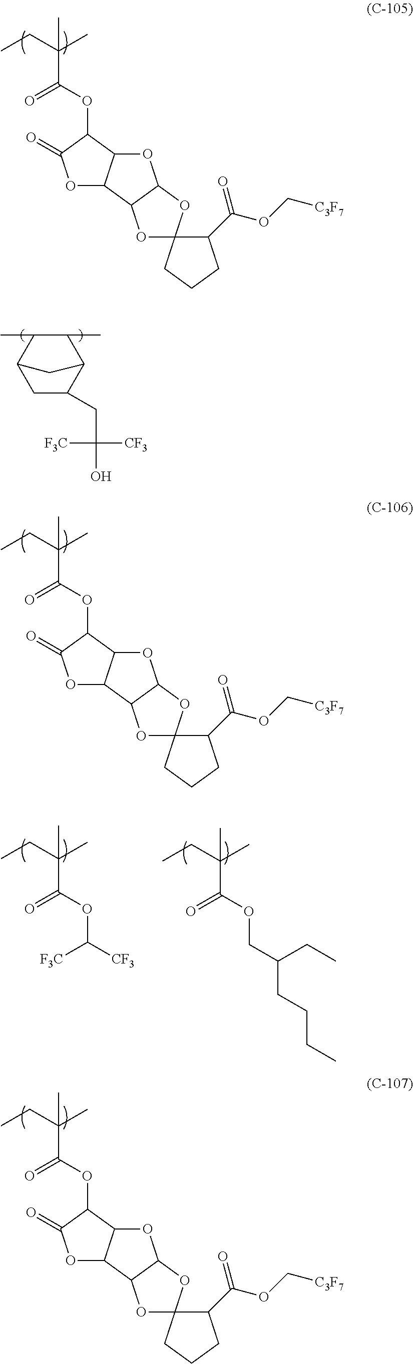

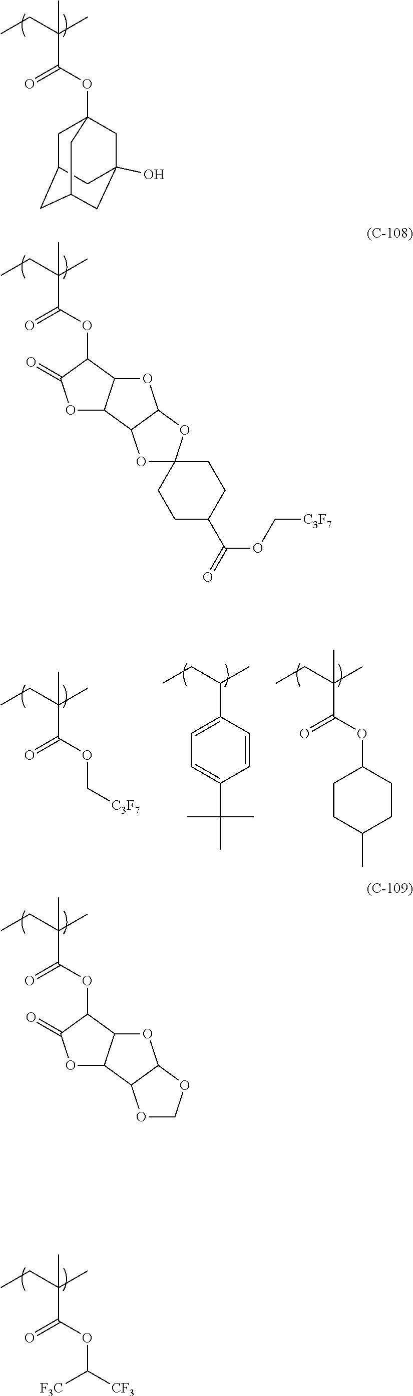

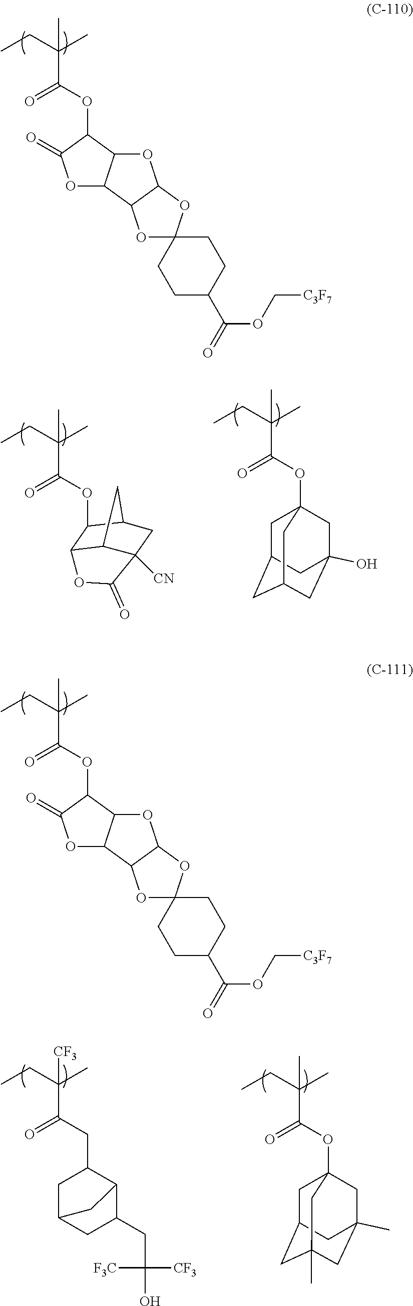

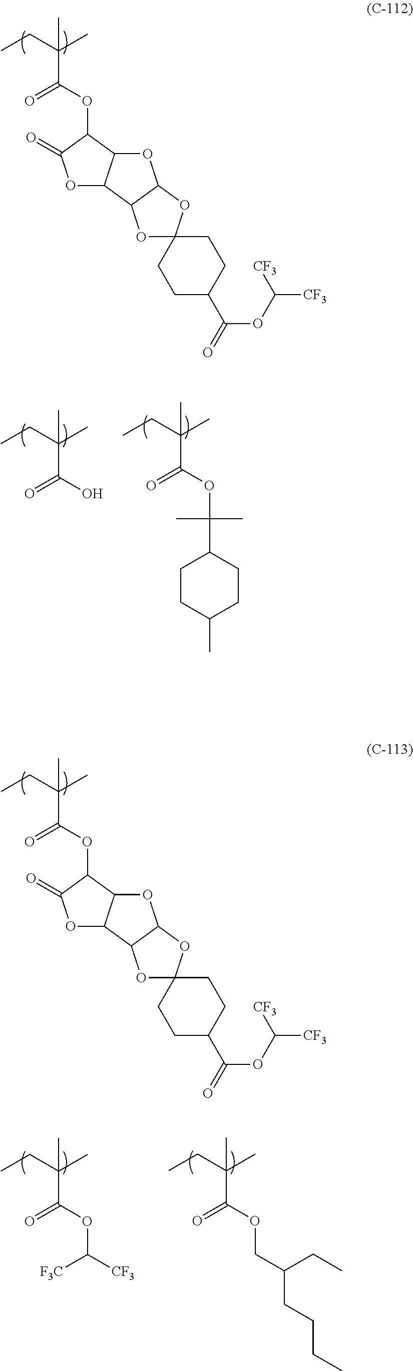

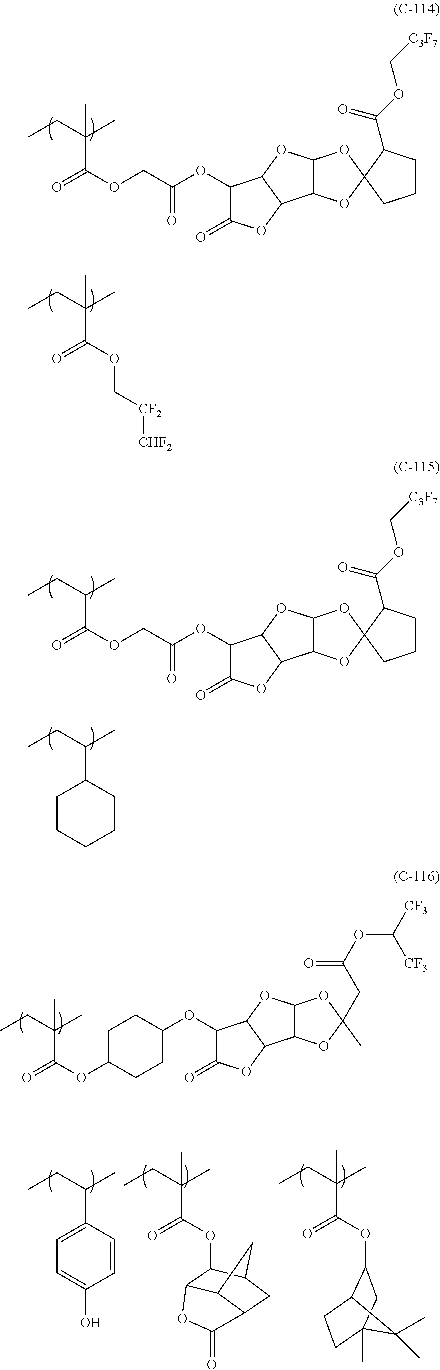

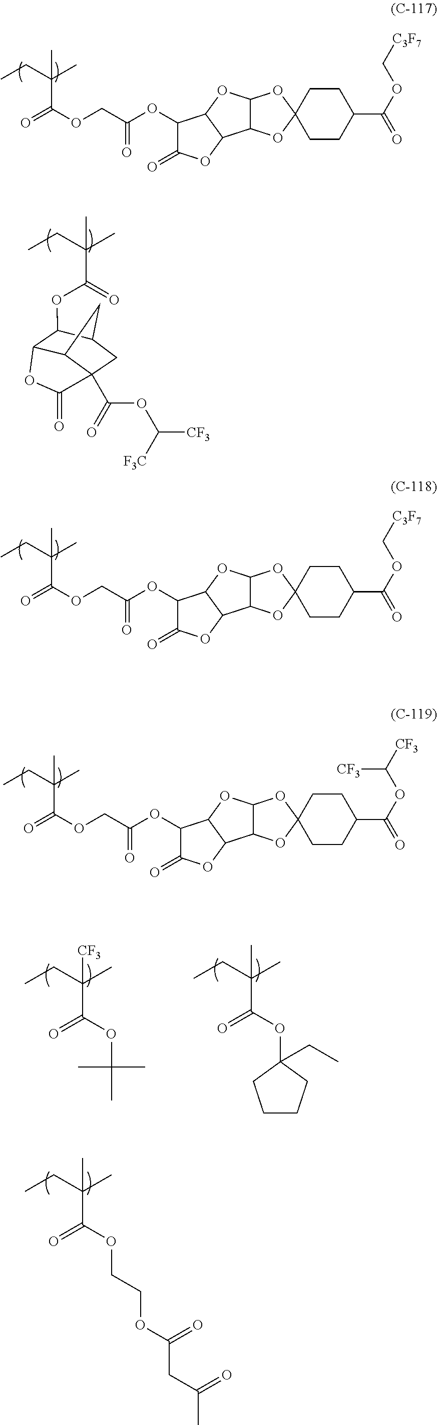

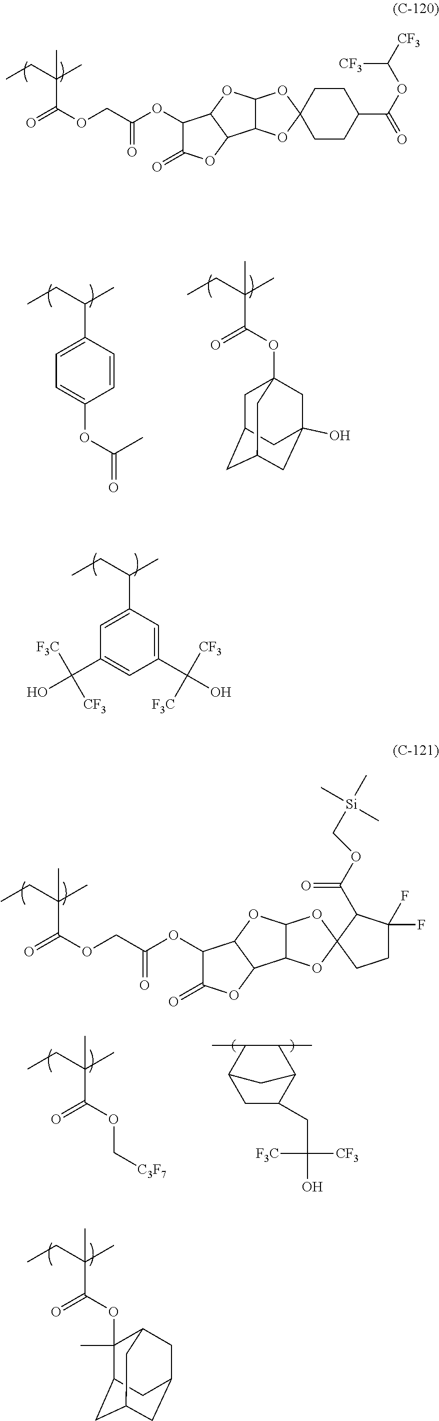

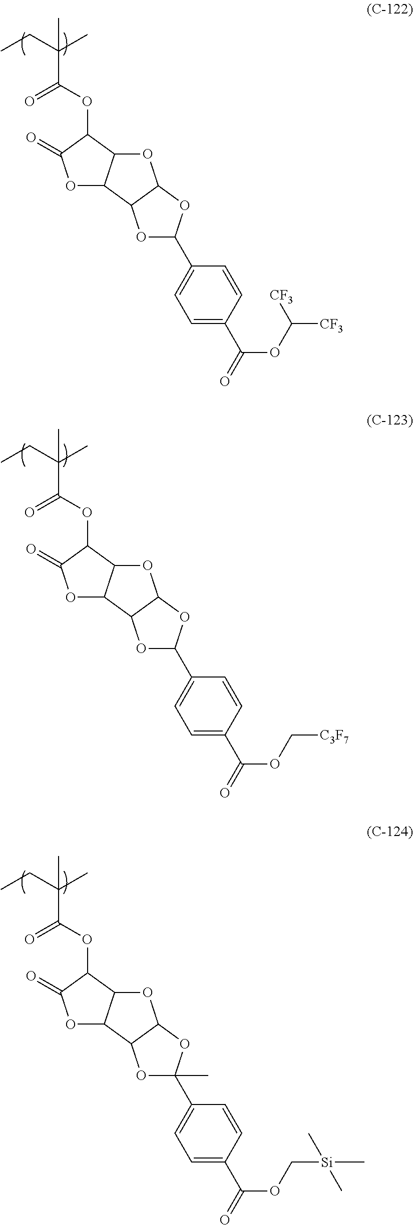

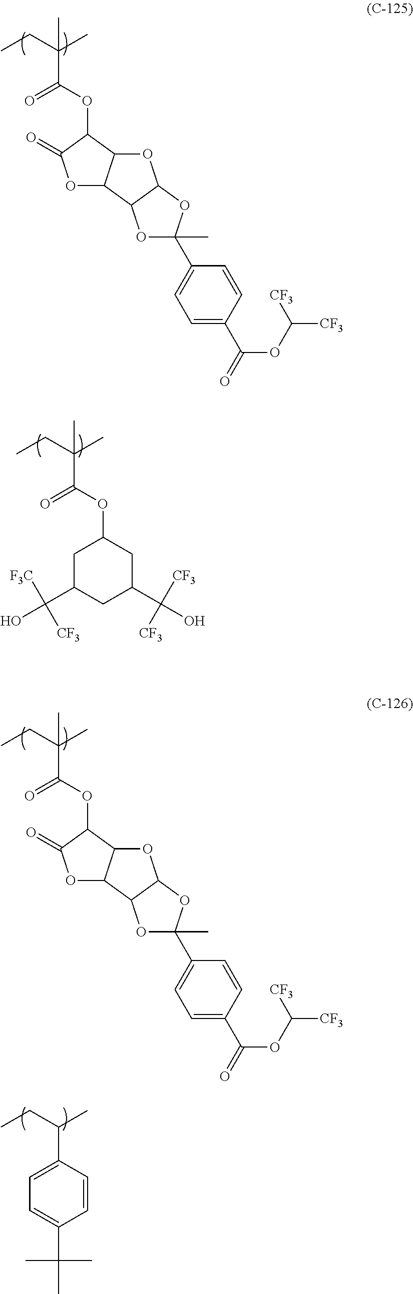

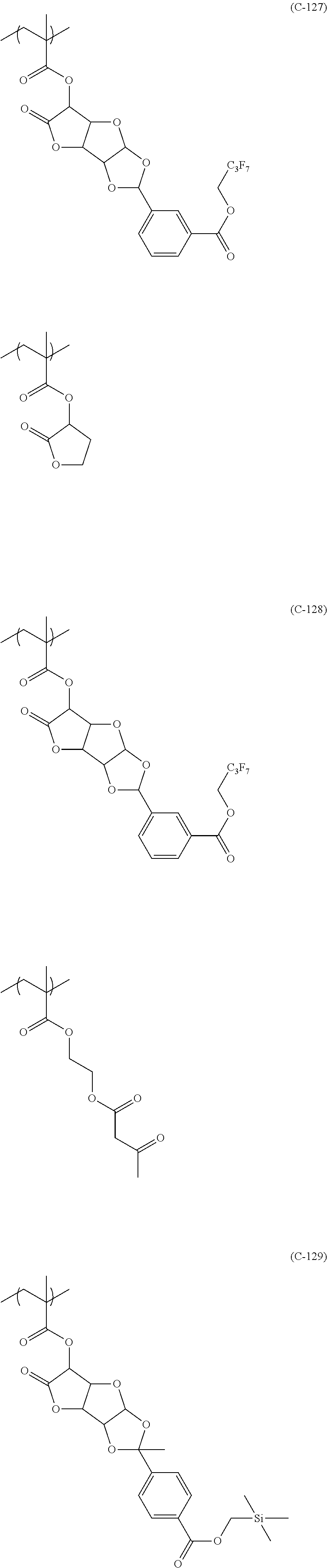

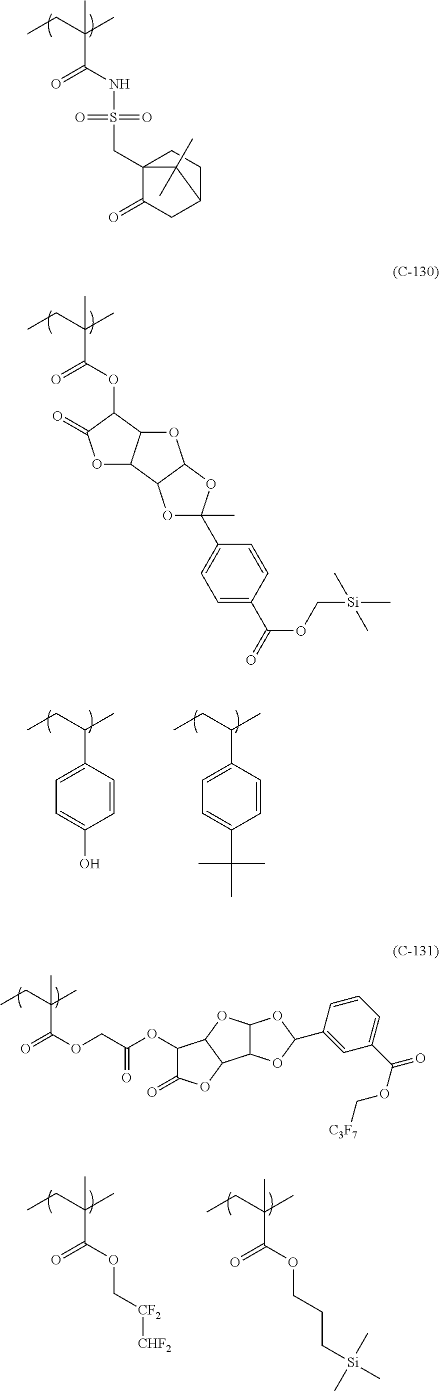

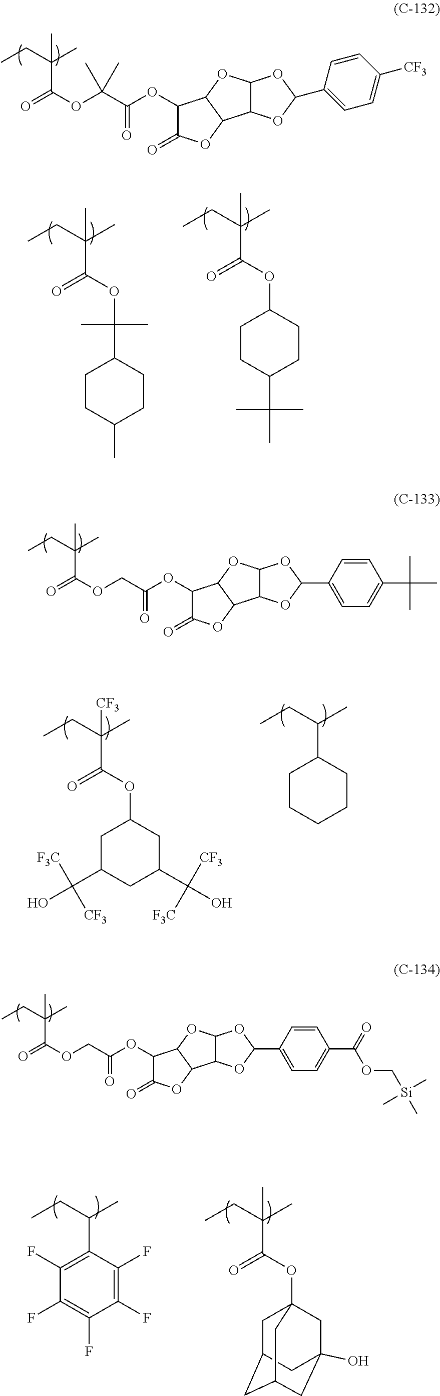

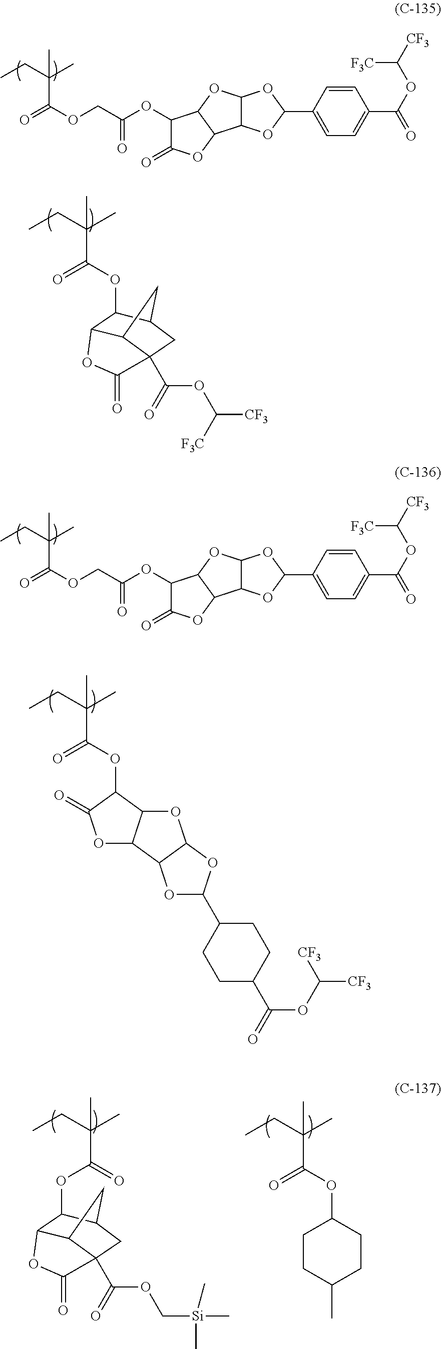

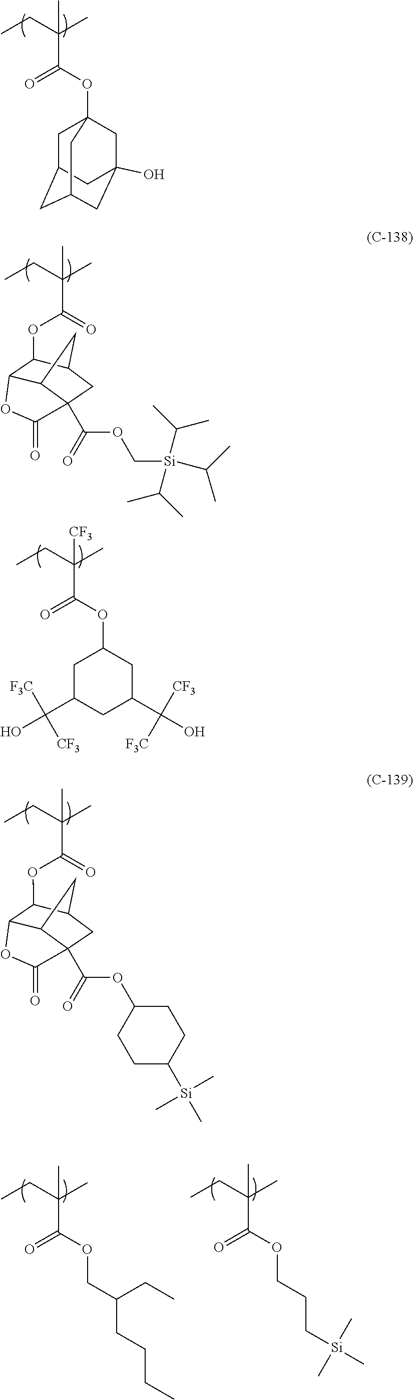

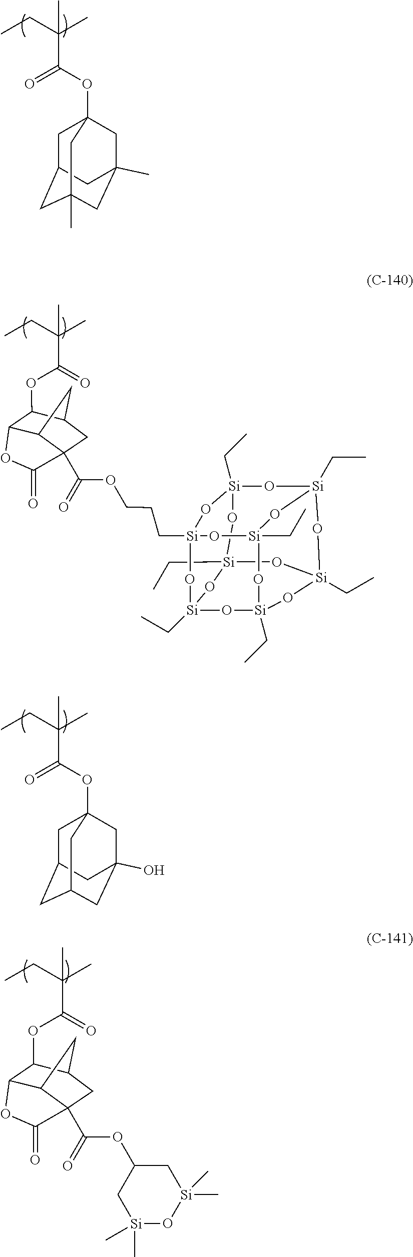

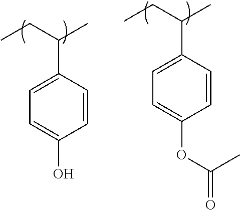

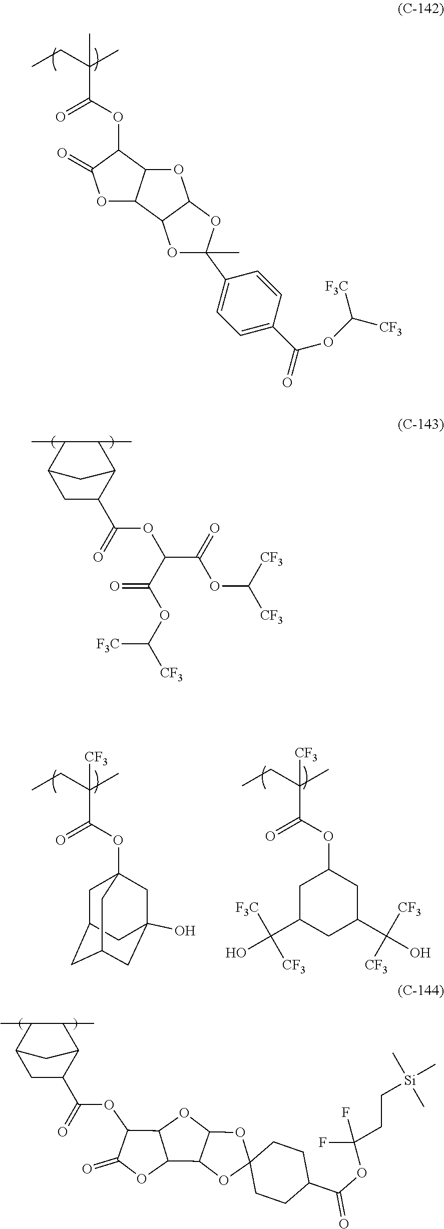

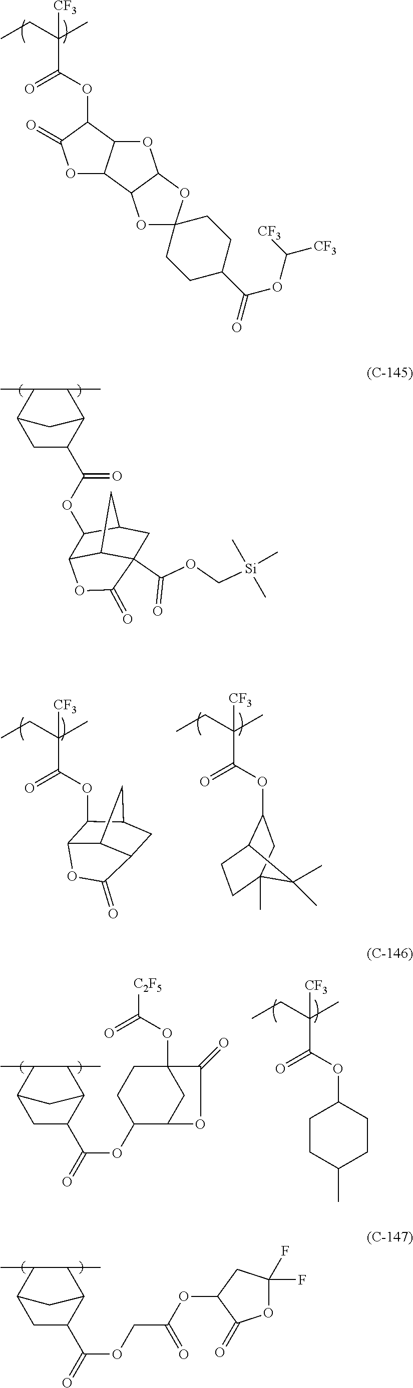

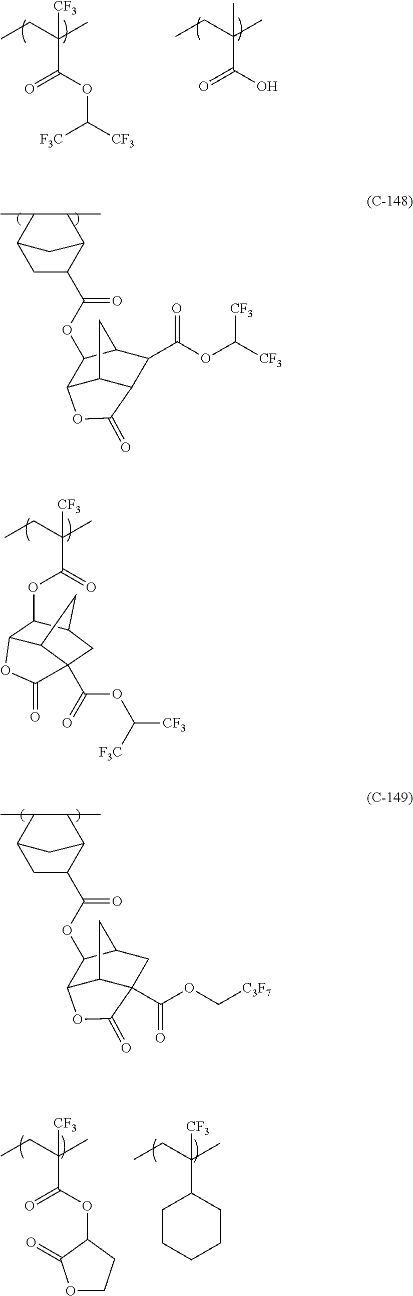

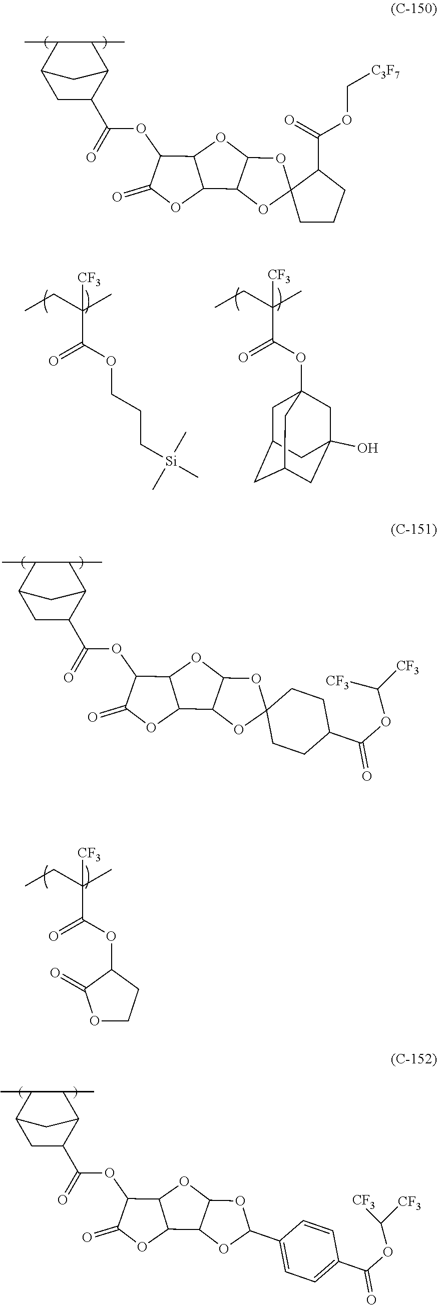

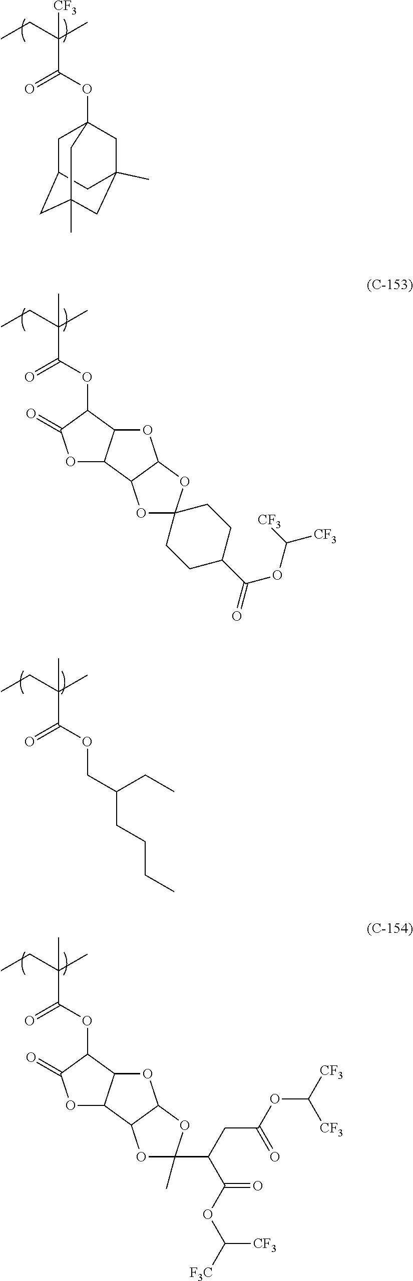

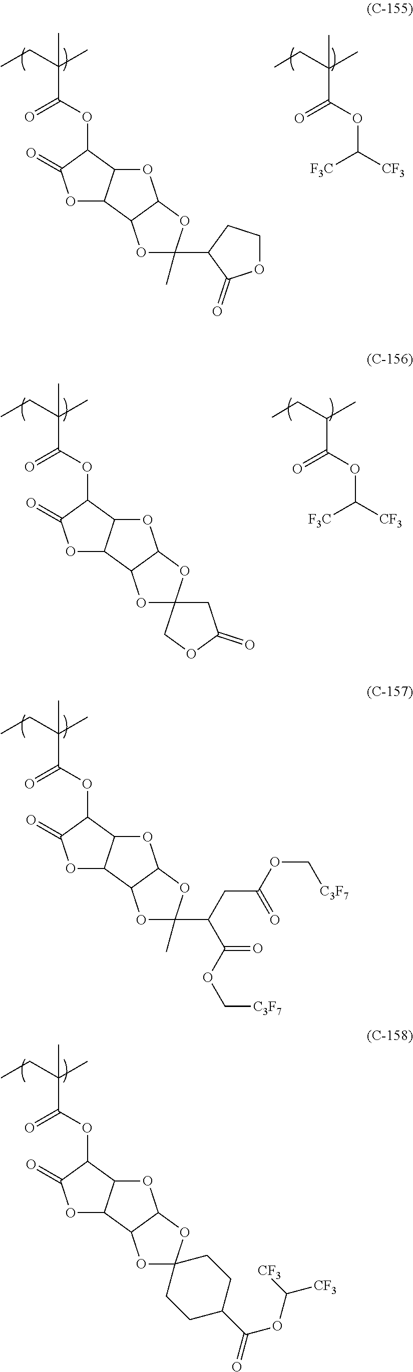

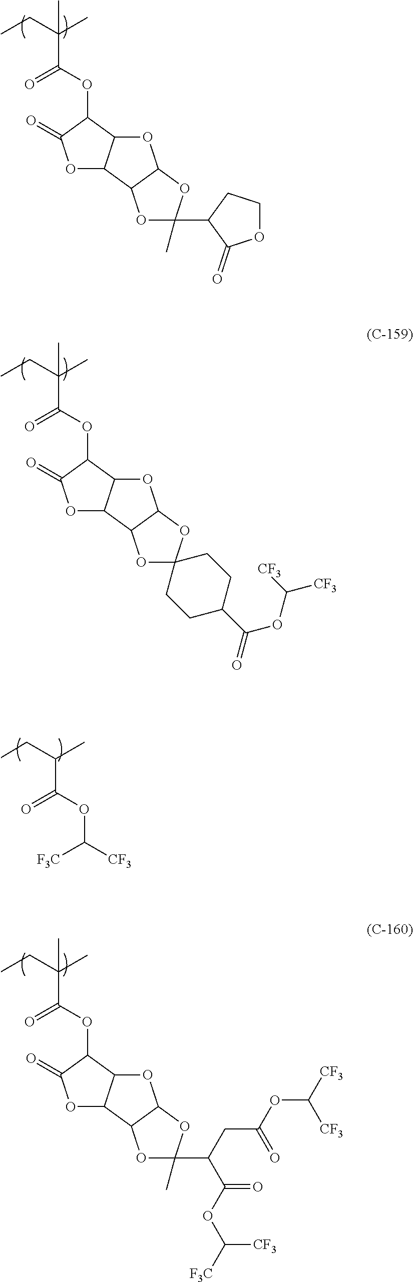

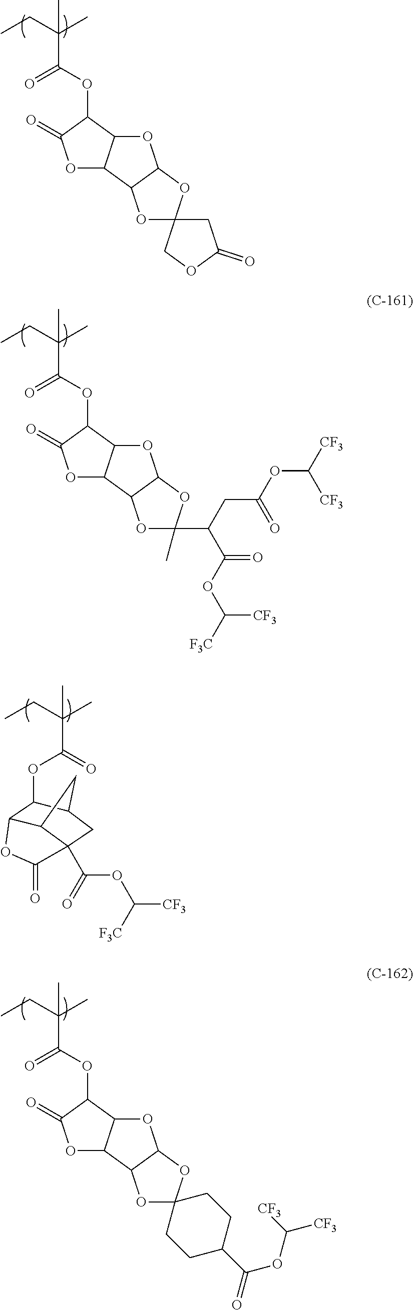

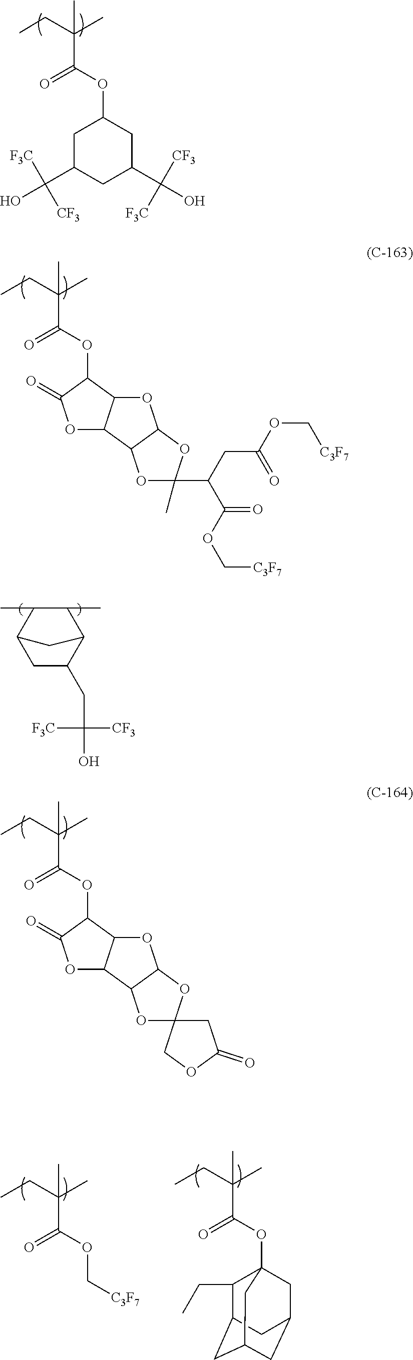

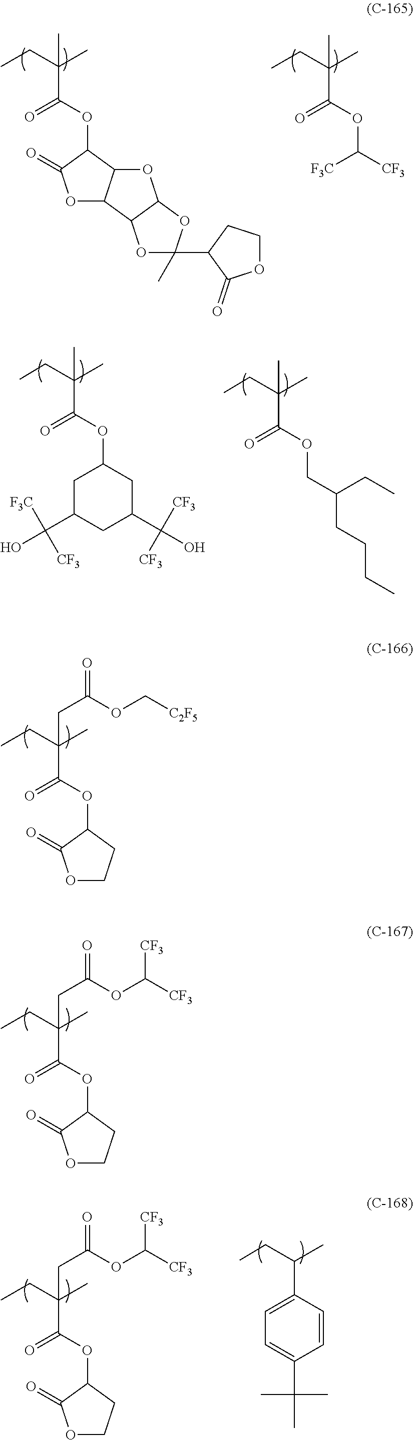

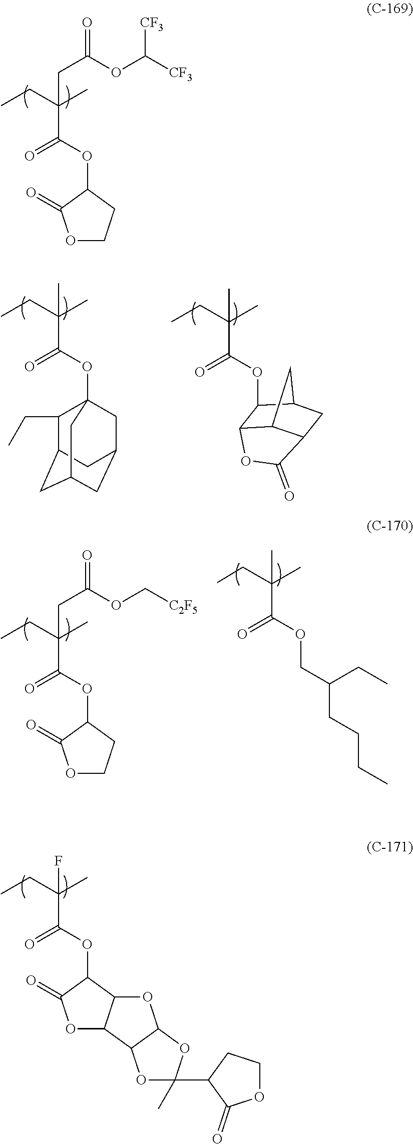

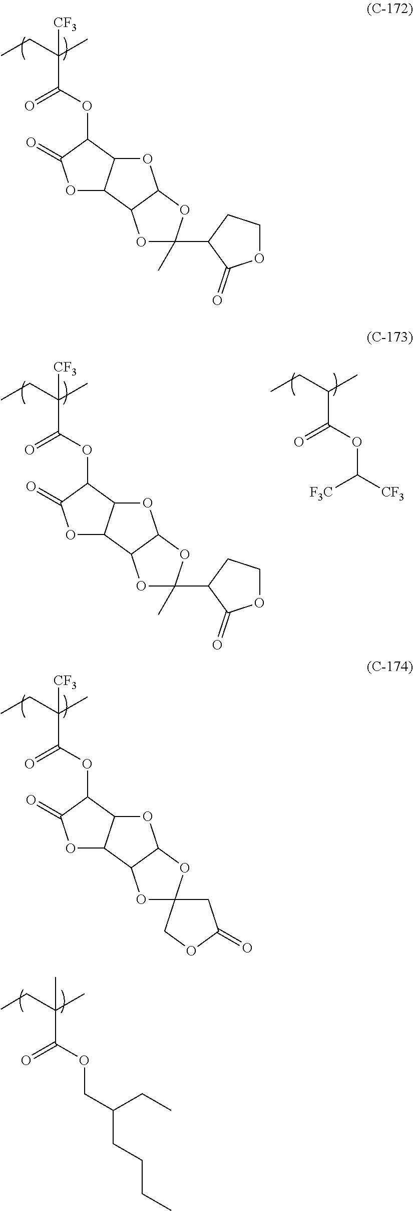

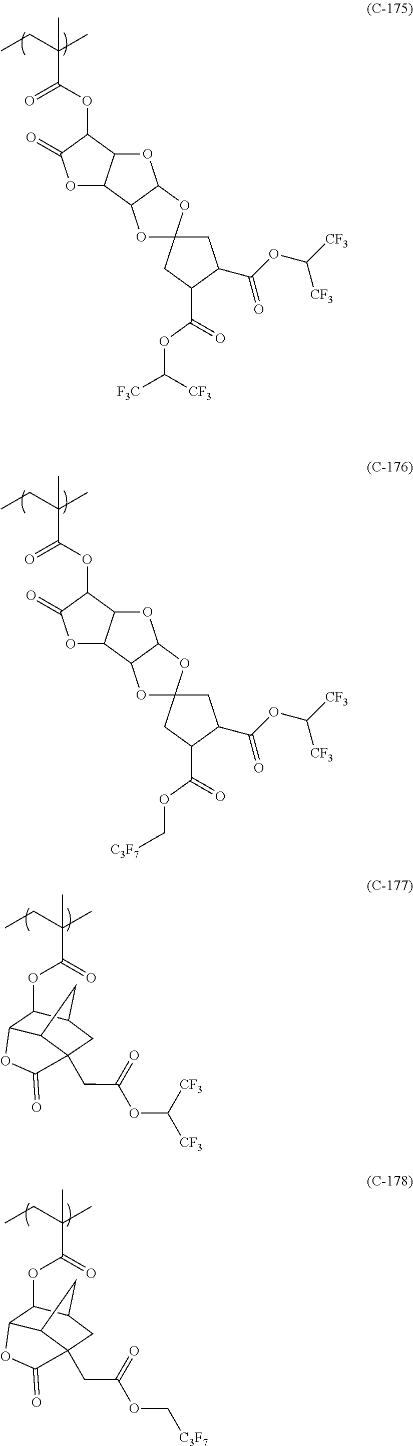

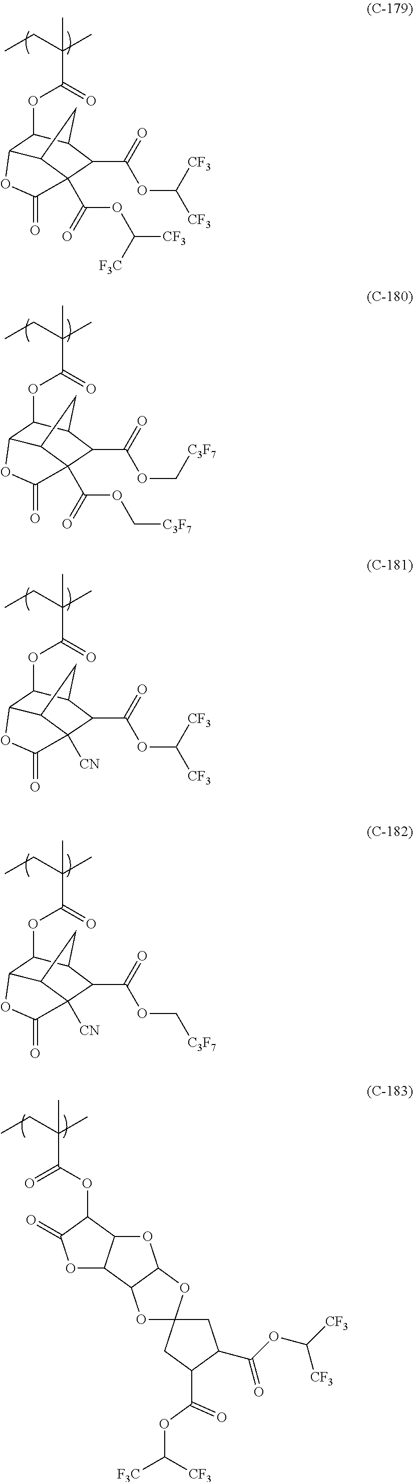

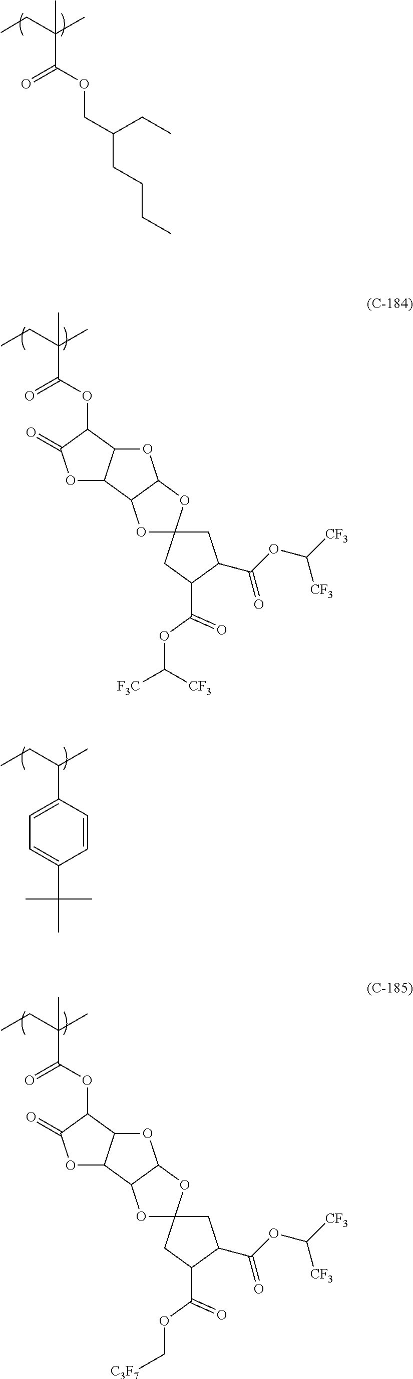

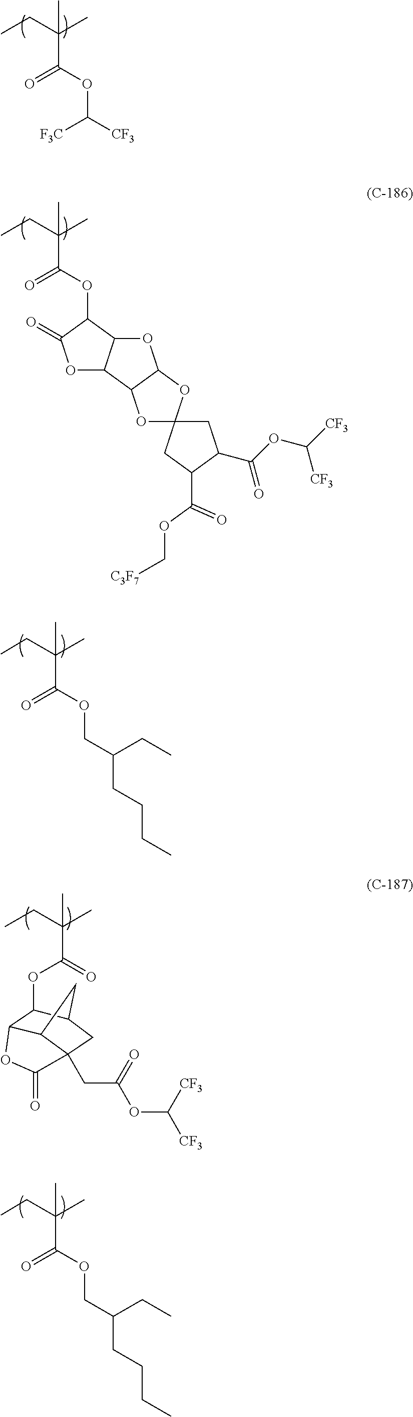

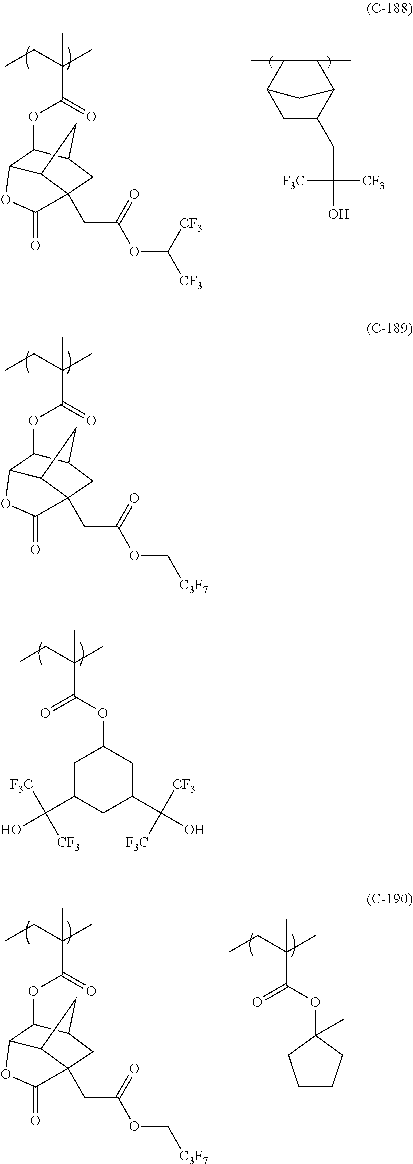

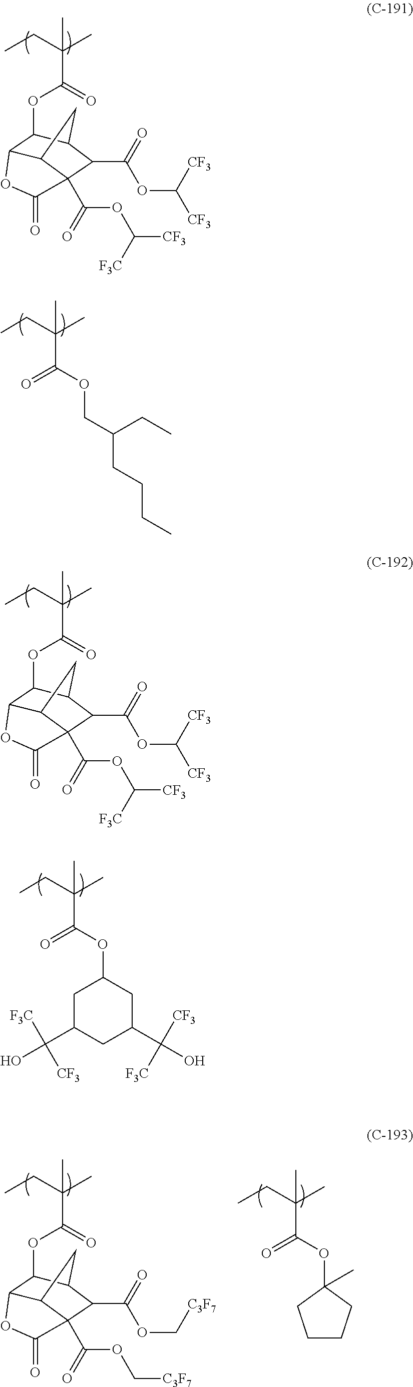

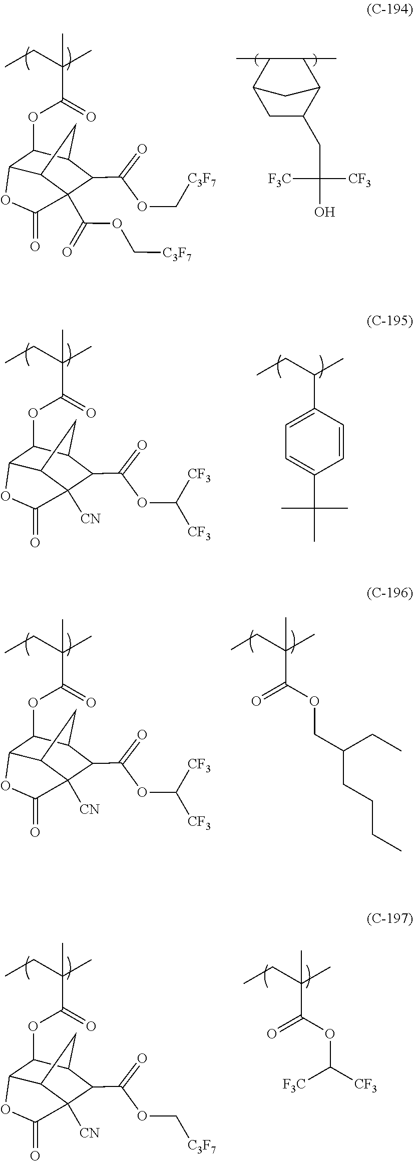

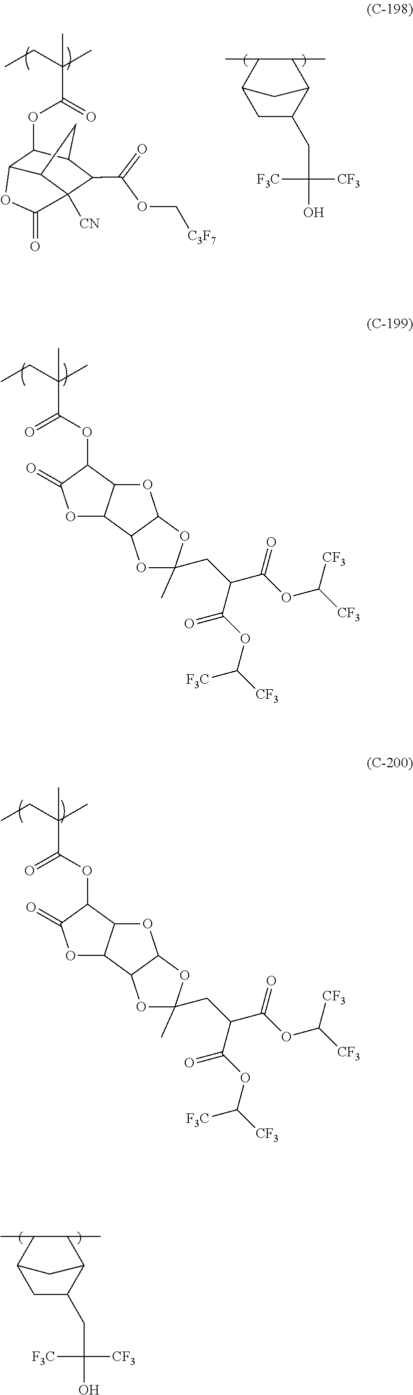

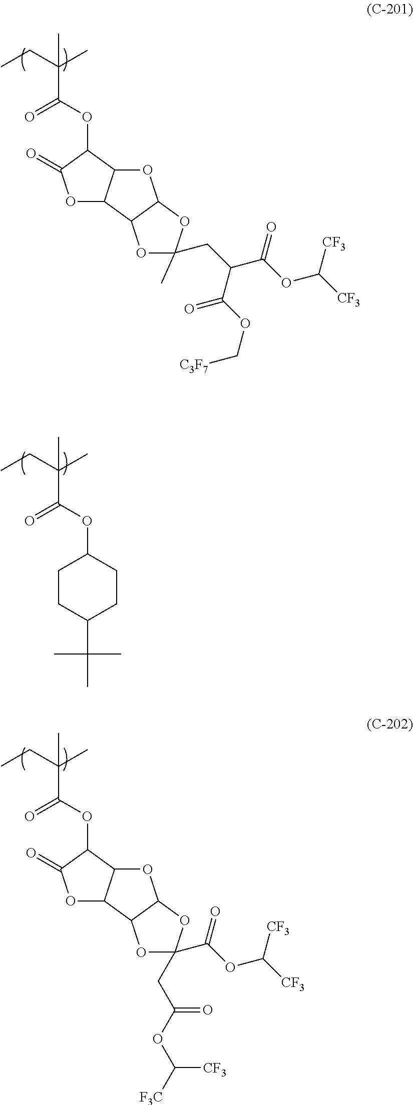

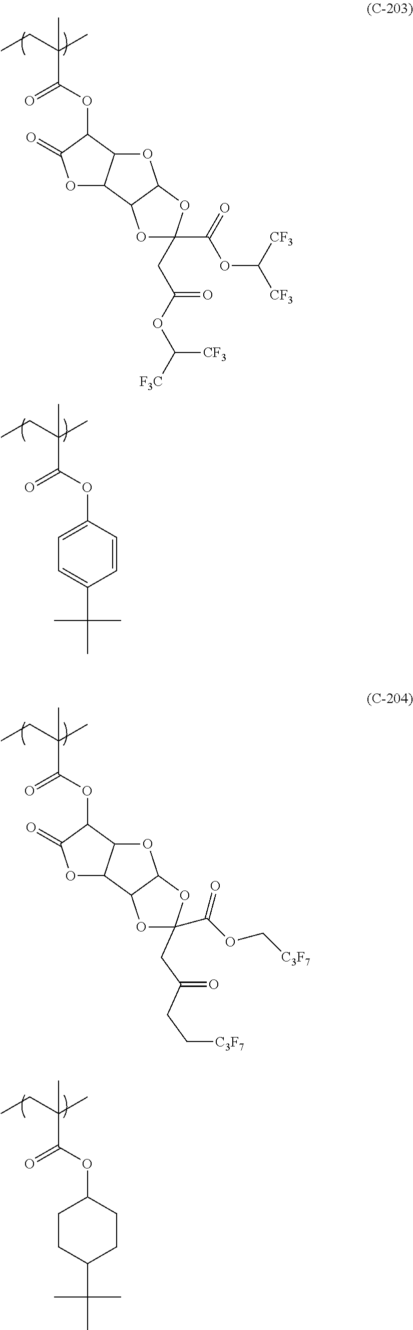

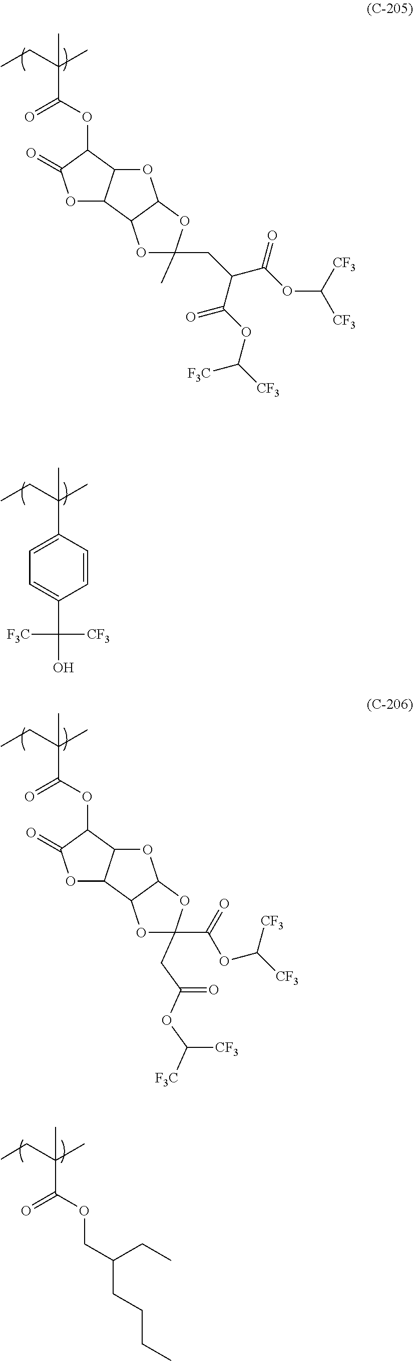

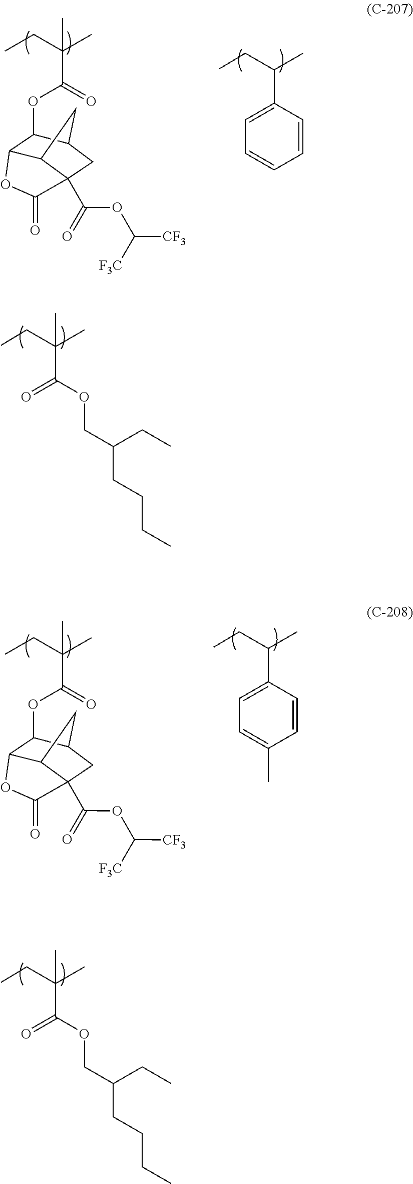

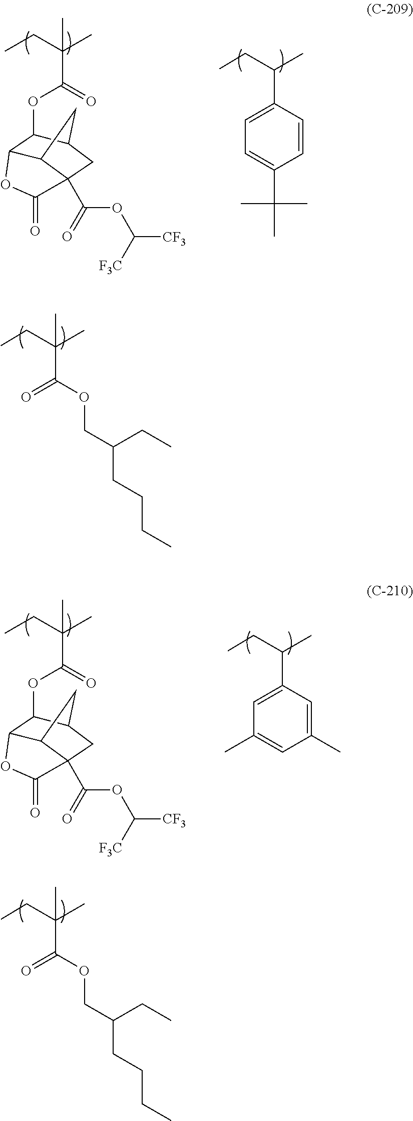

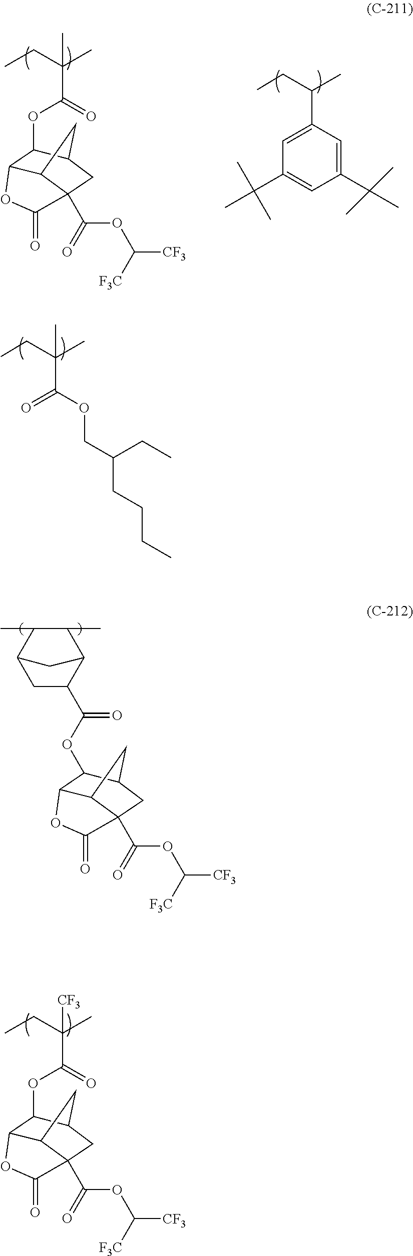

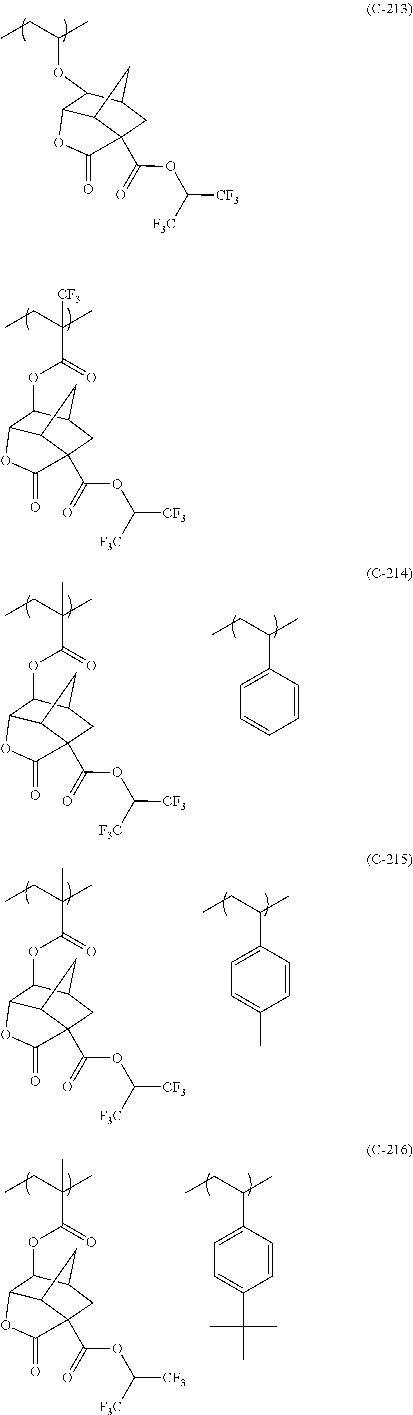

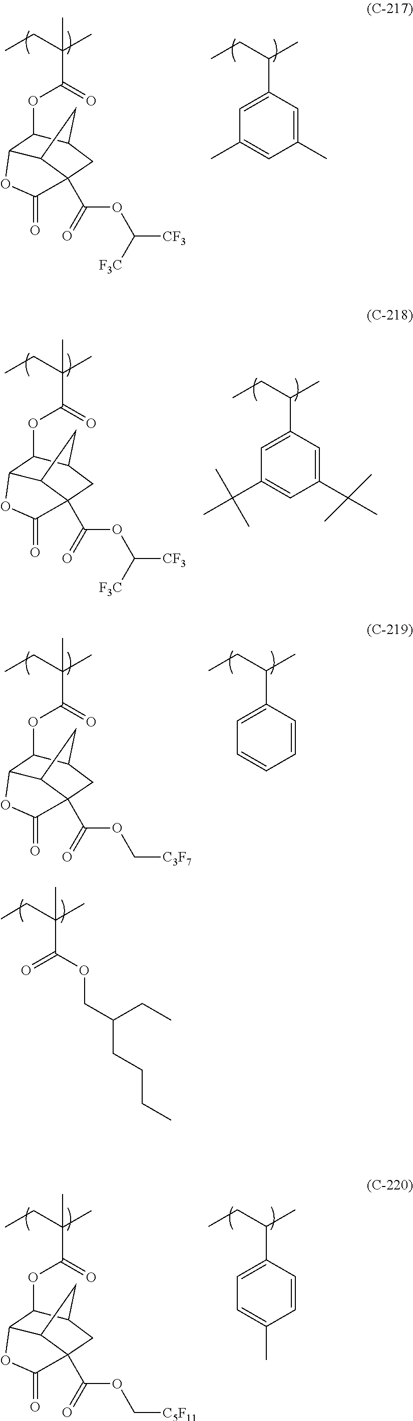

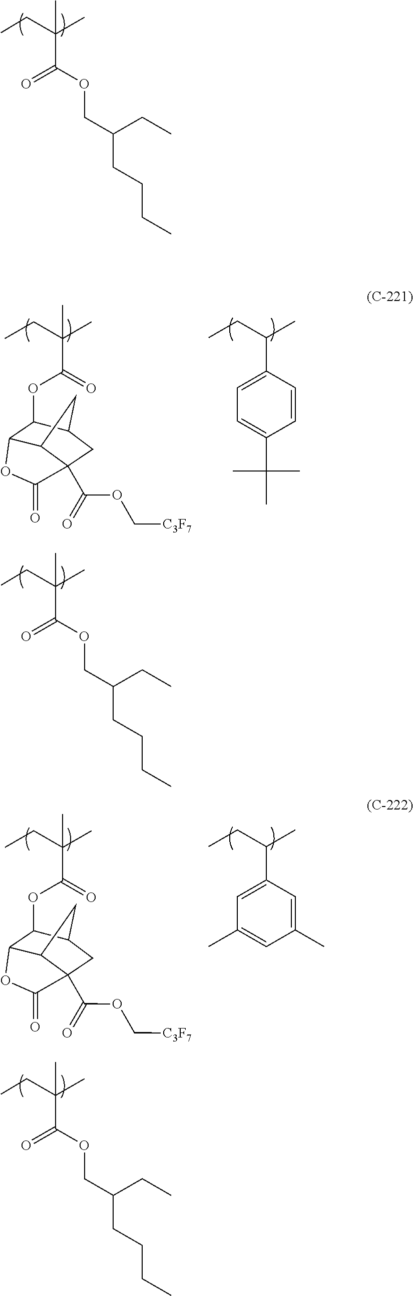

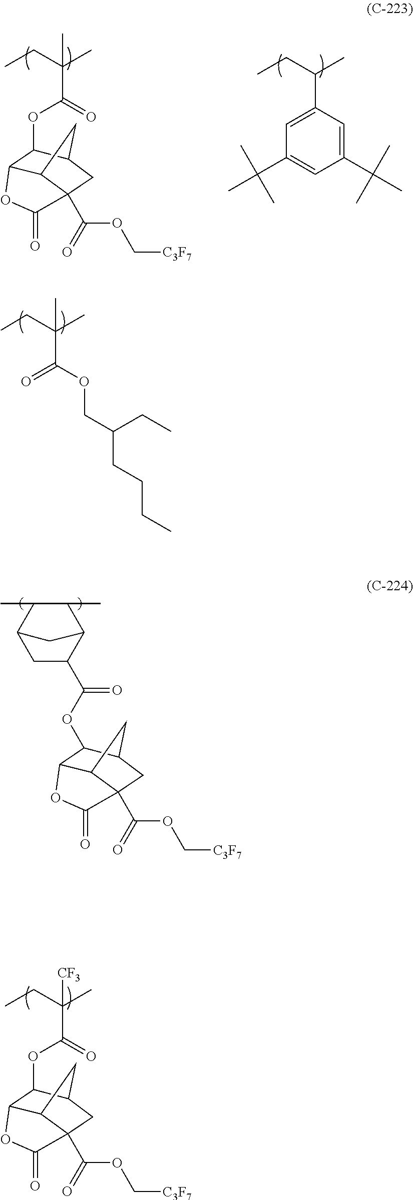

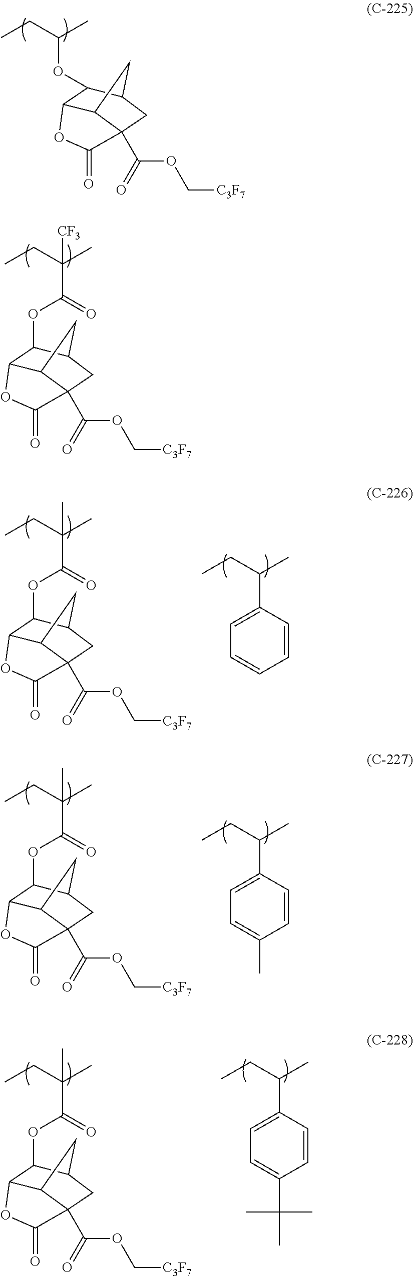

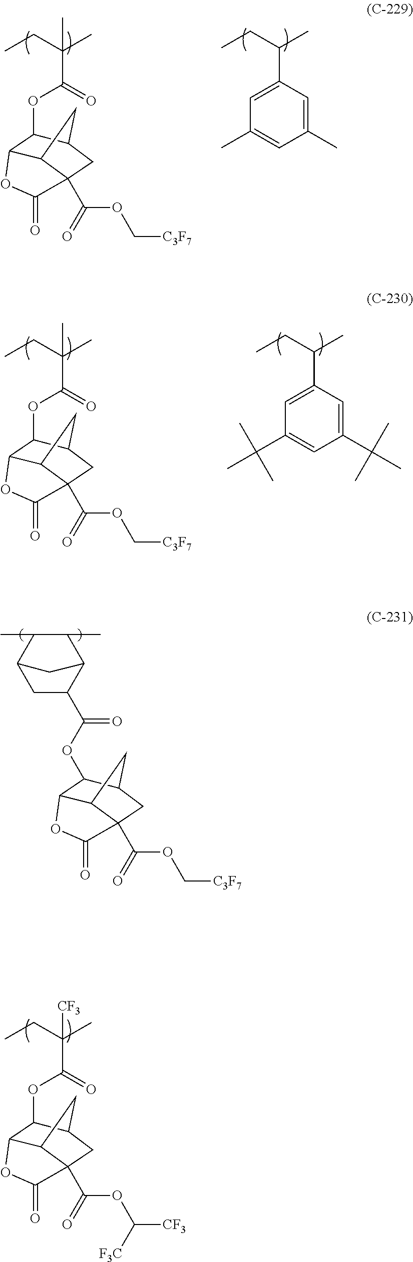

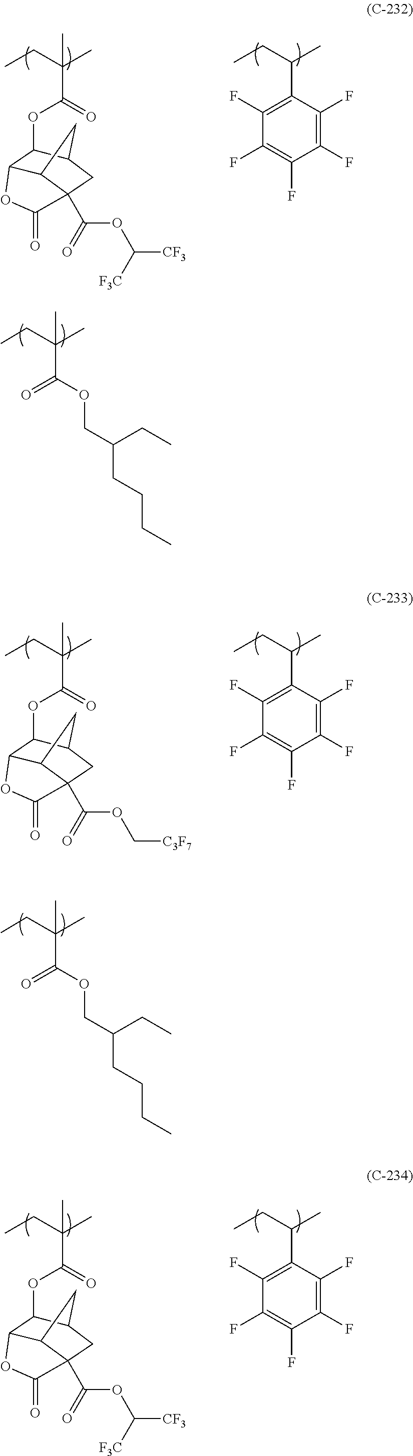

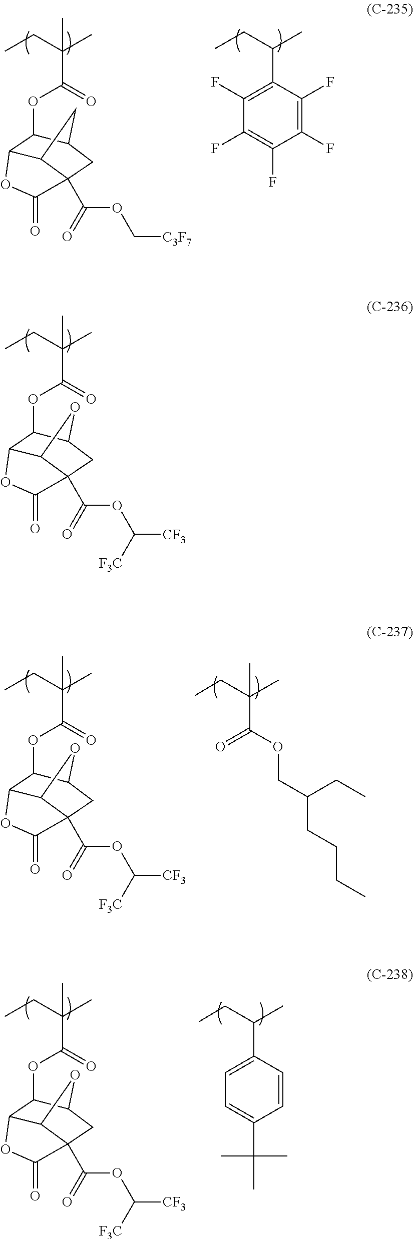

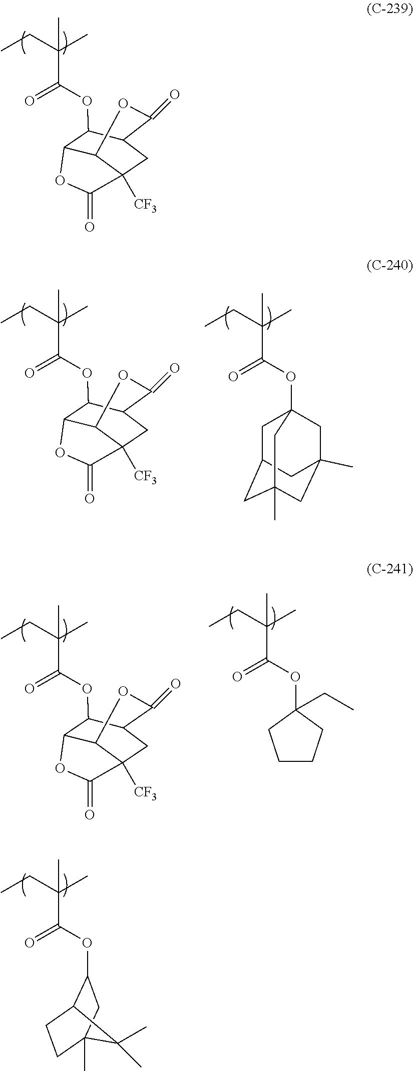

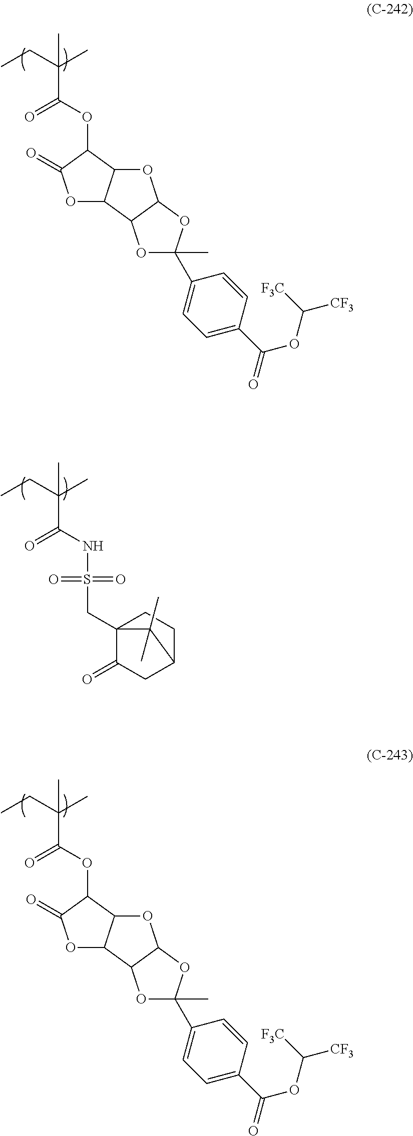

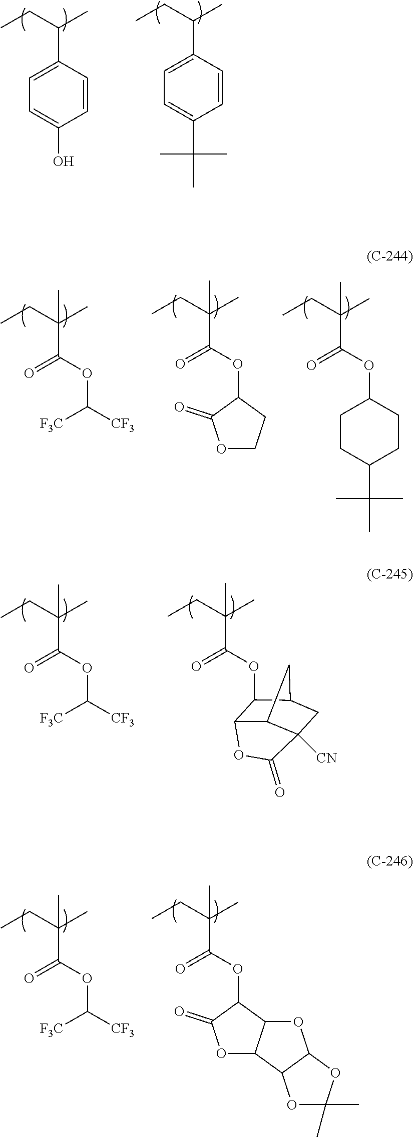

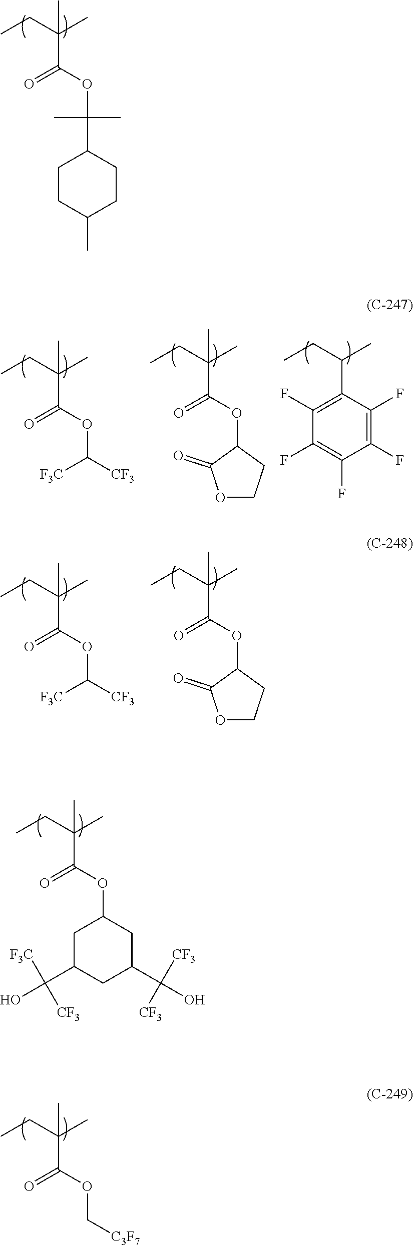

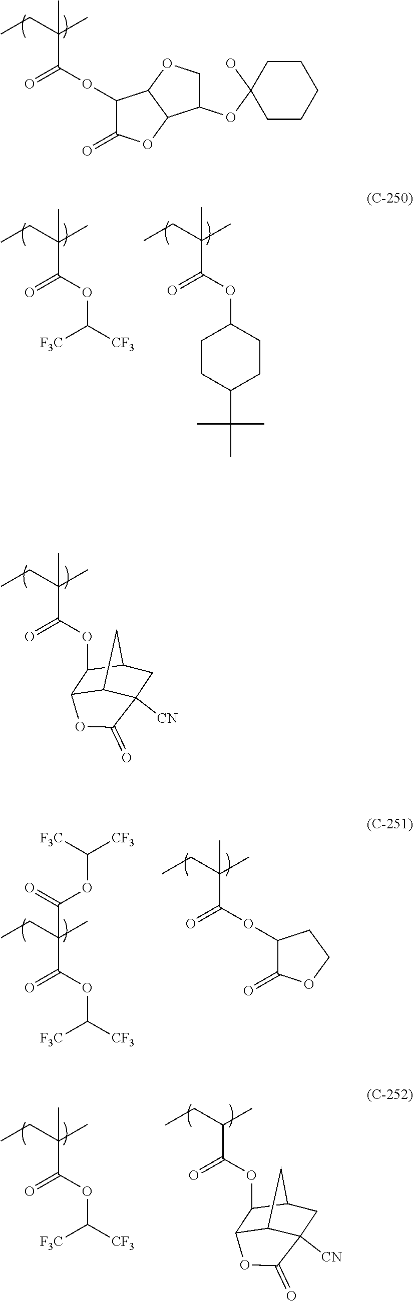

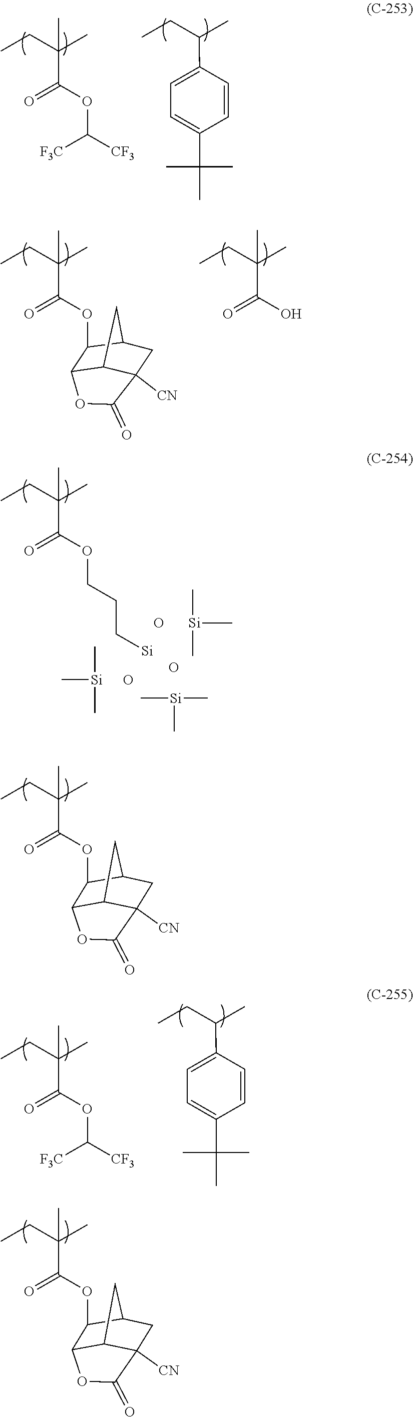

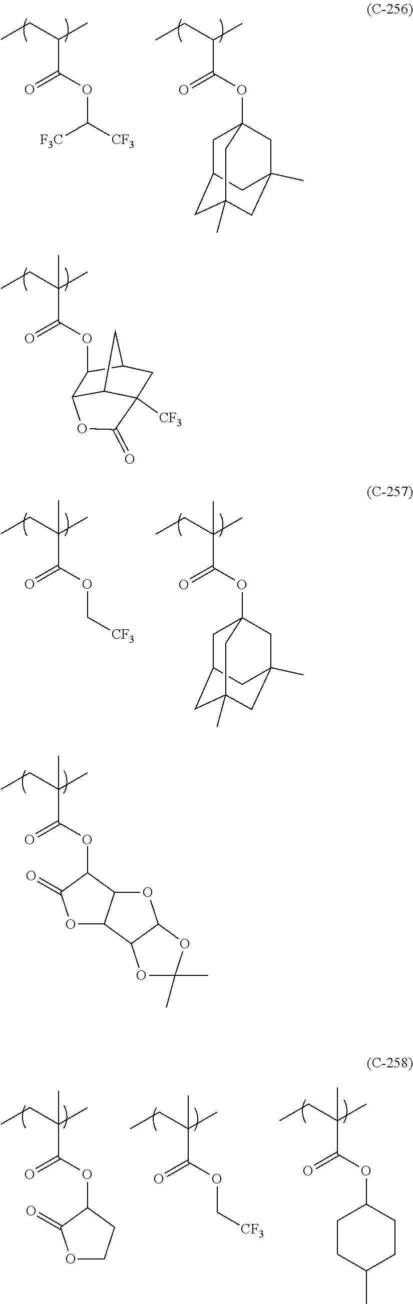

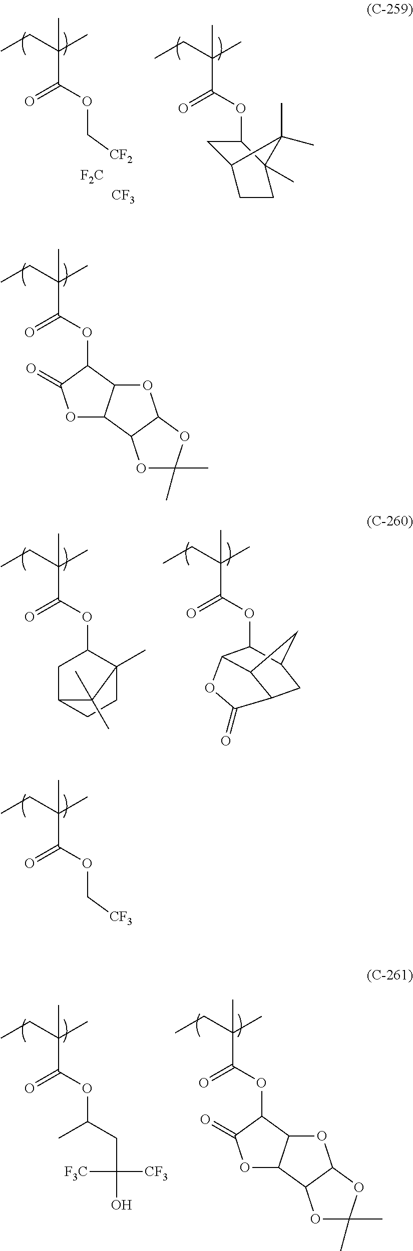

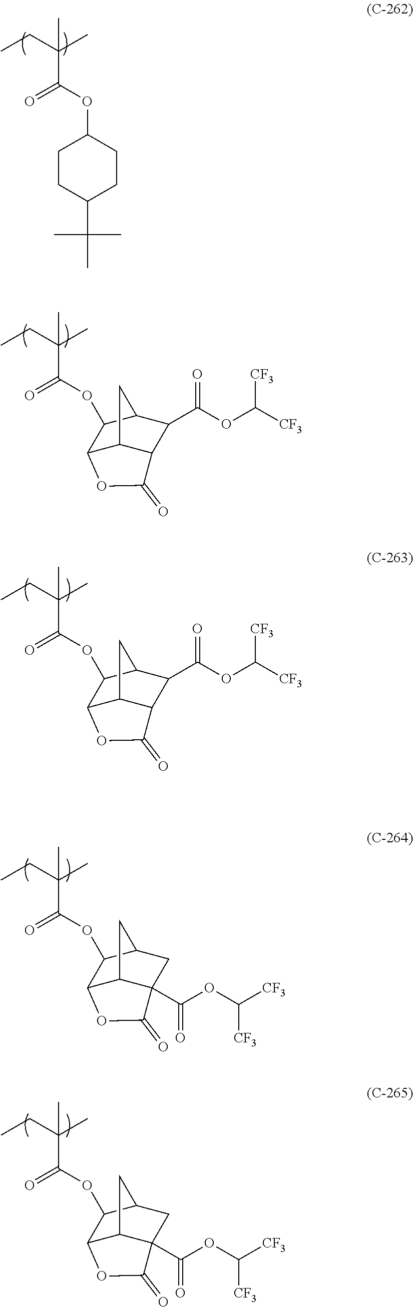

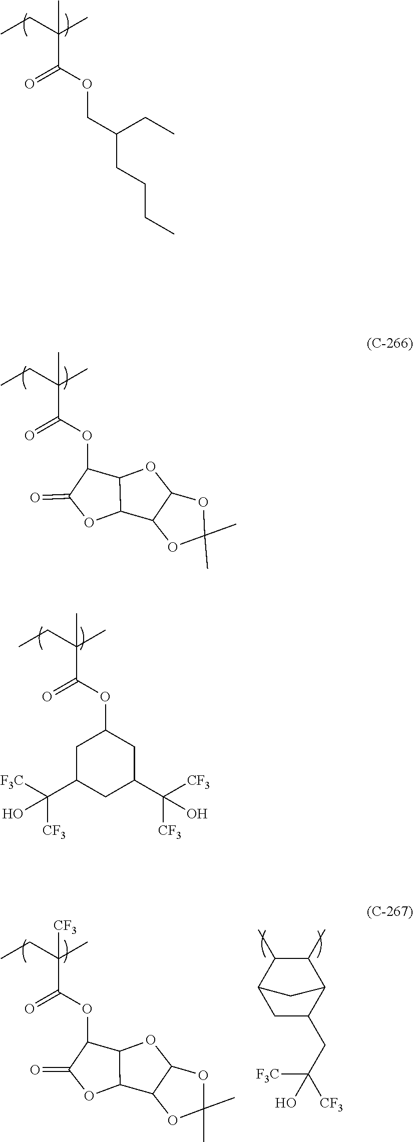

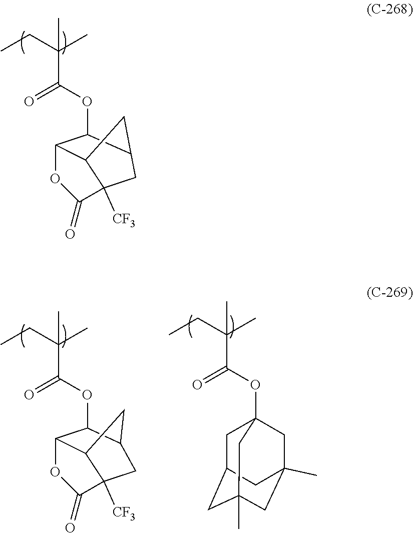

TABLE 1

| Resin | Composition | Mw | Mw/Mn |
|---|---|---|---|
| C-1 | 100 | 6000 | 1.5 |
| C-2 | 100 | 7500 | 1.4 |
| C-3 | 100 | 6000 | 1.4 |
| C-4 | 100 | 9000 | 1.5 |
| C-5 | 100 | 6000 | 1.4 |
| C-6 | 50/50 | 6500 | 1.4 |
| C-7 | 90/10 | 8000 | 1.4 |
| C-8 | 60/40 | 8000 | 1.3 |
| C-9 | 30/30/30/10 | 9500 | 1.4 |
| C-10 | 70/30 | 7000 | 1.4 |
| C-11 | 50/10/40 | 9000 | 1.6 |
| C-12 | 80/20 | 6000 | 1.4 |
| C-13 | 40/30/30 | 9500 | 1.4 |
| C-14 | 50/50 | 8000 | 1.4 |
| C-15 | 70/30 | 7000 | 1.4 |
| C-16 | 100 | 6000 | 1.4 |
| C-17 | 100 | 8000 | 1.4 |
| C-18 | 40/20/40 | 6000 | 1.4 |
| C-19 | 40/60 | 5000 | 1.5 |
| C-20 | 30/40/30 | 7000 | 1.4 |
| C-21 | 40/40/10/10 | 6000 | 1.4 |
| C-22 | 100 | 5500 | 1.4 |
| C-23 | 100 | 9500 | 1.5 |
| C-24 | 70/30 | 8500 | 1.4 |
| C-25 | 50/30/20 | 5000 | 1.4 |
| C-26 | 50/20/30 | 5500 | 1.4 |
| C-27 | 50/50 | 9000 | 1.5 |
| C-28 | 50/40/10 | 9000 | 1.4 |
| C-29 | 60/20/20 | 6500 | 1.4 |
| C-30 | 70/30 | 6500 | 1.4 |
| C-31 | 70/30 | 9000 | 1.5 |
| C-32 | 90/10 | 9000 | 1.5 |
| C-33 | 70/20/10 | 7000 | 1.4 |
| C-34 | 80/10/10 | 8500 | 1.5 |
| C-35 | 60/30/10 | 7500 | 1.4 |
| C-36 | 50/50 | 5000 | 1.5 |
| C-37 | 30/30/30/5/5 | 6000 | 1.5 |
| C-38 | 50/50 | 4500 | 1.4 |
| C-39 | 80/20 | 5000 | 1.4 |
| C-40 | 100 | 5000 | 1.4 |
| C-41 | 100 | 9000 | 1.5 |
| C-42 | 100 | 10000 | 1.5 |
| C-43 | 90/10 | 8500 | 1.4 |
| C-44 | 30/30/30/10 | 5500 | 1.4 |
| C-45 | 60/30/10 | 6500 | 1.4 |
| C-46 | 70/30 | 6500 | 1.4 |
| C-47 | 30/20/50 | 7000 | 1.4 |
| C-48 | 80/20 | 8000 | 1.5 |
| C-49 | 60/30/10 | 6000 | 1.4 |
| C-50 | 60/40 | 8000 | 1.5 |
| C-51 | 50/50 | 9500 | 1.4 |
| C-52 | 90/10 | 8000 | 1.5 |
| C-53 | 100 | 7000 | 1.5 |
| C-54 | 70/10/10/10 | 5500 | 1.4 |
| C-55 | 80/20 | 6500 | 1.4 |
| C-56 | 30/30/40 | 6000 | 1.4 |
| C-57 | 100 | 6000 | 1.4 |
| C-58 | 90/10 | 8000 | 1.4 |
| C-59 | 80/20 | 7000 | 1.5 |
| C-60 | 50/20/30 | 6000 | 1.4 |
| C-61 | 60/40 | 4500 | 1.5 |
| C-62 | 100 | 6500 | 1.4 |
| C-63 | 80/10/10 | 7000 | 1.5 |
| C-64 | 90/10 | 9000 | 1.5 |
| C-65 | 70/30 | 8000 | 1.4 |
| C-66 | 35/30/10/5/20 | 7000 | 1.4 |
| C-67 | 100 | 6500 | 1.4 |
| C-68 | 80/20 | 6500 | 1.4 |
| C-69 | 70/20/10 | 7000 | 1.4 |
| C-70 | 60/30/10 | 9000 | 1.5 |

TABLE 2

| Resin | Composition | Mw | Mw/Mn |
|---|---|---|---|
| C-71 | 60/20/20 | 8000 | 1.4 |
| C-72 | 100 | 9500 | 1.5 |
| C-73 | 40/60 | 8000 | 1.4 |
| C-74 | 60/10/30 | 7000 | 1.5 |
| C-75 | 100 | 5500 | 1.5 |
| C-76 | 90/10 | 6500 | 1.4 |
| C-77 | 90/10 | 7500 | 1.3 |
| C-78 | 50/10/20/20 | 6000 | 1.5 |
| C-79 | 70/30 | 5000 | 1.3 |
| C-80 | 70/10/20 | 8500 | 1.5 |
| C-81 | 80/20 | 5500 | 1.3 |
| C-82 | 100 | 8000 | 1.3 |
| C-83 | 85/5/10 | 6500 | 1.4 |
| C-84 | 80/20 | 8000 | 1.5 |
| C-85 | 60/30/10 | 10000 | 1.5 |
| C-86 | 100 | 8000 | 1.5 |
| C-87 | 55/30/5/10 | 8000 | 1.3 |
| C-88 | 40/30/30 | 6000 | 1.3 |
| C-89 | 70/30 | 6500 | 1.3 |
| C-90 | 90/10 | 8000 | 1.5 |
| C-91 | 70/20/10 | 6500 | 1.5 |
| C-92 | 100 | 7000 | 1.4 |
| C-93 | 100 | 6000 | 1.5 |
| C-94 | 100 | 13000 | 1.4 |
| C-95 | 100 | 4000 | 1.4 |
| C-96 | 100 | 6000 | 1.5 |
| C-97 | 100 | 10000 | 1.4 |
| C-98 | 100 | 7500 | 1.5 |
| C-99 | 50/50 | 6500 | 1.4 |
| C-100 | 50/50 | 8500 | 1.4 |
| C-101 | 80/20 | 7000 | 1.3 |
| C-102 | 50/20/30 | 4500 | 1.3 |
| C-103 | 90/10 | 5500 | 1.3 |
| C-104 | 60/30/10 | 6000 | 1.5 |
| C-105 | 80/20 | 8000 | 1.3 |
| C-106 | 50/45/5 | 7500 | 1.4 |
| C-107 | 80/20 | 7000 | 1.5 |
| C-108 | 30/30/30/10 | 9000 | 1.6 |
| C-109 | 70/30 | 8000 | 1.3 |
| C-110 | 50/30/20 | 9000 | 1.4 |
| C-111 | 60/10/30 | 6000 | 1.5 |
| C-112 | 60/5/35 | 8000 | 1.5 |
| C-113 | 50/40/10 | 9500 | 1.5 |
| C-114 | 80/20 | 7000 | 1.5 |
| C-115 | 90/10 | 6000 | 1.2 |
| C-116 | 40/20/30/10 | 8000 | 1.3 |
| C-117 | 50/50 | 6000 | 1.5 |
| C-118 | 100 | 9500 | 1.4 |
| C-119 | 50/20/20/10 | 8000 | 1.5 |
| C-120 | 75/10/10/5 | 7000 | 1.3 |
| C-121 | 30/30/10/30 | 5500 | 1.3 |
| C-122 | 100 | 8000 | 1.3 |
| C-123 | 100 | 9500 | 1.5 |
| C-124 | 100 | 9000 | 1.6 |
| C-125 | 90/10 | 9500 | 1.3 |
| C-126 | 70/30 | 7500 | 1.5 |
| C-127 | 70/30 | 8000 | 1.3 |
| C-128 | 85/15 | 6000 | 1.5 |
| C-129 | 90/10 | 7000 | 1.6 |
| C-130 | 50/20/30 | 5000 | 1.3 |
| C-131 | 60/20/20 | 4000 | 1.4 |
| C-132 | 50/30/20 | 6500 | 1.4 |
| C-133 | 70/10/20 | 7000 | 1.4 |
| C-134 | 80/10/10 | 9000 | 1.4 |
| C-135 | 60/40 | 8000 | 1.5 |
| C-136 | 30/70 | 9000 | 1.4 |
| C-137 | 70/15/15 | 7500 | 1.5 |
| C-138 | 70/30 | 8000 | 1.4 |
| C-139 | 75/5/10/10 | 6000 | 1.5 |
| C-140 | 70/30 | 5500 | 1.5 |

TABLE 3

| Resin | Composition | Mw | Mw/Mn |
|---|---|---|---|
| C-141 | 50/25/25 | 6500 | 1.4 |
| C-142 | 100 | 9000 | 1.6 |
| C-143 | 50/40/10 | 7000 | 1.4 |
| C-144 | 50/50 | 9000 | 1.4 |
| C-145 | 50/30/20 | 8000 | 1.4 |
| C-146 | 50/50 | 9000 | 1.5 |
| C-147 | 48/50/2 | 6000 | 1.4 |
| C-148 | 50/50 | 9000 | 1.5 |
| C-149 | 50/25/25 | 6000 | 1.4 |
| C-150 | 50/50 | 9500 | 1.5 |
| C-151 | 50/50 | 8000 | 1.5 |
| C-152 | 50/50 | 7000 | 1.4 |
| C-153 | 95/5 | 3000 | 1.4 |
| C-154 | 100 | 5000 | 1.4 |
| C-155 | 50/50 | 6000 | 1.5 |
| C-156 | 50/50 | 4000 | 1.5 |
| C-157 | 100 | 8000 | 1.4 |
| C-158 | 80/20 | 4500 | 1.4 |
| C-159 | 80/20 | 3500 | 1.4 |
| C-160 | 70/30 | 7000 | 1.4 |
| C-161 | 50/50 | 10000 | 1.3 |
| C-162 | 95/5 | 4500 | 1.4 |
| C-163 | 90/10 | 8500 | 1.4 |
| C-164 | 25/50/25 | 6000 | 1.5 |
| C-165 | 40/40/10/10 | 6500 | 1.4 |
| C-166 | 100 | 8000 | 1.4 |
| C-167 | 100 | 6500 | 1.4 |
| C-168 | 80/20 | 5000 | 1.3 |
| C-169 | 40/30/30 | 4500 | 1.5 |
| C-170 | 90/10 | 3000 | 1.4 |
| C-171 | 100 | 4500 | 1.4 |
| C-172 | 100 | 3500 | 1.4 |
| C-173 | 60/40 | 5000 | 1.4 |
| C-174 | 90/10 | 6000 | 1.4 |
| C-175 | 100 | 4000 | 1.5 |
| C-176 | 100 | 8000 | 1.4 |
| C-177 | 100 | 5000 | 1.4 |
| C-178 | 100 | 10000 | 1.5 |
| C-179 | 100 | 6000 | 1.4 |
| C-180 | 100 | 7000 | 1.3 |
| C-181 | 100 | 5500 | 1.4 |
| C-182 | 100 | 8000 | 1.3 |
| C-183 | 90/10 | 4500 | 1.4 |
| C-184 | 80/20 | 6000 | 1.4 |
| C-185 | 70/30 | 5500 | 1.6 |
| C-186 | 85/15 | 8500 | 1.4 |
| C-187 | 90/10 | 3000 | 1.3 |
| C-188 | 70/30 | 4500 | 1.4 |
| C-189 | 75/25 | 6500 | 1.4 |
| C-190 | 55/45 | 8500 | 1.3 |
| C-191 | 90/10 | 5500 | 1.4 |
| C-192 | 75/25 | 9000 | 1.4 |
| C-193 | 70/30 | 10000 | 1.5 |
| C-194 | 70/30 | 5000 | 1.4 |
| C-195 | 80/20 | 7000 | 1.4 |
| C-196 | 85/15 | 4500 | 1.4 |
| C-197 | 80/20 | 3500 | 1.5 |
| C-198 | 75/25 | 6000 | 1.4 |
| C-199 | 100 | 5000 | 1.4 |
| C-200 | 80/20 | 6000 | 1.4 |
| C-201 | 80/20 | 8000 | 1.5 |
| C-202 | 100 | 4500 | 1.5 |
| C-203 | 70/30 | 3500 | 1.4 |
| C-204 | 80/20 | 10000 | 1.4 |
| C-205 | 80/20 | 7000 | 1.4 |
| C-206 | 90/10 | 4000 | 1.4 |
| C-207 | 80/15/5 | 10000 | 1.4 |
| C-208 | 85/10/5 | 5000 | 1.5 |
| C-209 | 90/8/2 | 13000 | 1.5 |
| C-210 | 85/10/5 | 6000 | 1.5 |

TABLE 4

| Resin | Composition | Mw | Mw/Mn |
|---|---|---|---|
| C-211 | 90/8/2 | 8000 | 1.4 |
| C-212 | 50/50 | 12000 | 1.5 |
| C-213 | 50/50 | 8000 | 1.3 |
| C-214 | 85/15 | 6500 | 1.5 |
| C-215 | 85/10 | 4000 | 1.5 |
| C-216 | 90/10 | 7500 | 1.6 |
| C-217 | 90/10 | 3500 | 1.5 |
| C-218 | 95/5 | 5500 | 1.4 |
| C-219 | 85/10/5 | 5000 | 1.5 |
| C-220 | 88/10/2 | 13000 | 1.4 |
| C-221 | 90/8/2 | 12000 | 1.5 |
| C-222 | 90/8/2 | 11000 | 1.4 |
| C-223 | 90/8/2 | 9000 | 1.5 |
| C-224 | 50/50 | 6000 | 1.5 |
| C-225 | 50/50 | 8000 | 1.5 |
| C-226 | 80/20 | 4500 | 1.3 |
| C-227 | 85/15 | 8500 | 1.6 |
| C-228 | 90/10 | 10000 | 1.4 |
| C-229 | 90/10 | 3500 | 1.5 |
| C-230 | 95/5 | 4500 | 1.5 |
| C-231 | 50/50 | 4000 | 1.5 |
| C-232 | 80/18/2 | 6000 | 1.5 |
| C-233 | 90/8/2 | 9500 | 1.5 |
| C-234 | 80/20 | 6500 | 1.4 |
| C-235 | 90/10 | 8000 | 1.5 |
| C-236 | 100 | 8000 | 1.5 |
| C-237 | 95/5 | 4500 | 1.5 |
| C-238 | 90/10 | 10000 | 1.5 |
| C-239 | 100 | 6500 | 1.4 |
| C-240 | 80/20 | 6500 | 1.4 |
| C-241 | 70/20/10 | 7000 | 1.4 |
| C-242 | 90/10 | 7000 | 1.6 |
| C-243 | 50/20/30 | 5000 | 1.3 |
| C-244 | 40/30/30 | 5000 | 1.4 |
| C-245 | 60/40 | 6000 | 1.4 |
| C-246 | 40/20/40 | 7000 | 1.4 |
| C-247 | 40/30/30 | 8000 | 1.5 |
| C-248 | 40/30/30 | 9500 | 1.5 |
| C-249 | 60/40 | 9500 | 1.5 |
| C-250 | 40/40/20 | 7500 | 1.4 |
| C-251 | 80/20 | 9000 | 1.5 |
| C-252 | 80/20 | 9000 | 1.5 |
| C-253 | 40/30/15/15 | 7000 | 1.4 |
| C-254 | 60/40 | 8500 | 1.4 |
| C-255 | 50/30/20 | 8000 | 1.4 |
| C-256 | 30/30/40 | 9500 | 1.5 |
| C-257 | 30/50/20 | 8000 | 1.3 |
| C-258 | 30/50/20 | 8000 | 1.3 |
| C-259 | 40/40/20 | 6500 | 1.4 |
| C-260 | 50/30/20 | 6000 | 1.4 |
| C-261 | 80/20 | 8500 | 1.5 |
| C-262 | 20/80 | 10000 | 1.5 |
| C-263 | 100 | 8500 | 1.5 |
| C-264 | 100 | 6000 | 1.4 |
| C-265 | 90/10 | 8000 | 1.4 |
| C-266 | 30/70 | 9000 | 1.6 |
| C-267 | 50/50 | 4000 | 1.3 |
| C-268 | 100 | 6500 | 1.4 |
| C-269 | 80/20 | 6500 | 1.4 |

The resin (a) may be used either alone or in combination of two or more thereof.

Preferably, the hard coat layer forming composition of the present invention further includes
(b) a compound having three or more ethylenically unsaturated double bond groups in its molecule,
(c) a compound having at least one epoxy group in its molecule,
(d) inorganic fine particles reactive with an epoxy group or an ethylenically unsaturated double bond group, and
(e) a UV absorbent,
   and (c) is more preferably a compound having one alicyclic epoxy group and one ethylenically unsaturated double bond group and having a molecular weight of 300 or less.

<<(b) Compound Having Three or more Eethylenically Unsaturated Double Bbond Groups in its Molecule>>

The hard coat layer forming composition of the present invention preferably includes a compound having three or more ethylenically unsaturated double bond groups in its molecule (also referred to as a compound (b)).

Examples of the ethylenically unsaturated double bond group may include a polymerizable functional group such as a (meth)acryloyl group, a vinyl group, a styryl group, and an allyl group, and among them, preferred are a (meth)acryloyl group and —C(O)OCH═CH₂, and particularly preferred is a (meth)acryloyl group. When the ethylenically unsaturated double bond group is included, it is possible to maintain high hardness as well as to impart moist heat resistance. Further, when three or more ethylenically unsaturated double bond groups are included in its molecule, higher hardness may be exhibited.

Examples of the compound (b) may include ester of polyhydric alcohol and (meth)acrylamide, vinylbenzene and a derivative thereof, vinylsulfone, and (meth)acrylamide. Among them, from the viewpoint of the hardness, a compound having three or more (meth)acryloyl groups is preferred, and examples thereof may include an acrylate-based compound that forms a cured product with high hardness, which is widely used in this field. Examples of such a compound may include ester of polyhydric alcohol and (meth)acrylate, for example, pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphate tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate, and caprolactone-modified tris(acryloxyethyl) isocyanurate.

Specific examples of the polyfunctional acrylate-based compounds having three or more (meth)acryloyl groups may include KAYARAD DPHA, DPHA-2C, PET-30, TMPTA, TPA-320, TPA-330, RP-1040, T-1420, D-310, DPCA-20, DPCA-30, DPCA-60, and GPO-303 (all manufactured by Nippon Kayaku Co., Ltd.), and an esterified compound of polyol and (meth)acrylic acid such as V#400 and V#36095D (all manufactured by OSAKA ORGANIC CHEMICAL INDUSTRY LTD.). Further, a tri- or higher-functional urethane acrylate compound such as SHIKOH UV-1400B, UV-1700B, UV-6300B, UV-7550B, UV-7600B, UV-7605B, UV-7610B, UV-7620EA, UV-7630B, UV-7640B, UV-6630B, UV-7000B, UV-7510B, UV-7461TE, UV-3000B, UV-3200B, UV-3210EA, UV-3310EA, UV-3310B, UV-3500BA, UV-3520TL, UV-3700B, UV-6100B, UV-6640B, UV-2000B, UV-2010B, UV-2250EA, and UV-2750B (all manufactured by The Nippon Synthetic Chemical Industry Co., Ltd.), UL-503LN (manufactured by KYOEISHA CHEMICAL Co., LTD.), UNIDIC 17-806, 17-813, V-4030, and V-4000BA (all manufactured by Dainippon Ink and Chemicals, Incorporated), EB-1290K, EB-220, EB-5129, EB-1830, and EB-4358 (all Daicel-UCB Co. Ltd. [symbol] ), Hi-Coap AU-2010 and AU-2020 (all manufactured by Tokushiki Co., Ltd.), ALLONIX M-1960 (manufactured by TOAGOSEI CO., LTD.), ATERESIN UN-3320HA, UN-3320HC, UN-3320HS, UN-904, and HDP-4T, and a tri- or higher-functional polyester compound such as ALLONIX M-8100, M-8030, and M-9050 (all manufactured by TOAGOSEI CO., LTD.), and KBM-8307 (manufactured by DAICEL-CYTEC Co., Ltd.), may be suitable used.

Further, the compound (b) may be formed as a single compound, or may be used in combination of a plurality of compounds.

When the total solid (the total component except a solvent) of the hard coat layer forming composition of the present invention is assumed to 100% by mass, the compound (b) is contained in an amount of 40% by mass to 80% by mass, preferably 45% by mass to 75% by mass, and more preferably 50% by mass to 70% by mass. If the content is 40% by mass or more, it is possible to obtain a sufficient hardness. Meanwhile, if the content is 80% by mass or less, the resin (a) is not deficient, and the contact angle may be reduced, so that the smoothness is not deteriorated.

The compound (b) preferably has an ethylenically unsaturated bond group equivalent of 80 to 130. The ethylenically unsaturated bond group equivalent means a numerical value calculated by dividing the molecular weight of the compound (b) by the number of the ethylenically unsaturated bond group.

The ethylenically unsaturated bond group equivalent of the compound (b) is 80 to 130, preferably 80 to 110, and more preferably 80 to 100.

<<Compound Having at Lleast One Epoxy Group in its Molecule>>

The hard coat layer forming composition of the present invention preferably contains a compound having at least one epoxy group in its molecule (also referred to as a compound (c)).

The epoxy group possessed by the compound (c) is not particularly limited as long as there is one or more thereof.

The molecular weight of the compound (c) is preferably 300 or less, more preferably 250 or less, and still more preferably 200. Further, from the viewpoint of suppressing volatilization during the formation of the hard coat layer, the molecular weight of the compound (c) is preferably 100 or more, and more preferably 150 or more.

Meanwhile, if the epoxy group is alicyclic and the molecular weight is 300 or less, the effect to prevent deterioration of the hardness may be enhanced.

When the total solid of the hard coat layer forming composition of the present invention is assumed to 100% by mass, the compound (c) is contained in an amount of 105% by mass to 40% by mass, preferably 125% by mass to 35% by mass, and more preferably 155% by mass to 25% by mass. When the content is 10% by mass or more, the smoothness enhancing effect is excellent, so that the surface aspect of the hard coat layer is improved. Meanwhile, when the content is 40% by mass or less, the hardness is enhanced.

Preferably, the compound (c) further contains an ethylenically unsaturated double bond group. The ethylenically unsaturated double bond group is not particularly limited, but examples thereof may include a (meth)acryloyl group, vinyl group, a styryl group, and an allyl group. Among them, preferred are a (meth)acryloyl group and —C(O)OCH═CH₂, and particularly preferred is a (meth)acryloyl group.

When the compound(c) has an ethylenically unsaturated double bond group, a bonding strength with the compound (b) is imparted, so that hardness deterioration is prevented, and bursting during moist heat durability may be suppressed.

The compound (c) is not particularly limited as long as one or more alicyclic epoxy group is contained in the molecule, but specific examples thereof may include bicyclohexyl diepoxide; 3,4,3′,4′-diepoxybicyclohexyl, butane tetracarboxylate tetra(3 ,4-epoxycyclohexylmethyl) modified ε-caprolactone, a compound in paragraph [00151] of Japanese Patent Laid-Open Publication No. Hei 10-17614 or, a compound represented by Formula (1A) or (1B) below, or 1,2-epoxy-4-vinylcyclohexane. Among them, the compound represented by Formula (1A) or (1B) below is more preferred, and the compound represented by Formula (1A) below, which has a low molecular weight, is still more preferred. Meanwhile, an isomer of the compound represented by Formula (1A) below is also preferred.

By using these compounds, the smoothness may be enhanced, and the high hardness may be maintained.

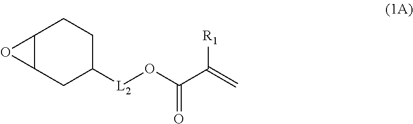

In Formula (1A), R₁ represents a hydrogen atom or a methyl group, and L₂ represents a divalent aliphatic hydrocarbon group having 1 to 6 carbon atoms.

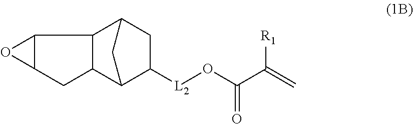

In Formula (1B), R₁ represents a hydrogen atom or a methyl group, and L₂ represents a divalent aliphatic hydrocarbon group having 1 to 6 carbon atoms.

In Formulas (1A) and (1B), the divalent aliphatic hydrocarbon group of L₂ has 1 to 6 carbon atoms, preferably 1 to 3 carbon atoms, and more preferably 1 carbon atom. The divalent aliphatic hydrocarbon group is preferably a straight, branched, or cyclic alkylene group, more preferably a straight or branched alkylene group, and still more preferably a straight alkylene group.

<<Inorganic Fine Particles>>

The hard coat layer forming composition of the present invention preferably contains inorganic fine particles reactive with an epoxy group or an ethylenically unsaturated double bond group (also referred to as inorganic fine particles (d)).

Since the addition of the inorganic fine particles (d) is able to increase the hydrophilicity of the cured layer, the contact angle may be reduced. Further, since the amount of cure shrinkage in a cured layer may be reduced, the film curling may be reduced. Moreover, the use of the inorganic fine particles reactive with an epoxy group or an ethylenically unsaturated double bond group makes it possible to improve pencil hardness. Examples of the inorganic fine particles may include silica particles, titanium dioxide particles, zirconium oxide particles, and aluminum oxide particles. Among them, silica particles are preferred.

In general, since the inorganic fine particles have low affinity with organic components, such as polyfunctional vinyl monomers, a simple mixture thereof may merely form an aggregate or tends to easily cause a crack in the cured layer after curing. In order to increase the affinity between the inorganic fine particles and organic components, the surface of the inorganic fine particles is treated with a surface modifier containing an organic segment.

The surface modifier preferably has a functional group capable of forming a bond with the inorganic particles or being adsorbed to the inorganic particles, and a functional group having high affinity with organic components in the same molecule. The surface modifier having a functional group capable of being bonded with or adsorbed to the inorganic particles is preferably a metal alkoxide surface modifier such as silane, aluminum, titanium, and zirconium, or a surface modifier having an anionic group such as a phosphate group, a sulfate group, a sulfonate group, and a carboxylate group. Further, a functional group having high affinity with organic components may be one formed by just combining the hydrophilicity and the hydrophobicity with the organic component, but preferred is a functional group capable of chemically bonding with the organic components, and particularly preferred is an ethylenically unsaturated double bond group or a ring-opening polymerizable group.

The preferred inorganic particle surface modifier in the present invention is a curable resin having a metal alkoxide or an anionic group and an ethylenically unsaturated double bond group or ring-opening polymerizable group in the same molecule. By chemically bonding with organic components, the crosslinking density of the hard coat layer increases, which in turn increases the pencil hardness.

Representative examples of the surface modifier may include an unsaturated double bond-containing coupling agent, a phosphate group-containing organic curable resin, a sulfate group-containing organic curable resin and a carboxylate group-containing organic curable resin, as listed below.

S-1 H₂C═C(X)COOC₃H₆Si(OCH₃)₃

S-2 H₂C═C(X)COOC₂H₄OTi(OC₂H₅)₃

S-3 H₂C═C(X)COOC₂H₄OCOC₅H₁₀OPO(OH)₂

S-4 (H₂C═C(X)COOC₂H₄OCOC₅H₁₀O)₂POOH

S-5 H₂C═C(X)COOC₂H₄OSO₃H

S-6 H₂C═C(X)COO(C₅H₁₀COO)₂H

S-7 H₂C═C(X)COOC₅H₁₀COOH

S-8 CH₂CH(O)CH₂OC₃H₆Si(OCH₃)₃

(X represents a hydrogen atom or CH₃)

Preferably, these inorganic fine particles are subjected to surface modification in a solution. The inorganic fine particles may be mechanically micro-dispersed together with a surface modifier, or may first be micro-dispersed and then, after the addition of the surface modifier, stirred, or may be subjected to surface modification before micro-dispersed (optionally followed by warming, heating after drying, or pH adjustment) and then micro-dispersed. A solution for dissolving the surface modifier is preferably an organic solvent having high polarity, and specifically a known solvent such as alcohol, ketone, or ester.

The organic fine particles have an average primary particle size of preferably 10 nm to 100 nm, and more preferably 0 nm to 60 nm. The average particle size of fine particles can be obtained from an electron micrograph. If the particle size of inorganic fine particles is overly small, no improvement of hardness is achieved, and if the particle size is overly large, it may increase a haze.

It is no matter whether inorganic fine particles have a spherical or non-spherical shape, but non-spherical shape in which 2 to 10 inorganic fine particles are connected is preferred in terms of imparting hardness. It is presumed that by using inorganic fine particles having a chained shape in which several inorganic fine particles are connected, a strong particle network structure may be formed to thereby increase hardness.

Specific examples of the inorganic fine particles may include ELECOM V-8802 (spherical silica fine particles having an average particle size of 12 nm, manufactured by JGC CORPORATION) or ELECOM V-8803 (non-spherical silica fine particles, manufactured by JGC CORPORATION), MiBK-SD (spherical silica fine particles having an average particle size of 10 nm to 20 nm, manufactured by NISSAN CHEMICAL INDUSTRIES, LTD.), MEK-AC-2140Z (spherical silica fine particles having an average particle size of 10 nm to 20 nm, manufactured by NISSAN CHEMICAL INDUSTRIES, LTD.), MEK-AC-4130C (spherical silica fine particles having an average particle size of 40 nm to 50 nm, manufactured by NISSAN CHEMICAL INDUSTRIES, LTD.), MiBK-SD-L (spherical silica fine particles having an average particle size of 40 nm to 50 nm, manufactured by NISSAN CHEMICAL INDUSTRIES, LTD.) and MEK-AC-5140 Z (spherical silica fine particles having an average particle size of 70 nm to 100 nm, manufactured by NISSAN CHEMICAL INDUSTRIES, LTD.). Among them, ELECOM V-8803, no-spherical silica fine particles, is preferred in terms of imparting hardness.

When the total solid in the hard coat layer forming composition of the present invention is assumed to 100% by mass, the inorganic fine particles (d) is contained in an amount of 10% by mass to 40% by mass, preferably 15% by mass to 30% by mass, and more preferably 15 mass % to 25 mass %.

<<UV Absorbent>>

The hard coat layer forming composition of the present invention preferably contains a UV absorbent (also referred to as a UV absorbent (e)).

The hard coat film of the present invention is used for a member for a polarizing plate or a member for liquid crystal display, and a UV absorbent is preferably used from the viewpoint of suppressing deterioration of the polarizing plate or the liquid crystal. A UV absorbent which is excellent in an absorbing performance of ultraviolet rays at a wavelength of 370 nm or less and has less absorption of visible lights at a wavelength of 400 nm or more from the viewpoint of a good liquid crystal display characteristic, is preferably used. The UV absorbent may be used either alone or in combination of two or more thereof. Examples thereof may include the UV absorbents described in Japanese Patent Laid-Open Publication No. 2001-72782 or Japanese National Publication of International Patent Application No. 2002-543265. Specific examples thereof may include an oxybenzophenone-based compound, a benzotriazole-based compound, a salicylate ester-based compound, a benzophenone-based compound, a cyanoacrylate-based compound, and nickel complex salt-based compound.

<<Solvent>>

In the present invention, the hard coat layer forming composition may contain a solvent. For the solvent, various solvents may be used in consideration of solubility of monomer, dispersity of translucent particles, and dryness during the coating. Examples of the organic solvent may include dibutyl ether, dimethoxyethane, diethoxyethane, propylene oxide, 1,4-dioxane, 1,3-dioxolane, 1,3,5-trioxane, tetrahydrofuran, anisole, phenetole, dimethyl carbonate, methylethyl carbonate, diethyl carbonate, acetone, methyl ethyl ketone (MEK), diethyl ketone, dipropyl ketone, diisobutyl ketone, cyclopentanone, cyclohexanone, methylcyclohexanone, ethyl formate, propyl formate, pentyl formate, methyl acetate, ethyl acetate, propyl acetate, methyl propionate, ethyl propionate, y-butyrolactone, methyl 2-methoxyacetate, methyl 2-ethoxyacetate, ethyl 2-ethoxyacetate, ethyl 2-ethoxypropionate, 2-methoxyethanol, 2-propoxyethanol, 2-butoxyethanol, 1,2-diacetoxyacetone, acetylacetone, diacetone alcohol, methyl acetoacetate, ethyl acetoacetate, methyl alcohol, ethyl alcohol, isopropyl alcohol, n-butyl alcohol, cyclohexyl alcohol, isobutyl acetate, methyl isobutyl ketone (MIBK), 2-octanone, 2-pentanone, 2-hexanone, ethylene glycol ethyl ether, ethylene glycol isopropyl ether, ethylene glycol butyl ether, propylene glycol methyl ether, ethyl carbitol, butyl carbitol, hexane, heptane, octane, cyclohexane, methylcyclohexane, ethylcyclohexane, benzene, toluene, xylene, methanol, ethanol, and tert-butyl alcohol, which may be used either alone or in combination of two or more thereof.

In the present invention, the solvent is preferably used such that the concentration of the solid of the hard coat layer forming composition is in a range of 20% by mass to 80% by mass, more preferably 30% by mass to 75% by mass, still more preferably 40% by mass to 70% by mass.

The present inventors has found that, when a hard coat layer fabricated by using the hard coat layer forming composition of the present invention is used as a lower layer, it is possible to fabricate an upper layer in which cissing during coating is hard to occur even when the upper layer is coated and formed on the surface, and simultaneously, film surface is uniform and unevenness is not present. While not wishing to be bound by any theory, as described above, during the coating, the surface of the hard coat layer composed of the hard coat layer forming composition containing the resin (a) exhibiting a surface aspect smoothing (leveling) function may be hydrophilized by performing saponification on the film, thereby preventing generation of cissing when forming the upper layer. Because of the property as described above, when a layer formed of the hard coat layer forming composition of the present invention may be used as a lower layer, and an upper layer is coated and formed on the surface, various solvents may be used as a solvent for an upper layer forming coating liquid.

The hard coat layer forming composition may contain an additive such as a radical polymerization initiator, in addition to (a) to (e) above.

(Radical Polymerization Initiator)

The hard coat layer forming composition of the present invention may contain a radical polymerization initiator.

Polymerization of a compound having an ethylenically unsaturated group may be performed by irradiation with ionizing radiation or by heating in the presence of a photo-radical polymerization initiator or a thermal radical polymerization initiator. As photo and thermal polymerization initiators, commercially available compounds may be used and such compounds are disclosed in “Recent UV Curing Technology” (see p. 159, published by Takasusuki Kazuhiro at Technical Information Institute Co., Ltd., 1991) or a catalogue issued by Chiba Specialty Chemicals Inc.

Specific examples of the radical polymerization initiator may include an alkylphenone-based photo polymerization initiator (such as Irgacure 651, Irgacure 184, DAROCURE 1173, Irgacure 2959, Irgacure 127, DAROCURE MBF, Irgacure 907, Irgacure 369, and Irgacure 379EG), an acyl phosphine oxide-based photo polymerization initiator (such as Irgacure 819 and LUCIRIN TPO), and others (such as Irgacure 784, Irgacure OXE01, Irgacure OXE02, and Irgacure 754).

When the total solid of the hard coat layer forming composition of the present invention is assumed to 100% by mass, the amount of the radical polymerization initiator added is in a range of 0.1% by mass to 10% by mass, preferably 1% by mass to 5% by mass, and more preferably 2% by mass to 4% by mass. If the amount is less than 0.1% by mass, polymerization does not fully occur and thus the hardness of the hard coat layer is insufficient. Meanwhile, if the amount is greater than 10% by mass, UV beams do not reach the inside of the film and thus the hardness of the hard coat layer is insufficient. Each of these radical initiators may be used either alone or in combination of two or more thereof.

(Cationic Polymerization Initiator)

The hard coat layer forming composition of the present invention may contain a cationic polymerization initiator.

As the cationic polymerization initiator, known compounds, such as a photo-cationic polymerization initiator, photo-decolorants of colorants, photo-color changing agents, or known acid generators used in a microresist and the like, and a mixture thereof may be used.

Examples thereof may include an onium compound, an organic halogen compound, and a disulfonic compound. Specific examples of the organic halogen compound and the disulfonic compound include the same ones as listed for the compound capable of generating the radical.

Examples of the onium compound may include a diazonium salt, an ammonium salt, an iminium salt, a phosphonium salt, an iodonium salt, a sulfonium salt, an arsonium salt, and a selenonium salt, and for instance, also include those compounds listed in paragraphs [00589 and [0059] of Japanese Patent Laid-Open Publication No. 2002-29162.

As a cationic polymerization initiator that is particularly suitable for use in the present invention, an onium salt may be used, and a diazonium salt, an iodonium salt, a sulfonium salt, and an iminium salt are preferred in terms of the photosensitivity upon initiation of photo-polymerization and the stability of a compound material. Among them, an iodonium salt is most preferred in terms of light resistance.

Specific examples of the onium salt that may suitably be used in the present invention may include an amylated sulfonium salt disclosed in paragraph [0035] of Japanese Patent Laid-Open Publication No. Hei 9-268205, a diaryl iodonium salt or a triaryl sulfonium salt disclosed in paragraphs [0010] and [0011] of Japanese Patent Laid-Open Publication No. 2000-71366, a sulfonium salt of thiobenzoic acid S-phenyl ester described in paragraph [00179 of Japanese Patent Laid-Open Publication No. 2001-288205, and an onium salt disclosed in paragraphs [0030] to [0033] of Japanese Patent Laid-Open Publication No. 2001-133696.

Other examples thereof may include a compound such as an organometallic/organic halogenated compound, a photo acid generator having an o-nitrobenzyl type protective group, and a compound that is photo-decomposed to generate a sulfonic acid (such as iminosulfonate), which are disclosed in paragraphs [0059] to [0062] of Japanese Patent Laid-Open Publication No. 2002-29162.

Specific examples of the iodonium salt-based cationic polymerization initiator may include B2380 (manufactured by Tokyo Chemical Industry Co., Ltd.), BBI-102 (manufactured by Midori Kagaku Co., Ltd.), WPI-113 (manufactured by Wako Pure Chemical Industries, Ltd.), WPI-124 (manufactured by Wako Pure Chemical Industries, Ltd.), WPI-169 (manufactured by Wako Pure Chemical Industries, Ltd.), WPI-170 (manufactured by Wako Pure Chemical Industries, Ltd.), and DTBPI-PFBS (Toyo Gosei Co., Ltd.).

### (Wind Unevenness Inhibitor)

The hard coat layer forming composition of the present invention may contain a wind unevenness inhibitor.

(Fluorine-Based Surfactant and Silicon-Based Surfactant)

The hard coat layer forming composition may contain a fluorine-based surfactant and a silicon-based surfactant, but since the hydrophobicity is increased so that the contact angle becomes higher, it is preferred that they are substantially not contained. The surface of the formed hard coat layer is hard to be hydrophobic, so that cissing is hardly generated when forming the upper layer.

Specifically, the content of the fluorine-based surfactant and the silicon-based surfactant of the hard coat layer forming composition is 0.05% by mass or less, preferably 0.01% by mass or less, and more preferably 0% by mass based on the total mass of the hard coat layer forming composition.

The fluorine-based surfactant is a fluorine-containing compound, and is a compound unevenly distributed on the surface in a solvent used in the hard coat layer forming composition. Examples of a fluorine-based surfactant having a hydrophobic moiety may include a fluorine-containing compound among those described as an orientation controlling agent in paragraphs 0028 to 0034 of Japanese Patent Laid-Open Publication No. 2011-191582, a fluorine-based surfactant described in Japanese Patent No. 2841611, and a fluorine-based surfactant described in paragraphs 0017 to 0019 of Japanese Patent Laid-Open Publication No. 2005-272560.

Examples of a commercially available fluorine-based surfactant may include Surflon manufactured by AGC SEIMI CHEMICAL CO., LTD., Megafac manufactured by DIC Corporation, and Ftergent manufactured by Neos Corporation.

The silicon-based surfactant is a silicon-containing compound, and is a compound unevenly distributed on the surface in a solvent used in an optically functional layer fabricating composition.

Examples of the silicon-based surfactant may include a silicon atom-containing low molecular weight compound such as polymethylphenylsiloxane, polyether-modified silicone oil, polyether-modified dimethylpolysiloxane, dimethyl silicone, diphenyl silicone, hydrogen-modified polysiloxane, vinyl-modified polysiloxane, hydroxyl-modified polysiloxane, amino-modified polysiloxane, carboxyl-modified polysiloxane, chloro-modified polysiloxane, epoxy-modified polysiloxane, methacryloxy-modified polysiloxane, mercapto-modified polysiloxane, fluorine-modified polysiloxane, long-chain alkyl-modified polysiloxane, phenyl-modified polysiloxane, and silicon-modified copolymer.

Examples of a commercially available silicon-based surfactant may include KF-96 and X-22-945 (all manufactured by Shin-Etsu Chemical Co., Ltd.), Toray silicon DC3PA, DC7PA, SH11PA, SH21PA, SH28PA, SH29PA, SH3OPA, and FS-1265-300 (all manufactured by Dow Coming Toray Silicone Co., Ltd.), TSF-4300, -4440, -4445, -4446, -4452, and -4460 (all manufactured by GE Toshiba Silicones Co., Ltd.), polysiloxane polymer KP341 (manufactured by Shin-Etsu Chemical Co., Ltd.), BYK-301, BYK-302, BYK-307, BYK-325, BYK-331, BYK-333, BYK-341, BYK-345, BYK-346, BYK-348, and BYK-375 (all manufactured by BYK-Chemie Japan KK), ARON GS-30 (manufactured by TOAGOSEI CO., LTD.), and Silicon L-75, Silicon L-76, Silicon L-77, Silicon L-78, Silicon L-79, Silicon L-520, and Silicon L-530 (manufactured by Nippon Unicar. Co., Ltd.).

<Transparent Support>

In the present invention, a glass or a polymer film may be used as a transparent support. Examples of a material of the polymer film used as a support may include a cellulose acylate film (for example, a cellulose triacetate film (refractive index 1.48), a cellulose diacetate film, a cellulose acetate butyrate film, and cellulose acetate propionate film), polyolefin such as polyethylene and polypropylene, a polyester-based resin such as polyethylene terephthalate or polyethylene naphthalate, a polyester sulfone film, a polyacrylate-based resin film such as polymethyl methacrylate, a polyurethane-based resin film, a polyester film, a polycarbonate film, a polysulfone film, a polyether film, a polymethylpentene film, a polyether ketone film, a (meth)acrylonitrile film, polyolefin, a polymer having an alicyclic structure (a norbornene-based resin (ARTON: trade name, manufactured by JSR Corporation, amorphous polyolefin (ZEONEX: trade name, manufactured by Zeon Corporation)). Among them, a cellulose acylate film is preferred.

The transparent support may be a temporary support which will be peeled off after the formation of the hard coat layer.

The film thickness of the transparent support is about 1 μm to 1,000 μm, and, since it is preferable to suit a mobile use, the film thickness is preferably 1 μm to 100 μm, and more preferably 1 μm to 25 μm.

[Preparation of Hard Coat Film]

The hard coat film may be prepared by coating the hard coat layer forming composition on the transparent support, and drying and curing the composition to form a hard coat layer. The transparent support may be peeled off after the hard coat layer is formed.

<Coating Method>

Each of the layers on the hard coat film of the present invention can be formed by the following coating methods, but not limited to the methods. Well-known methods such as a dip coating method, an air knife coating method, a curtain coating method, a roller coating method, a wire bar coating method, a gravure coating method, a slide coating method, an extrusion coating method (die coating method) (see Japanese Patent Laid-Open Publication No. 2003-164788), and a microgravure coating method, are used, and among them, a microgravure coating method and a die coating method are preferred.

<Drying and Curing Conditions>

Preferred examples of a drying and curing method used when forming a layer by coating the hard coat layer of the present invention, will be described hereinafter.

In the present invention, curing is effective by performing heat treatment before, simultaneously with or after irradiation with ionizing radiation.

Some patterns of manufacturing process are illustrated below, but the present invention is not limited thereto. (In the following, “-” indicates that heat treatment is not performed.)

| | Before | | Simultaneously with | | After |
|---|---|---|---|---|---|
| | irradiation | → | irradiation | → | irradiation |
| (1) | Heat treatment | → | Curing by ionizing | → | — |
| | | | radiation | | |
| (2) | Heat treatment | → | Curing by ionizing | → | Heat treatment |
| | | | radiation | | |
| (3) | — | → | Curing by ionizing | → | Heat treatment |
| | | | radiation | | |

It is also preferred to perform heat treatment simultaneously with curing by ionization radiation.

In the present invention, it is preferred to perform heat treatment in combination with irradiation with ionizing radiation, as described above. Although not particularly restricted as long as the layers constituting the hard coat film, including the support and the hard coat layer, are not damaged, the heat treatment is performed preferably at a temperature of 40° C. to 150° C. and more preferably 40° C. to 80° C.

Although it varies depending on various factors, such as the molecular weight of the component used, the interaction with other components, and the viscosity, the time required for the heat treatment is 15 seconds to 1 hour, preferably 20 seconds to 30 min and most preferably 30 sec to 5 min

Although not particularly limited in terms of type, the ionization radiation may be, for example, X-ray, electron beam, UV light, visible light and infrared light. UV light is widely used. For example, when a coating layer is UV curable, it is preferred to cure each layer by irradiating with a UV light dose of 10 mJ/cm² to 1,000 mJ/cm² using a UV lamp. Upon irradiation, the light may be applied in a single dose or in divided doses. It is particularly preferred to irradiate UV light in two or more divided doses in terms of reducing performance non-uniformity in the in-plane of the coating film and improving curling. It is preferred that a low UV light dose of 150 mJ/cm² or less is first irradiated at an initial stage, and a high UV light does of 50 mJ/cm² or greater is irradiated at a later stage. It is preferred that the dose of UV light irradiated at the later stage is higher than that irradiated at the initial stage.

The hard coat film of the present invention is manufactured according to the method of manufacturing the hard coat film of the present invention.

Generally, the simplest configuration of the hard coat film of the present invention is provided with a hard coat layer coated on a transparent support.

Examples of a preferred layer configuration of the hard coat film according to the present invention are illustrated below, but not particularly limited thereto.

Support/hart coat layer

Support/hart coat layer/low refractive index layer

Support/hart coat layer/antiglare layer (antistatic layer)/low refractive index layer

Support/hart coat layer/antiglare layer/antistatic layer/low refractive index layer

Support/hart coat layer/antistatic layer/anti-glare layer/low refractive index layer

Support/hart coat layer/(antistatic layer)/antiglare layer/low refractive index layer

Support/hart coat layer/high refractive index layer/antistatic layer/low refractive index layer

Support/hard coat layer/high refractive index layer/(antistatic layer)/low refractive index layer

Support/hard coat layer/antistatic layer/high refractive index layer/low refractive index layer

Support/hard coat layer/intermediate refractive index layer/high refractive index layer(antistatic layer)/low refractive index layer

Support/hard coat layer/intermediate refractive index layer (antistatic layer)/high refractive index layer/low refractive index layer

Support/hard coat layer(antistatic layer)/intermediate refractive index layer/high refractive index layer/low refractive index layer

Support/antistatic layer/hard coat layer/intermediate refractive index layer/high refractive index layer/low refractive index layer

Antistatic layer/support/hard coat layer/intermediate refractive index layer/high refractive index layer/low refractive index layer

Herein, the antistatic layer and the antiglare layer may have hard coatability.

The film thickness of the hard coat layer of the present invention may be selected according to the desired hardness, and may preferably range between 1 μm and 50 μm. This is because forming the hard coat layer thick does not cause a handling problem due to a small amount of curling in the hard coat film of the present invention. Also when used as a polarizer protective film, the hard coat layer is preferably designed to a thickness of 3 μm to 10 μm.

When the hard coat film of the present invention is used for fabrication of a laminate film in which the upper layer is laminated as described above, cissing of the upper layer forming coating composition is hard to occur, so that a uniform upper layer may be formed. While not wishing to be bound by any theory, it is considered that the polarity converting group is hydrophilicized by performing saponification on the film.

<Polarizing Plate>

The polarizing plate of the present invention has at least one hard coat film of the present invention, and preferably includes the hard coat film bonded to the polarizer after performing saponification.

The hard coat film of the present invention may be used as a protective film for a polarizing plate. When using as a protective film for a polarizing plate, the fabrication method of the polarizing plate is not particularly limited, but an ordinary method may be used. There is a method in which the obtained hard coat film is subjected to an alkali treatment, and bonded to both sides of the polarizer, which is fabricated by immerging and stretching a polyvinyl alcohol film in an iodine solution, using a fully saponified polyvinyl alcohol aqueous solution. Instead of the alkali treatment, an adhesion facilitating processing as described in Japanese Patent Laid-Open Publication Nos. Hei 6-94915 and Hei 6-118232 may be performed. Further, the surface treatment as described above may be performed. The bonded surface of the optical film to the polarizer may be a surface in which the film is laminated to a low moisture permeable layer, or a surface in which the film is not laminated.

Examples of an adhesive used in bonding the treated surface of the protective film to the polarizer include a polyvinyl alcohol-based adhesive such as polyvinyl alcohol and polyvinyl butyral, and a vinyl-based latex such as butyl acrylate.

The polarizing plate is composed of a polarizer and protective film that protects both sides thereof, and also configured by bonding a protect film on one surface of the polarizing plat and bonding a separate film on the other surface. The protect film and the separate film are used for the purpose of protecting the polarizing plate when shipping the polarizing plate or during the product inspection. In this case, the protect film is bonded for protecting the surface of the polarizing plate, and used in an opposite side to a surface of the polarizing plate that is bonded to a liquid crystal plate. Further, the separate film is used for covering the adhesive layer bonded to the liquid crystal plate, and us used in a surface side of the polarizing plate that is bonded to the liquid crystal plate.

<Touch Panel Display>

The touch panel display of the present invention includes a liquid crystal cell, the polarizing plate of the present invention disposed on a viewing side of the liquid crystal cell, and an optically clear resin (OCA) or an optically clear adhesive (OCR) disposed on a surface of the polarizing plate opposite to the liquid crystal cell.

### EXAMPLES

Hereinafter, the present invention will be described in more detail with reference to Examples. The materials, reagents, amounts and ratios of substances, operations and the like shown in the following Examples may be appropriately modified as long as they do not depart from the spirit of the present invention. Therefore, the scope of the present invention is not limited to the following specific examples.

<Preparation of Hard coat Layer Coating Liquid>

With composition listed in Tables 5 and 6, coating liquids A01 to A24 were prepared using the hard coat forming composition. In Tables 5 and 6, “%” indicates “% by mass”, a numerical value in the solvent indicates a content of each solvent contained in the total amount of the coating liquid, and numeral values in other components indicate contents in the components in the hard coat layer coating liquid except the solvent.

Compounds listed in Tables 5 and 6 are described below. <<Compound(b)>>

DPHA: KAYARD DPHA (manufactured by Nippon Kayaku Co., Ltd.) (hexa-functional)

ATMMT: Pentaerythritol tetraacrylate (manufactured by Shin-Nakamura Chemical Co., Ltd.) (tetra-functional)

UV1700B: Urethane (meth)acrylate (manufactured by The Nippon Synthetic Chemical Industry Co., Ltd.) (deca-functional)

A-DCP: Tricyclodecane dimethanol diacrylate (manufactured by Shin-Nakamura Chemical Co., Ltd.)

<<Polymerization Initiator>>

Irgacure 127: Acylphosphine oxide-based photo-polymerization initiator (manufactured by BASF)

Irgacure 184: alkylphenone-based photo-polymerization initiator (manufactured by BASF)

<<Resin (a)>>

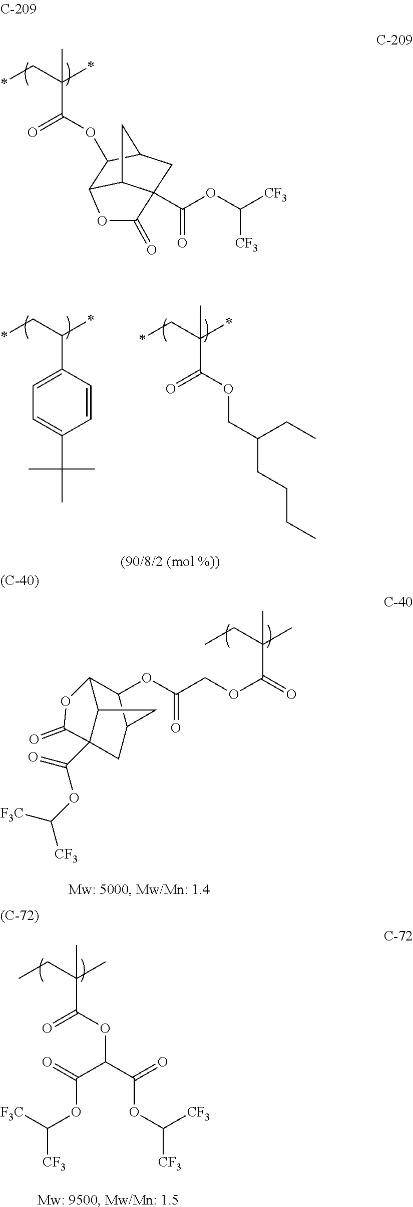

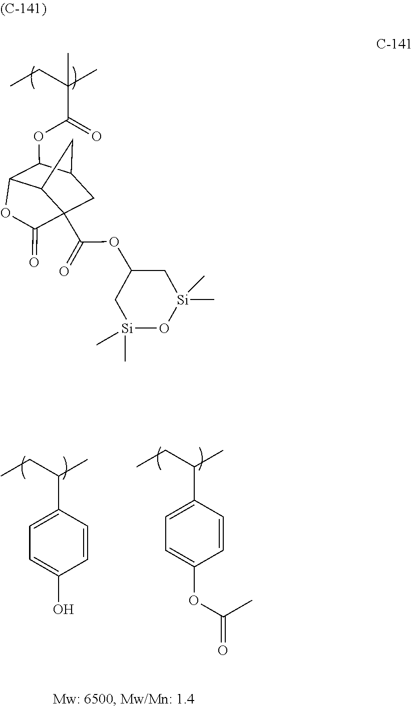

<<Polarity Converting Group-Free Leveling Agent>>

Ftergent 610FM: (manufactured by Neos Corporation)

FP-1: The following fluorine-containing compound(Mw: 20,000)

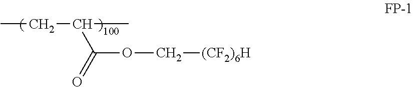

<<Compound (c)>>

3,4-Epoxycyclohexylmethyl methacrylate: CYCLOMER M100 (Daicel Corporation, molecular weight 196)

3′,4′-Epoxycyclohexylmethyl-3,4-epoxycyclohexane carboxylate: CELLOXIDE 2021P (Daicel Corporation, molecular weight 252)

Glycidyl methacrylate:

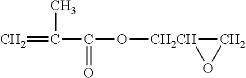

<<Polymerization Initiator>>

Compound 1: Compound 1 was synthesized by the method described in Example 1 of Japanese Patent No. 4841935.

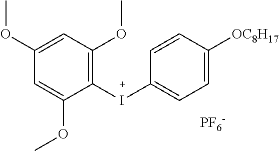

B2380: Iodonium salt-based cationic polymerization initiator (manufactured by Tokyo Chemical Industry Co., Ltd.)

<<Inorganic Fine Particles>>

ELECOM V-8802: Average particle size 12 nm, including a polymerizable group, MiBK dispersion having a 40% solid content by mass of spherical silica fine particles (manufactured by JGC CORPORATION)

ELECOM V-8803: including a polymerizable group, MiBK dispersion having a 40% solid content by mass of hetero (connected in a chain shape) silica fine particles (JGC CORPORATION)

MiBK-ST: Average particle size 10 nm to 20 nm, MiBK dispersion having a 30% solid content by mass of silica fine particles imparted with no reactive group (manufactured by NISSAN CHEMICAL INDUSTRIES, LTD.)

<<UV Absorbent>>

Tinuvin928: Benzotriazole-based UV absorbent (manufactured by BASF)

<<Solvent>>

MEK: Methyl ethyl ketone

MiBK: Methyl isobutyl ketone

(Fabrication of 40 μm Acrylic Film)

Into a reactor having an internal volume of 30 L and provided with a stirring device, a temperature sensor, a condenser, and a nitrogen inlet tube, 8,000 g of methyl methacrylate (MMA), 2,000 g of 2-(hydroxymethyl)methacrylate (MHMA) and 10,000 g of toluene as a polymerization solvent were charged, and while passing a nitrogen gas therethrough, the temperature was elevated to 105° C. When circulation began with the elevation of the temperature, 10.0 g of t-amylperoxyisononanoate was added as a polymerization initiator and a solution consisting of 20.0 g of t-amylperoxyisononanoate and 100 g of toluene dropped for two (2) hours to proceed with solution polymerization under a reflux at a temperature of about 105° C. to 110° C., and proceed with aging for another 4 hours. The polymerization reaction rate was 96.6%, and the content of MHMA in the resulting polymer (wt %) was 20.0%.

Then, 10 g of stearyl phosphate/distearyl phosphate mixture (Phoslex A-18 manufactured by Sakai Chemical Industry Co., Ltd.) was added to the resulting polymer solution to proceed with a cyclization condensation reaction for 5 hours under a reflux at approximately 80° C. to 100° C.

Then, the resulting polymer solution was introduced at the processing rate of 2.0 kg/h in terms of the amount of resin into a vent-type twin-screw extruder (screw diameter: φ=29.75 mm, the effective length: L/D=30) having a barrel temperature of 260° C., a rotation rate of 100 rpm, a vacuum degree of 13.3 hPa to 400 hPa (10 mmHg to 300 mmHg), one rear vent and four front vents, followed by cyclization condensation reaction and devolatilization in the extruder. Then, after devolatilization was completed, the resin left in a hot molten state in the extruder was discharged from the tip of the extruder and then pelleted by a pelletizer to thereby obtain transparent pellets of acrylic resin having a lactone ring structure in the main chain. The weight average molecular weight of the resin was 148,000, the melt flow rate (compliant JISK7120, measured under a test temperature of 240° C. and a load of 10 kg, the same conditions as them were applied in the following preparation example) was 11.0 g/10 min, and the glass transition temperature was 130° C.

Then, the resulting pellets and AS resin (manufactured by TOYO STYRENE Co., Ltd., Trade Name: Toyo AS AS20) were kneaded using a single screw extruder (screw diameter (φ=30 mm) at a weight ratio of pellet/AS resin=90/10, to thereby resulting in a transparent pellet having a glass transition temperature of 127° C.

The pellets of resin composition prepared as above were melt-extruded from a coat hanger T-die using a twin-screw extruder to thereby prepare a resin film having a thickness of about 160 μm.

Then, the resulting unstretched resin film was simultaneously biaxially stretched, that is, 2.0 times in the vertical direction (lengthwise) and 2.0 times in the horizontal direction (widthwise) to thereby prepare a polarizer protective film. The resulting acrylic-based film had a thickness of 40 μm, a total light transmittance of 92%, a haze of 0.3%, and a glass transition temperature of 127° C.

(Fabrication of 30 μm Acrylic-Based Film)

Pellets having a glass transition temperature of 127° C., which were prepared in the same manner as the above 40 μm acrylic-based film, were melt-extruded from a coat hanger type T-die using a twin-screw extruder to thereby prepare a resin film having a thickness of about 120 μm.

Then, the resulting unstretched resin film was simultaneously biaxially stretched, that is, 2.0 times in the vertical direction (lengthwise) and 2.0 times in the horizontal direction (widthwise) to thereby prepare a polarizer protective film. The resulting acrylic film had a thickness of 30 μm, a total light transmittance of 92%, a haze of 0.25%, and a glass transition temperature of 127° C.

TJ40 and TJ25 were commercially available (manufactured by Fujifilm Corporation).

<Coating of Hard Coat Layer>

The transparent support was unwound into a roll shape, and hard coat layer coating liquids A01 to A42 were used to prepare hard coat films S01 to S42. Further, the acryl base film having a thickness of 300 μm as fabricated above was unwound into a roll shape, and coating liquid A09 was used to prepare hard coat film S43.

Specifically, each coating liquid was coated by a die coating method using the slot die described in Example 1 of Japanese Patent Laid-Open Publication No. 2006-122889 at a conveying speed of 30 m/min and dried at 60° C. for 150 seconds. Then, at an oxygen concentration of approximately 0.1 vol % achieved by purging in the presence of nitrogen, the coated layer was cured by irradiating with an ultraviolet ray thereon in an irradiation dose of 500 mJ/cm² at an illuminance of 400 mW/cm² by using an air-cooled metal halide lamp (manufactured by EYE GRAPHICS Co., Ltd.) of 160 W/cm, to thereby form a hard coat layer, which then was wound up.

The prepared hard coat films S01 to S24 were evaluated in an evaluation method illustrated below.

{Film Thickness of Hard Coat Layer}

The film thickness of the hard coat layer was calculated by measuring the film thickness of a prepared hard coat film with a contact-type film thickness meter and subtracting the thickness of a support measured by the same film thickness meter from the measured hard coat film thickness. For all hard coat films S01 to S24, the film thickness of the hard coat layer was 7.5 μm.

{Surface Aspect of Hard Coat Layer}

A black tape was attached to a surface of the hard coat film opposite to the hard coat layer in order to suppress back reflection, and the polarizing plate protective film was visually observed from the surface of the hard coat layer, and evaluated under the following evaluation criteria.

A: No interference fringe was observed.

B: Very slight interference fringe was observed.

C: Slight interference fringe was generated, but allowed as a product.

D: Strong interference fringe was generated.

{Pencil Hardness}

The pencil hardness test described in JIS K 5400 was performed. The moisture of the hard coat film was controlled at a temperature of 25° C. and a relative humidity (RH) of 60% for 2 hours. Then, the surface of the film was scratched with 2H-4H test pencils defined in JIS S 6006 under a load of 4.9 N. The number of times that the no damage occurred on the surface when scratched 5 times with each pencil was measured, and the determination was made under the following criteria.

A: Three or more times no damage occurred when scratched 5 times with a 4H pencil.

B: Three or more times no damage occurred when scratched 5 times with a 3H pencil.

C: Three or more times damage occurred when scratched 5 times with a 3H pencil.

(Saponification of Film)

The fabricated hard coat film was immersed in 1.5 mol/L of aqueous NaOH solution (saponification liquid), which was maintained at 45° C., for 2 minutes. Then, the film was washed with water, then immersed in 0.1 mol/L of aqueous sulfuric acid solution at 30° C. for 15 seconds, and then, allowed to pass through a water washing bath under running water to make the film neutral. Then, dehydration by air knife was repeated three times. After water dropped, the film stayed in a drying zone at 90° C. for 60 seconds to dryness to fabricate a saponified film.

{Contact Angle of Water}

Using a contact angle meter (“CA-X” type contact angle meter, manufactured by Kyowa Interface Science Co., LTD.), pure water was used as a liquid in a dry state (20° C./65% RH) to produce a droplet having a diameter of 1 0 mm at a tip of a needle, which is then brought into contact with the surface of the saponified hard coat film to produce a droplet on the film. As an angle formed between a tangent line with respect to the liquid surface and the film surface at the point where the film and the liquid are in contact, the angle at a side including the liquid was measured to obtain a contact angle. Based on the result, evaluation was made under the following criteria.

A: Contact angle is 50° or less

B: Contact angle is greater than 50° but not greater than 75°

C: Contact angle is greater than 75°

{Cissing When Laminating on the Hard Coat Layer}

(Preparation of Coating Liquid Ln-1 for Lamination)

Each component was mixed as described below, and dissolved in a 90/10 (mass ratio) mixture of MEK/MMPG-Ac to prepare a low refractive index coating liquid having a solid content of 1% by mass.

<<Composition of Ln-1>>

| | | |
|---|---|---|
| The following perfluoroolefin copolymer (P-1) | 15.0 | g |
| DPHA | 7.0 | g |
| RMS-033 | 5.0 | g |
| The following fluorine-containing monomer (M-1) | 20.0 | g |
| Hollow silica particles (as solid) | 50.0 | g |
| Irgacure 127 | 3.0 | g |

The used compounds are described below.

Perfluoroolefin copolymer (P-1)

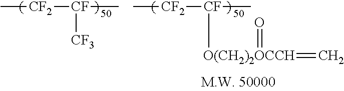

In the formula, 50:50 indicates a molar ratio

Fluorine-Containing monomer (M-1)

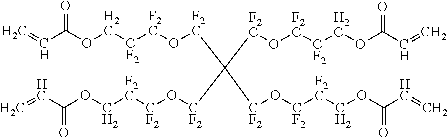 [SMILES: C=CC(=O)OCC(F)(F)C(F)(F)OC(F)(F)C(C(F)(F)OC(F)(F)C(F)(F)COC(=O)C=C)(C(F)(F)OC(F)(F)C(F)(F)COC(=O)C=C)C(F)(F)OC(F)(F)C(F)(F)COC(=O)C=C]

DPHA: KAYARD DPHA (manufactured by Nippon Kayaku Co., Ltd.)

RMS-033: Silicon-based polyfunctional acrylate (manufactured by Gelest, Mwt=28000)

Irgacure 127: Acylphosphine oxide-based photo-polymerization initiator (manufactured by BASF)

Hollow silica particles: Hollow silica particle dispersion (average particle size: 45 nm, refractive index: 1.25, surface-treated with a silane coupling agent having an acryloyl group, concentration of MEK dispersion: 20%)

MEK: Methyl ethyl ketone

MMPG-Ac: Propylene glycol monomethyl ether acetate

The low refractive index coating liquid was prepared by filtering the coating liquid through a polypropylene filter having a pore of 1 μm.

Then, the coating liquid Ln-1 to for a low refractive index layer was applied to a surface on which the hard coat layer of the hard coat film subjected to the saponification as described above was applied. The drying conditions of the low refractive index layer was set to 90° C. for 60 seconds, and the UV curing were performed in an irradiation dose of 300 mJ/cm² at an illuminance of 600 mW/cm² using a 240 W/cm air-cooled metal halide lamp (manufactured by EYE GRAPHICS CO., LTD.) under nitrogen purge performing so as to be an atmosphere in which the oxygen concentration is approximately 0.01 vol % or less. The refractive index of the low refractive index layer was 1.36, and the film thickness was 95 nm The number of cissing in the obtained 15 cm×20 cm film was counted. Here, a region in which the upper layer was not formed on the surface of the lower layer was regarded as a cissing. Based on the result, evaluation was made under the following criteria.

A: One or less cissing.

B: Two to four cissings.

C. Five or more cissings.

TABLE 5

| | Hard coat layer coating liquid | A01 | A02 | A03 | A04 | A05 | A06 |
|---|---|---|---|---|---|---|---|
| Component (b) | DPHA | 97.00% | 96.98% | 96.98% | 96.90% | 96.98% | 96.98% |
| | ATMMT | | | | | | |
| | UV1700B | | | | | | |
| | A-DCP | | | | | | |
| Polymerization | IRGACURE 127 | 3.00% | 3.00% | | 3.00% | 3.00% | 3.00% |
| initiator | IRGACURE 184 | | | 3.00% | | | |
| Component (a) | C-209 | 0.005% | 0.020% | 0.020% | 0.100% | | |
| | C-40 | | | | | 0.020% | |
| | C-141 | | | | | | 0.020% |
| | C-72 | | | | | | |
| Leveling agent | Ftergent 610FM | | | | | | |
| | FP-1 | | | | | | |
| Component (c) | 3,4-Epoxycyclohexylmethyl | | | | | | |
| | methacrylate | | | | | | |
| | 3′,4,′-Epoxycyclohexylethyl | | | | | | |
| | 3,4-Epoxycyclohexane | | | | | | |
| | carboxylate | | | | | | |
| | Glycidyl meathacrylate | | | | | | |
| Polymerization | Compound 1 | | | | | | |
| initiator | B2380 | | | | | | |
| Component (d) | ELECOM V-8802 | | | | | | |
| | ELECOM V-8802 | | | | | | |
| | MiBK-ST | | | | | | |
| Component (e) | Tinuvin 928 | | | | | | |
| Solvent | MEK | 50% | 50% | 50% | 50% | 50% | 50% |
| | MiBK | 30% | 30% | 30% | 30% | 30% | 30% |
| | Methyl acetate | 20% | 20% | 20% | 20% | 20% | 20% |
| Remarks | | Ex. | Ex. | Ex. | Ex. | Ex. | Ex. |
| | Hard coat layer coating liquid | A07 | A08 | A09 | A10 | A11 | A12 |
| Component (b) | DPHA | 96.98% | 96.98% | 96.98% | 97.00% | | |
| | ATMMT | | | | | 96.98% | |
| | UV1700B | | | | | | 96.98% |
| | A-DCP | | | | | | |
| Polymerization | IRGACURE 127 | 3.00% | 3.00% | 3.00% | 3.00% | 3.00% | 3.00% |
| initiator | IRGACURE 184 | | | | | | |
| Component (a) | C-209 | | | | | 0.020% | 0.020% |
| | C-40 | | | | | | |
| | C-141 | | | | | | |
| | C-72 | 0.020% | | | | | |
| Leveling agent | Ftergent 610FM | | 0.020% | | | | |
| | FP-1 | | | 0.020% | | | |
| Component (c) | 3,4-Epoxycyclohexylmethyl | | | | | | |
| | methacrylate | | | | | | |
| | 3′,4,′-Epoxycyclohexylethyl | | | | | | |
| | 3,4-Epoxycyclohexane | | | | | | |
| | carboxylate | | | | | | |
| | Glycidyl meathacrylate | | | | | | |
| Polymerization | Compound 1 | | | | | | |
| initiator | B2380 | | | | | | |
| Component (d) | ELECOM V-8802 | | | | | | |
| | ELECOM V-8802 | | | | | | |
| | MiBK-ST | | | | | | |
| Component (e) | Tinuvin 928 | | | | | | |
| Solvent | MEK | 50% | 50% | 50% | 50% | 50% | 50% |
| | MiBK | 30% | 30% | 30% | 30% | 30% | 30% |
| | Methyl acetate | 20% | 20% | 20% | 20% | 20% | 20% |

| Remarks | | Ex. | | C. Ex. | | C. Ex. | | C. Ex. | | Ex. | | Ex. | |
|---|---|---|---|---|---|---|---|---|---|---|---|---|---|
| | | Sample No. | | | | | | | | | | | |
| | | S01 | S02 | S03 | S04 | S05 | S06 | S07 | S08 | S09 | S10 | S11 | S12 |
| | Hard coat coating liquid No. | A01 | A02 | A03 | A04 | A05 | A06 | A07 | A08 | A09 | A10 | A11 | A12 |
| Layer | Support | TJ40 | TJ40 | TJ40 | TJ40 | TJ40 | TJ40 | TJ40 | TJ40 | TJ40 | TJ40 | TJ40 | TJ40 |
| configuration | Hard coat layer thickness | 7.5 | 7.5 | 7.5 | 7.5 | 7.5 | 7.5 | 7.5 | 7.5 | 7.5 | 7.5 | 7.5 | 7.5 |
| Evaluation | Surface aspect (smoothness) | C | B | B | B | B | B | B | C | A | D | C | C |
| result | Contact angle after saponification | A | A | A | B | A | A | B | C | C | C | A | A |
| | Cissing during lamination | A | A | A | B | A | A | B | C | C | C | A | A |
| | Pencil evaluation | A | A | A | A | A | A | A | A | A | A | A | B |

TABLE 6

| | Hard coat layer coating liquid | A13 | A14 | A15 | A16 | A17 | A18 |
|---|---|---|---|---|---|---|---|
| Component (b) | DPHA | | 96.98% | 96.98% | 96.98% | 73.18% | 73.18% |
| | ATMMT | | | | | | |
| | UV1700B | | | | | | |
| | A-DCP | 96.98% | | | | | |
| Polymerization | IRGACURE 127 | 3.00% | 3.00% | 3.00% | 3.00% | 3.00% | 3.00% |
| initiator | IRGACURE 184 | | | | | | |
| Component (a) | C-209 | 0.020% | 0.020% | 0.020% | 0.020% | 0.020% | 0.020% |
| | C-40 | | | | | | |
| | C-141 | | | | | | |
| | C-72 | | | | | | |
| Leveling agent | Ftergent 610FM | | | | | | |
| | FP-1 | | | | | | |
| Component (c) | 3,4-Epoxycyclohexylmethyl | | | | | 23.00% | 23.00% |
| | methacrylate | | | | | | |
| | 3′,4,′-Epoxycyclohexylethyl | | | | | | |
| | 3,4-Epoxycyclohexane | | | | | | |
| | carboxylate | | | | | | |
| | Glycidyl meathacrylate | | | | | | |
| Polymerization | Compound 1 | | | | | 0.80% | |
| initiator | B2380 | | | | | | 0.80% |
| Component (d) | ELECOM V-8802 | | | | | | |
| | ELECOM V-8802 | | | | | | |
| | MiBK-ST | | | | | | |
| Component (e) | Tinuvin 928 | | | | | | |
| Solvent | MEK | 50% | 50% | 50% | 50% | 50% | 50% |
| | MiBK | 30% | 30% | 30% | 30% | 30% | 30% |
| | Methyl acetate | 20% | 20% | 20% | 20% | 20% | 20% |

| | | | | | | |
|---|---|---|---|---|---|---|
| Remarks | Ex. | Ex. | Ex. | Ex. | Ex. | Ex. |

| | Hard coat layer coating liquid | A19 | A20 | A21 | A22 | A23 | A24 |
|---|---|---|---|---|---|---|---|
| Component (b) | DPHA | 73.18% | 73.18% | 58.18% | 58.18% | 58.18% | 57.38% |
| | ATMMT | | | | | | |
| | UV1700B | | | | | | |
| | A-DCP | | | | | | |
| Polymerization | IRGACURE 127 | 3.00% | 3.00% | 3.00% | 3.00% | 3.00% | 3.00% |
| initiator | IRGACURE 184 | | | | | | |
| Component (a) | C-209 | 0.020% | 0.020% | 0.020% | 0.020% | 0.020% | 0.020% |
| | C-40 | | | | | | |
| | C-141 | | | | | | |
| | C-72 | | | | | | |
| Leveling agent | Ftergent 610FM | | | | | | |
| | FP-1 | | | | | | |
| Component (c) | 3,4-Epoxycyclohexylmethyl | | | 23.00% | 23.00% | 23.00% | 23.00% |
| | methacrylate | | | | | | |
| | 3′,4,′-Epoxycyclohexylethyl | 23.00% | | | | | |
| | 3,4-Epoxycyclohexane | | | | | | |
| | carboxylate | | | | | | |
| | Glycidyl meathacrylate | | 23.00% | | | | |
| Polymerization | Compound 1 | 0.80% | 0.80% | 0.80% | 0.80% | 0.80% | 0.80% |
| initiator | B2380 | | | | | | |
| Component (d) | ELECOM V-8802 | | | 15.00% | | | 15.00% |
| | ELECOM V-8802 | | | | 15.00% | | |
| | MiBK-ST | | | | | 15.00% | |
| Component (e) | Tinuvin 928 | | | | | | 0.80% |
| Solvent | MEK | 50% | 50% | 50% | 50% | 50% | 50% |
| | MiBK | 30% | 30% | 30% | 30% | 30% | 30% |
| | Methyl acetate | 20% | 20% | 20% | 20% | 20% | 20% |

| | | | | | | |
|---|---|---|---|---|---|---|
| Remarks | Ex. | Ex. | Ex. | Ex. | Ex. | Ex. |

| | | Sample No. | | | | | | | | | | | |
|---|---|---|---|---|---|---|---|---|---|---|---|---|---|
| | | S13 | S14 | S15 | S16 | S17 | S18 | S19 | S20 | S21 | S22 | S23 | S24 |
| | Hard coat coating liquid No. | A13 | A14 | A15 | A16 | A17 | A18 | A19 | A20 | A21 | A22 | A23 | A24 |
| Layer | Support | TJ40 | Acryl | Acryl | TJ25 | TJ25 | TJ25 | TJ25 | TJ25 | TJ25 | TJ25 | TJ25 | TJ25 |
| configuration | | | 40 μ | 30 μ | | | | | | | | | |
| | Hard coat layer thickness | 7.5 | 7.5 | 7.5 | 7.5 | 7.5 | 7.5 | 7.5 | 7.5 | 7.5 | 7.5 | 7.5 | 7.5 |
| Evaluation | Surface aspect (smoothness) | C | C | C | B | A | A | A | A | A | A | A | A |
| result | Contact angle after saponification | A | A | A | A | A | A | A | A | A | A | A | A |
| | Cissing during lamination | A | A | A | A | A | A | A | A | A | A | A | A |
| | Pencil evaluation | C | A | A | A | A | A | B | C | A | A | A | A |

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and there equivalents.

What is claimed is:

1. A hard coat film having a hard coat layer made from a hard coat layer forming composition on at least one side of a transparent support, the hard coat layer forming composition containing:
a) a resin which has a repeating unit including, in a same side chain thereof, at least one selected from a fluorine atom and a silicon atom, and a polarity conversion group capable of being hydrolyzed by the action of an alkali solution to increase the hydrophilicity.

2. The hard coat film according to claim 1,
wherein the polarity conversion group is a polarity conversion group containing a lactone ring.

3. The hard coat film according to claim 1,
wherein the hard coat layer forming composition further contains:
b) a compound having three or more ethylenically unsaturated double bond groups in the molecule.

4. The hard coat film according to claim 1,
wherein the hard coat layer forming composition further contains:
c) a compound having at least one epoxy group in the molecule.

5. The hard coat film according to claim 4,
wherein the compound c) is a compound having one alicyclic epoxy group and one ethylenically unsaturated double bond group in the molecule and having a molecular weight of 300 or less.

6. The hard coat film according to claim 1,
wherein the hard coat layer forming composition further contains:
d) inorganic fine particles having reactivity with an epoxy group or an ethylenically unsaturated double bond group.

7. The hard coat film according to claim 1,
wherein the hard coat layer forming composition further contains:
e) a UV absorbent.

8. The hard coat film according to claim 1,
wherein the transparent support is a cellulose acylate film and has a thickness of 25 μm or less.

9. The hard coat film according to claim 3,
wherein a content of the compound b) is 45% by mass to 75% by mass based on a total solid content of the hard coat layer forming composition.

10. The hard coat film according to claim 4,
wherein a content of the compound c) is 12% by mass to 35% by mass based on a total solid content of the hard coat layer forming composition.

11. The hard coat film according to claim 10,
wherein a content of the compound c) is 15% by mass to 30% by mass based on a total solid content of the hard coat layer forming composition.

12. A hard coat film obtained by saponifying the hard coat film according to claim 1,
wherein a contact angle of a surface of the hard coat layer is 75° or less.

13. A polarizing plate comprising a polarizer and at least one sheet of the saponified hard coat film according to claim 12.

14. A touch panel display comprising a liquid crystal cell, the polarizing plate according to claim 13 disposed at a viewing side of the liquid crystal cell, and an optically clear resin or an optically clear adhesive disposed on a surface of the polarizing plate opposite to a liquid crystal cell side.
